(19) United States
(12) Patent Application Publication
(10) Pub. No.: US 2026/0094470 A1
(43) Pub. Date: Apr. 2, 2026

(54) METHODS, SYSTEMS, AND COMPUTER PROGRAM PRODUCTS FOR IMAGE PROCESSING AND COMPUTER VISION USING INVARIANT FEATURES AND DEEP LEARNING TECHNIQUES

(71) Applicant: ACCTON TECHNOLOGY CORPORATION, Sunnyvale, CA (US)

(72) Inventors: WEI-SHUO LEE, Zhubei City (TW); CHIH-YI CHI, Zhubei City (TW); CHIH-CHIANG LIN, Zhubei City (TW); TING-TZU CHANG, Zhubei City (TW)

(73) Assignee: ACCTON TECHNOLOGY CORPORATION, Sunnyvale, CA (US)

(21) Appl. No.: 19/310,416

(22) Filed: Aug. 26, 2025

Related U.S. Application Data
(60) Provisional application No. 63/699,804, filed on Sep. 27, 2024.
(60) Provisional application No. 63/858,308, filed on Aug. 6, 2025.

(51) Int. Cl. G06V 40/20; G06V 10/32; G06V 10/774; G06V 10/776; G06V 10/82

(52) U.S. Cl. CPC G06V 40/25; G06V 10/32; G06V 10/774; G06V 10/776; G06V 10/82

(57) ABSTRACT

Various techniques receive one or more images or a sequence of images pertaining to a gait cycle of a person and process the one or more images or the sequence of images. A convolutional neural network may be trained or retrained using at least the one or more images or the sequence of images that has been processed, based at least in part upon one or more invariant features from the one or more images or the sequence of images. A gait feature of the person may be recognized to determine an identity of the person using at least the convolutional neural network that has been trained.

### CROSS REFERENCE TO RELATED APPLICATION(S)

This U.S. patent application claims the benefit of U.S. provisional patent application Ser. No. 63/699,804 filed on Sep. 27, 2024 and entitled “METHODS, SYSTEMS, AND COMPUTER PROGRAM PRODUCTS FOR IMAGE PROCESSING AND COMPUTER VISION USING INVARIANT FEATURES AND DEEP LEARNING TECHNIQUES”, U.S. provisional patent application Ser. No. 63/858,808 filed on Aug. 6, 2025 and entitled “METHODS, SYSTEMS, AND COMPUTER PROGRAM PRODUCT FOR DIAGNOSING AND EVALUATING SKIN DISEASES, PREDICTING PROGNOSIS, AND RECOMMENDING TREATMENT OPTIONS, USING A DEEP LEARNING SYSTEM”. This application is also cross-related to U.S. patent application Ser. No. 19/295,557 filed on Aug. 9, 2025 and entitled “METHODS, SYSTEMS, AND COMPUTER PROGRAM PRODUCT FOR DIAGNOSING AND EVALUATING SKIN DISEASES, PREDICTING PROGNOSIS, AND RECOMMENDING TREATMENT OPTIONS, USING A DEEP LEARNING SYSTEM”. The contents of the aforementioned U.S. provisional patent applications and U.S. patent application are hereby expressly incorporated by reference in their entireties for all purposes.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Image processing and computer vision techniques have been widely developed for a various applications in the technological fields such as security, healthcare, skincare, etc. For example, facial identification and recognition has been widely adopted in security industry, the healthcare industry, and the skincare/cosmetic industries; and gait analysis and recognition have been utilized in behavioral sciences.

Nonetheless, legacy approaches have faced challenges so as to provided limited utility. For example, computer vision and image processing techniques are intrinsically tied to the camera pose coordinate frame and the pixel coordinate frame to map three-dimensional (3D) features in the real world to a two-dimensional (2D) image plane, using the perspective transformation from the 3D physical world to the 2D image plane while accounting for the camera pose coordinate frame and the pixel coordinate frame.

Moreover, the positioning of a camera (or video camera) relative to a subject (e.g., a person or a portion thereof such as the person's face) has further exacerbated the challenges. For example, for security applications, different camera, video camera, x-ray cameras, and/or thermal imaging devices, etc. are usually mounted at different perspectives despite the fact that recognition from images is best if the camera is mounted directly in front of the face of the person being recognized or on the side of the person whose gait is to be analyzed. These different perspectives, after accounting the perspective transformation and the camera pose, cause recognition of features (e.g., facial features, gait, etc.) even more difficult.

To further complicate these tasks, cameras may be mounted at different distances from the subjects being captured, and subjects being captured may exhibit large-scale motion/movement. Nonetheless, even a slight movement (e.g., a person tilting his head slightly upward, downward, leftward, rightward, or any combination thereof, etc.), when combined with the lack of an absolute scale (e.g., a length scale) as a reference scale in most imaging devices or images being captured, may simply throw off a correct measurement and determination of a skin condition or the recognition of the face or gait of a person.

These shortcomings are especially problematic in security applications. For example, many systems use computer vision and image processing techniques to recognize persons from an image or a sequence of images. Various camouflage techniques have been developed to avoid such recognition. For example, people may wear different clothing (e.g., various coats, shirts, etc.), accessories (e.g., hats, caps, sunglasses, fake beard, scarf, etc.), countershading, disruptive coloration, counterillumination, reflection, or even plastic surgery, etc. to fool computer vision and image processing techniques so as to avoid recognition.

In addition, the lack of an absolute scale in image capturing causes additional difficulties in determining the severity and any prognosis after treatment of a skin condition because of the difficulties in accurately quantifying a skin condition. For example, for diagnosis of a skin condition (e.g., hairs, colors, undertones, moles, freckles, wrinkles, fine lines, etc. on the skin), computer vision and image processing techniques can accurately identify an affected area from an image or a sequence of images (e.g., in a video sequence). Nonetheless, these techniques fall short in quantifying the skin condition. For example, conventional techniques have great difficulties in generating a trustworthy (e.g., consistent with what a dermatologist would generate) number to assess the seriousness of a skin condition (e.g., in a number of fingertip units or FTU). Without accurate recognition, assessment of skin conditions for cosmetic products, skincare products, medical treatments, etc. has become more difficult, let alone subsequent monitoring of prognosis of such skin conditions and recommended adjustments in the offerings of products, services, and/or treatments.

Therefore, there exists a need for improved methods, systems, and computer program products for image processing and computer vision, using invariant features and deep learning techniques.

### SUMMARY

Various embodiments of the present disclosure provide improved methods, systems, and computer program products for image processing and computer vision, using invariant features and deep learning techniques. In some of these embodiments, the invariant features comprise a plurality of invariant features.

Some embodiments are directed to a method for image processing and computer vision, using invariant features and deep learning techniques. These embodiments receive one or more images or a sequence of images pertaining to a gait cycle of a person and process the one or more images or the sequence of images. In addition, a convolutional neural network is trained or re-trained using at least the one or more images or the sequence of images that has been processed, based at least in part upon one or more invariant features from the one or more images or the sequence of images. A gait feature of the person is then recognized to determine an identity of the person using at least the convolutional neural network that has been trained.

In some of these embodiments, the one or more images or the sequence of images is processed at least by generating one or more complete gait images and one or more incomplete gait images, wherein the one or more complete gait images correspond to at least one complete gait cycle, and the one or more incomplete gait images corresponds to a smaller subset of a complete gait cycle.

In some of the immediately preceding embodiments, the one or more images or the sequence of images is processed further at least by performing a normalization operation on the one or more complete gait images and one or more incomplete gait images to transform pixel values of the one or more complete gait images and one or more incomplete gait images are within a range.

In some of the immediately preceding embodiments that process the one or more images or the sequence of images, the one or more complete gait images and one or more incomplete gait images, which have been normalized, are split into one or more first datasets and one or more second datasets, wherein the one or more first datasets include first data corresponding to the at least one complete gait cycle, and the one or more second datasets include second data corresponding to one or more smaller subsets of the complete gait cycle.

In some embodiments, the convolutional neural network may be trained or re-trained at least by training a stack of a plurality of convolutional networks into a trained gait generation network using at least one of the one or more invariant features, one or more predicted invariant features, or one or more gait features detected from the one or more images or the sequence of images.

In some of these immediately preceding embodiments that train or re-train the convolutional neural network, a gait recognition network is trained into a trained gait recognition network using at least one of the one or more invariant features or the one or more predicted invariant features.

In some of these immediately preceding embodiments that train the stack of the plurality of convolutional networks, a number of individual convolutional neural networks is determined for generating complete gait images from incomplete gait images. Each individual convolutional neural network of the number of individual convolutional neural networks is trained with a respective dataset. One or more parameters of the each individual convolutional neural network are then determined.

In some of these immediately preceding embodiments that train the stack of the plurality of convolutional networks, the gait generation network is trained with the one or more parameters of the each individual convolutional neural network at least by stacking the number of convolutional neural networks to form the gait generation network.

In some of these immediately preceding embodiments that train the stack of the plurality of convolutional networks, the gait generation network is validated using at least one dataset of the one or more first datasets or the one or more second datasets that are determined by splitting the one or more the one or more complete gait images and one or more incomplete gait images.

In some embodiments, the one or more invariant features comprise an invariant physiological feature that is located at a fixed location with respect to a body part of a human body of the person and is free from disguise, occlusion, and mutilation due to movements of soft tissues of the person.

Some embodiments are directed to a method for image processing and computer vision using invariant features and deep learning techniques. These embodiments receive input gait data for a person and perform variations processing and view processing with a gait recognition model. In addition, a feature extraction process is performed to obtain a plurality of gait features for gait feature recognition, wherein the plurality of gait features include one or more invariant features; and gait feature recognition is performed based at least in part upon the plurality of gait features.

In some of these embodiments, dimensionality of the plurality of gait features is reduced using at least a principal component analysis.

In some embodiments that perform the variations processing and the view processing, the one or more invariant features may be determined for the person from the input gait data. Moreover, a model may be determined based at least in part upon the one or more invariant features. In addition, a plurality of existing models of known identifies may be identified.

In some of the immediately preceding embodiments that perform the variations processing and the view processing, a partial match may be performed between a smaller portion of the model and a corresponding portion of an existing model of the plurality of models using at least a translation, rotation, or scaling operation, based at least in part upon a smaller portion of the existing model, wherein the partial match.

In some of the immediately preceding embodiments that perform the variations processing and the view processing, a determination may be made to decide whether the model matches the existing model using a remaining portion of the model and a corresponding remaining portion of the existing model. In addition, another decision may be made to decide whether the person matches a known identity based at least in part upon a result of determining whether the model matches the existing model that corresponds to the known identity.

In some of the immediately preceding that determine whether the model matches the existing model, a set of features including the one or more invariant features may be determined from the input gait data; and the model and a set of entities for the model may be determined based at least in part upon the set of features.

In some of the immediately preceding embodiments that determine the model and the set of entities, a set of overlapping images may be identified from input gait data for training a reconstructor, and the set of features including the one or more invariant features may be extracted from the set of overlapping images.

In some of the immediately preceding embodiments that determine the model and the set of entities, a set of corresponding features may be identified from one or more remaining images in the set of overlapping images. Furthermore, a sparse entity cloud may be generated at least by estimating a multi-dimensional structure from two or more images in the set using camera poses of two or more cameras capturing the two or more images and respective orientations of the two or more images based at least in part upon one or more geometric relationships among the two or more cameras.

In some of the immediately preceding embodiments that determine the model and the set of entities, a denser entity cloud may be generated from the sparse entity cloud at least by fusing depth information into the sparse entity cloud; and a surface mesh may also be generated for the denser entity cloud as the model.

In some of the immediately preceding embodiments that determine whether the model matches the existing model, a first pair of entities may be identified from the set of entities, wherein the first pair of entities are supposed to be symmetric with respect to a reference entity. Moreover, a determination may be made to decide whether first asymmetry beyond a threshold exists between the first pair of entities with respect to the reference entity. In addition, the model may be oriented with one or more rotation operations to reduce the first asymmetry below the threshold.

In some of the immediately preceding embodiments that determine whether the model matches the existing model, a second pair of entities that are supposed to be symmetric with respect to the reference entity may be identified. Moreover, a scaling operation or a rotation operation may be performed on the model to reduce second asymmetry below the threshold when the second asymmetry beyond the threshold exists between the second pair of entities. In addition, the existing model may be discarded when misalignment beyond the threshold or an alignment threshold exists between the a next entity in the model and a next existing entity in the existing model.

In some embodiments that determine the model and the set of entities, a set of silhouettes or depth maps may be determined from a single input image using an autoencoder. Moreover, an intermediate output may be generated at least by transforming visible pixels from the set to a target set using a transformation, a symmetry constraint, and a first network in the autoencoder, wherein the visible pixels are visible in both the set and the target set. Further, a final output may be generated at least by hallucinating occluded pixels, using a second network in the autoencoder.

In some of the immediately preceding embodiments that determine the model and the set of entities, the first network or the second network may be trained using a background mask, a similarity or dissimilarity measure of the final output from a loss network, and a visibility map.

In some of the immediately preceding embodiments that determine the model and the set of entities, one or more latent variables in the first network or the second network may be learned using a deep generative network. Moreover, the target set of silhouettes or depth maps may be learned. In addition, a three-dimensional (3D) entity cloud may be generated at least with a set of features including the one or more invariant features from the target set of silhouettes or depth maps.

In some of the immediately preceding embodiments that determine the model and the set of entities, an initial model may be determined using a plurality of 3D entity clouds including the 3D entity cloud; and the model may be determined at least by refining the initial model into the model at least by filtering out noise with one or more predicted silhouettes or depth maps.

Some embodiments are directed to a computer implemented method for image processing and computer vision using invariant features and deep learning techniques. These embodiments identify an input for a person, the input comprising one or more images or a sequence of images of a portion of a body of the person; and generate, at a first network of a deep learning model, a prediction for a skin condition of the person based at least in part upon the input. In addition, a predicted set of one or more treatment options may be generated at a first network of a deep learning model, products, or services for the skin condition of the person. Moreover, the first network of the deep learning model may generate a predicted set of one or more treatment options, products, or services for the skin condition of the person as well as generate a predicted interaction or prognosis of the person in response to the predicted set using at least a user representation and a product representation. Moreover, a personalized recommendation that is specifically tailored to the person may be generated based at least in part upon the predicted set of one or more treatment options, products, or services and the predicted interaction or prognosis.

In some of these embodiments, the user representation for the person and the product representation for a treatment option, a product, or a service may be generated; the first network and the second network of the deep learning model may be trained; or the first network or the second network of the deep learning model may be validated using at least the predicted interaction or prognosis.

In some of the immediately preceding embodiments that train the first network and the second network of the deep learning model, a relationship that indicates a user's entity's comparative characteristic between a first product, service, or treatment option and a second product, service, or treatment option may be identified; and a latent product, service, or treatment option entity vector and a latent user entity vector may be determined, using respective distributions for textual embedding, visual embedding, audio embedding, relationship embedding, or other embeddings.

In some of the immediately preceding embodiments that train the first network and the second network of the deep learning model, a personalized model may be determined for the user entity, using the latent product, service, or treatment option entity vector and the latent user entity vector, and a likelihood metric may be determined for a specific combination of the user entity, a first product, service, or treatment option entity, and a second product, service, or treatment option entity, using the personalized model.

In some of the immediately preceding embodiments that train the first network and the second network of the deep learning model, a subset of product, service, or treatment option entities may be determined at least by sampling the specific combination of the user entity, the first product, service, or treatment option entity, and the second product, service, or treatment option entity. In addition, a plurality of parameters of the deep learning model including both the first network and the second network may be updated using an objective function, based at least in part upon the subset of product, service, or treatment option entities.

In some of the immediately preceding embodiments that train the first network and the second network of the deep learning model, accuracy of the personalized model that determines the likelihood may be improved at least by fine-tuning some of the plurality of parameters, using joint-learning and the objective function. Further, a plurality of combinations including the specific combination for the user entity may be ranked based at least in part upon a result of the joint-learning.

In some embodiments, the input includes service data of a plurality of services, product data of a plurality of products, treatment option data of a plurality of treatment options, user data of a plurality of users, general data, and historical data pertaining to the plurality of services, the plurality of products, the plurality of treatment options, and the plurality of users.

In some of the immediately preceding embodiments, the service data may be transformed into one or more first topics, wherein a first topic includes a plurality of service embedding vectors; and the product data may be transformed into one or more second topics, wherein a second topic includes a plurality of product embedding vectors. Moreover, the treatment option data may be transformed into one or more third topics, wherein a third topic includes a plurality of treatment option embedding vectors; and the user data may be transformed into one or more fourth topics, wherein a fourth topic includes a plurality of user embedding vectors. In addition, the general data may be transformed into one or more fifth topics, wherein a fifth topic includes a plurality of general data embedding vectors; and the historical data may be transformed into one or more sixth topics, wherein a sixth topic includes a plurality of historical data embedding vectors.

Some embodiments are directed at a hardware system that may be invoked to perform any of the methods, processes, or sub-processes disclosed herein. The hardware system may include at least one microprocessor or at least one processor core, which executes one or more threads of execution to perform any of the methods, processes, or sub-processes disclosed herein in a computing system located in a local computing environment in some embodiments or in a cloud environment in some other embodiments. The hardware system may further include one or more forms of non-transitory machine-readable storage media or devices to temporarily or persistently store various types of data or information. Some exemplary modules or components of the hardware system may be found in the System Architecture Overview section below.

Some embodiments are directed at an article of manufacture that includes a non-transitory machine-accessible storage medium having stored thereupon a sequence of instructions which, when executed by at least one processor or at least one processor core, causes the at least one processor or the at least one processor core to perform any of the methods, processes, or sub-processes disclosed herein. Some exemplary forms of the non-transitory machine-readable storage media may also be found in the System Architecture Overview section below.

Embodiment 1. A computer implemented method for image processing and computer vision using invariant features and deep learning techniques, comprising:
receiving one or more images or a sequence of images pertaining to a gait cycle of a person;
processing the one or more images or the sequence of images;
training or re-training a convolutional neural network using at least the one or more images or the sequence of images that has been processed, based at least in part upon one or more invariant features from the one or more images or the sequence of images; and
recognizing a gait feature of the person to determine an identity of the person using at least the convolutional neural network that has been trained.

Embodiment 2. The computer implemented method of claim 1, processing the one or more images or the sequence of images comprising:
generating one or more complete gait images and one or more incomplete gait images, wherein the one or more complete gait images correspond to at least one complete gait cycle, and the one or more incomplete gait images corresponds to a smaller subset of a complete gait cycle.

Embodiment 3. The computer implemented method of claim 2, processing the one or more images or the sequence of images comprising:
performing a normalization operation on the one or more complete gait images and one or more incomplete gait images to transform pixel values of the one or more complete gait images and one or more incomplete gait images are within a range.

Embodiment 4. The computer implemented method of claim 3, processing the one or more images or the sequence of images comprising:
splitting the one or more complete gait images and one or more incomplete gait images, which have been normalized, into one or more first datasets and one or more second datasets, wherein the one or more first datasets include first data corresponding to the at least one complete gait cycle, and the one or more second datasets include second data corresponding to one or more smaller subsets of the complete gait cycle.

Embodiment 5. The computer implemented method of claim 1, wherein training or re-training the convolutional neural network comprises:
training a stack of a plurality of convolutional networks into a trained gait generation network using at least one of the one or more invariant features, one or more predicted invariant features, or one or more gait features detected from the one or more images or the sequence of images.

Embodiment 6. The computer implemented method of claim 5, wherein training or re-training the convolutional neural network comprises:
training a gait recognition network into a trained gait recognition network using at least one of the one or more invariant features or the one or more predicted invariant features.

Embodiment 7. The computer implemented method of claim 5, training the stack of the plurality of convolutional networks comprising:
determining a number of individual convolutional neural networks for generating complete gait images from incomplete gait images;
training each individual convolutional neural network of the number of individual convolutional neural networks with a respective dataset; and
determining one or more parameters of the each individual convolutional neural network.

Embodiment 8. The computer implemented method of claim 7, training the stack of the plurality of convolutional networks comprising:
training the gait generation network with the one or more parameters of the each individual convolutional neural network at least by stacking the number of convolutional neural networks to form the gait generation network.

Embodiment 9. The computer implemented method of claim 8, training the stack of the plurality of convolutional networks comprising:
validating the gait generation network using at least one dataset of the one or more first datasets or the one or more second datasets that are determined by splitting the one or more the one or more complete gait images and one or more incomplete gait images.

Embodiment 10. The computer implemented method of claim 1, wherein the one or more invariant features comprise an invariant physiological feature that is located at a fixed location with respect to a body part of a human body of the person and is free from disguise, occlusion, and mutilation due to movements of soft tissues of the person.

Embodiment 11. A computer implemented method for image processing and computer vision using invariant features and deep learning techniques, comprising:
receiving input gait data for a person;
performing variations processing and view processing with a gait recognition model;
performing a feature extraction process to obtain a plurality of gait features for gait feature recognition, wherein the plurality of gait features include one or more invariant features; and
performing gait feature recognition based at least in part upon the plurality of gait features.

Embodiment 12. The computer implemented method of claim 11, further comprising:
reducing dimensionality of the plurality of gait features using at least a principal component analysis.

Embodiment 13. The computer implemented method of claim 11, performing the variations processing and the view processing comprising:
determining the one or more invariant features for the person from the input gait data;
determining a model based at least in part upon the one or more invariant features; and identifying a plurality of existing models of known identifies.

Embodiment 14. The computer implemented method of claim 13, performing the variations processing and the view processing comprising:
performing a partial match between a smaller portion of the model and a corresponding portion of an existing model of the plurality of models using at least a translation, rotation, or scaling operation, based at least in part upon a smaller portion of the existing model, wherein the partial match.

Embodiment 15. The computer implemented method of claim 14, performing the variations processing and the view processing further comprising:
determining whether the model matches the existing model using a remaining portion of the model and a corresponding remaining portion of the existing model; and
determining whether the person matches a known identity based at least in part upon a result of determining whether the model matches the existing model that corresponds to the known identity.

Embodiment 16. The computer implemented method of claim 15, determining whether the model matches the existing model comprising:
determining a set of features including the one or more invariant features from the input gait data; and
determining the model and a set of entities for the model based at least in part upon the set of features.

Embodiment 17. The computer implemented method of claim 16, determining the model and the set of entities comprising:
identifying a set of overlapping images from input gait data for training a reconstructor, and extracting the set of features including the one or more invariant features from the set of overlapping images.

Embodiment 18. The computer implemented method of claim 17, determining the model and the set of entities comprising:
identifying a set of corresponding features from one or more remaining images in the set of overlapping images; and
generating a sparse entity cloud at least by estimating a multi-dimensional structure from two or more images in the set using camera poses of two or more cameras capturing the two or more images and respective orientations of the two or more images based at least in part upon one or more geometric relationships among the two or more cameras.

Embodiment 19. The computer implemented method of claim 18, determining the model and the set of entities comprising:
generating a denser entity cloud from the sparse entity cloud at least by fusing depth information into the sparse entity cloud; and
generating a surface mesh for the denser entity cloud as the model.

Embodiment 20. The computer implemented method of claim 16, determining whether the model matches the existing model comprising:
identifying a first pair of entities from the set of entities, wherein the first pair of entities are supposed to be symmetric with respect to a reference entity;
determining whether first asymmetry beyond a threshold exists between the first pair of entities with respect to the reference entity; and orienting the model with one or more rotation operations to reduce the first asymmetry below the threshold.

Embodiment 21. The computer implemented method of claim 20, determining whether the model matches the existing model comprising:
identifying a second pair of entities that are supposed to be symmetric with respect to the reference entity;
performing a scaling operation or a rotation operation on the model to reduce second asymmetry below the threshold when the second asymmetry beyond the threshold exists between the second pair of entities; and
discarding the existing model when misalignment beyond the threshold or an alignment threshold exists between the a next entity in the model and a next existing entity in the existing model.

Embodiment 22. The computer implemented method of claim 16, determining the model and the set of entities comprising:
determining a set of silhouettes or depth maps from a single input image using an autoencoder;
generating an intermediate output at least by transforming visible pixels from the set to a target set using a transformation, a symmetry constraint, and a first network in the autoencoder, wherein the visible pixels are visible in both the set and the target set; and
generating a final output at least by hallucinating occluded pixels, using a second network in the autoencoder.

Embodiment 23. The computer implemented method of claim 22, determining the model and the set of entities comprising:
training the first network or the second network using a background mask, a similarity or dissimilarity measure of the final output from a loss network, and a visibility map.

Embodiment 24. The computer implemented method of claim 23, determining the model and the set of entities comprising:
learning one or more latent variables in the first network or the second network using a deep generative network;
reconstructing the target set of silhouettes or depth maps; and
generating a three-dimensional (3D) entity cloud at least with a set of features including the one or more invariant features from the target set of silhouettes or depth maps.

Embodiment 24. The computer implemented method of claim 23, determining the model and the set of entities comprising:
determining an initial model using a plurality of 3D entity clouds including the 3D entity cloud; and
determining the model at least by refining the initial model into the model at least by filtering out noise with one or more predicted silhouettes or depth maps.

Embodiment 25. A computer implemented method for image processing and computer vision using invariant features and deep learning techniques, comprising:
identifying an input for a person, the input comprising one or more images or a sequence of images of a portion of a body of the person;
generating, at a first network of a deep learning model, a prediction for a skin condition of the person based at least in part upon the input,
generating, at the first network of the deep learning model, a predicted set of one or more treatment options, products, or services for the skin condition of the person;
generating, at the first network of or a second network the deep learning model, a predicted interaction or prognosis of the person in response to the predicted set using at least a user representation and a product representation; and
generating a personalized recommendation that is specifically tailored to the person based at least in part upon the predicted set of one or more treatment options, products, or services and the predicted interaction or prognosis.

Embodiment 26. The computer implemented method of claim 25, further comprising at least one of:
generating the user representation for the person and the product representation for a treatment option, a product, or a service;
training the first network and the second network of the deep learning model; or
validating the first network or the second network of the deep learning model using at least the predicted interaction or prognosis.

Embodiment 27. The computer implemented method of claim 26, training the first network and the second network of the deep learning model comprising:
identifying a relationship that indicates a user's entity's comparative characteristic between a first product, service, or treatment option and a second product, service, or treatment option; and
determining a latent product, service, or treatment option entity vector and a latent user entity vector, using respective distributions for textual embedding, visual embedding, audio embedding, relationship embedding, or other embeddings.

Embodiment 28. The computer implemented method of claim 27, training the first network and the second network of the deep learning model comprising:
determining a personalized model for the user entity, using the latent product, service, or treatment option entity vector and the latent user entity vector, and
determining a likelihood metric for a specific combination of the user entity, a first product, service, or treatment option entity, and a second product, service, or treatment option entity, using the personalized model.

Embodiment 29. The computer implemented method of claim 28, training the first network and the second network of the deep learning model comprising:
determining a subset of product, service, or treatment option entities at least by sampling the specific combination of the user entity, the first product, service, or treatment option entity, and the second product, service, or treatment option entity; and
updating, using an objective function, a plurality of parameters of the deep learning model including both the first network and the second network, based at least in part upon the subset of product, service, or treatment option entities.

Embodiment 30. The computer implemented method of claim 29, training the first network and the second network of the deep learning model comprising:
improving accuracy of the personalized model that determines the likelihood at least by fine-tuning some of the plurality of parameters, using joint-learning and the objective function; and
ranking a plurality of combinations including the specific combination for the user entity based at least in part upon a result of the joint-learning.

Embodiment 31. The computer implemented method of claim 25, wherein the input includes service data of a plurality of services, product data of a plurality of products, treatment option data of a plurality of treatment options, user data of a plurality of users, general data, and historical data pertaining to the plurality of services, the plurality of products, the plurality of treatment options, and the plurality of users.

Embodiment 32. The computer implemented method of claim 31, further comprising:
transforming the service data into one or more first topics, wherein a first topic includes a plurality of service embedding vectors;
transforming the product data into one or more second topics, wherein a second topic includes a plurality of product embedding vectors;
transforming the treatment option data into one or more third topics, wherein a third topic includes a plurality of treatment option embedding vectors;
transforming the user data into one or more fourth topics, wherein a fourth topic includes a plurality of user embedding vectors;
transforming the general data into one or more fifth topics, wherein a fifth topic includes a plurality of general data embedding vectors; and
transforming the historical data into one or more sixth topics, wherein a sixth topic includes a plurality of historical data embedding vectors.

Embodiment 33. A computer program product embodied on a non-transitory computer readable medium having stored thereon a sequence of instructions which, when executed by a processor causes the processor to execute any of the methods of claims 1-32.

Embodiment 34. A system, comprising at least one processor and memory that stores therein a sequence of instructions which, when executed, causes the at least processor to implement any of the methods of claims 1-32.

### BRIEF DESCRIPTION OF THE DRAWINGS

The drawings illustrate the design and utility of various embodiments of the present disclosure. It should be noted that the figures are not drawn to scale and that elements of similar structures or functions are represented by like reference numerals throughout the figures. In order to better appreciate how to obtain the above-recited and other advantages and objects of various embodiments of the present disclosure, a more detailed description of the present disclosure briefly described above will be rendered by reference to specific embodiments thereof, which are illustrated in the accompanying drawings. Understanding that these drawings depict only typical embodiments of the present disclosure and are not therefore to be considered limiting of its scope, the present disclosure will be described and explained with additional specificity and detail through the use of the accompanying drawings in which:

FIG. 1A illustrates a simplified, high-level block diagram of a computing environment for image processing and computer vision, using invariant features and deep learning techniques, according to some embodiments.

FIG. 1B illustrates a simplified computer system on which various methods for image processing and computer vision using invariant features and deep learning techniques may be implemented, according to some embodiments.

FIG. 1C illustrates a block diagram of an illustrative computing system suitable for implementing some embodiments for image processing and computer vision using invariant features and deep learning techniques, according to some embodiments.

FIG. 2A illustrates a simplified high-level block diagram of method or a system for image processing and computer vision, using invariant features and deep learning techniques, according to some embodiments.

FIG. 2B illustrates a simplified block diagram of a method or system for image processing and computer vision, using invariant features and deep learning techniques, according to some embodiments.

FIG. 2C illustrates a simplified high-level block diagram of a method or system for image processing and computer vision, using invariant features and deep learning techniques, according to some embodiments.

FIG. 2D illustrates more details about a portion of the simplified high-level block diagram of a method or system for image processing and computer vision, using invariant features and deep learning techniques illustrated in FIG. 2C, according to some embodiments.

FIG. 2E illustrates more details about a portion of the simplified high-level block diagram of a method or system for image processing and computer vision, using invariant features and deep learning techniques illustrated in FIG. 2D, according to some embodiments.

FIG. 2F illustrates more details about a portion of the simplified high-level block diagram of a method or system for image processing and computer vision, using invariant features and deep learning techniques illustrated in FIG. 2E, according to some embodiments.

FIG. 2G illustrates more details about a portion of the simplified high-level block diagram of a method or system for image processing and computer vision, using invariant features and deep learning techniques illustrated in FIG. 2E, according to some embodiments.

FIG. 2H illustrates more details about a portion of the simplified high-level block diagram of a method or system for image processing and computer vision, using invariant features and deep learning techniques illustrated in FIG. 2E, according to some embodiments.

FIG. 3A illustrates a simplified high-level block diagram for image processing and computer vision, using invariant features and deep learning techniques, according to some embodiments.

FIG. 3B illustrates more details about a portion of the simplified high-level block diagram of a method or system for image processing and computer vision, using invariant features and deep learning techniques illustrated in FIG. 3A, according to some embodiments.

FIG. 3C illustrates more details about a portion of the simplified high-level block diagram of a method or system for image processing and computer vision, using invariant features and deep learning techniques illustrated in FIG. 3A, according to some embodiments.

FIG. 3D illustrates another simplified high-level block diagram for image processing and computer vision, using invariant features and deep learning techniques, according to some embodiments.

FIG. 3E illustrates another simplified high-level block diagram for image processing and computer vision, using invariant features and deep learning techniques, according to some embodiments.

FIG. 3F illustrates more details about a portion of the simplified high-level block diagram of a method or system for image processing and computer vision, using invariant features and deep learning techniques illustrated in FIG. 3A, according to some embodiments.

FIG. 4A illustrates a simplified block diagram of a method or system for image processing and computer vision, using invariant features and deep learning techniques, according to some embodiments.

FIGS. 4B-4E illustrate some examples of the application of the method or system for image processing and computer vision using invariant features and deep learning techniques illustrated in FIG. 4A, according to some embodiments.

FIG. 4F illustrates another simplified block diagram of a method or system for image processing and computer vision, using invariant features and deep learning techniques, according to some embodiments.

FIG. 4G illustrates more details about a portion of the simplified high-level block diagram of a method or system for image processing and computer vision, using invariant features and deep learning techniques illustrated in FIG. 4A, according to some embodiments.

FIG. 4H illustrates more details about a portion of the simplified high-level block diagram of a method or system for image processing and computer vision, using invariant features and deep learning techniques illustrated in FIG. 4A, according to some embodiments.

FIG. 4I illustrates more details about a portion of the simplified high-level block diagram of a method or system for image processing and computer vision, using invariant features and deep learning techniques illustrated in FIG. 4H, according to some embodiments.

FIG. 4J illustrates a simplified high-level block diagram of a method or system for generating multi-view from an input image for image processing and computer vision, using invariant features and deep learning techniques, according to some embodiments.

FIG. 4K illustrates more details about a portion of the simplified high-level block diagram of a method or system for image processing and computer vision, using invariant features and deep learning techniques illustrated in FIG. 4J, according to some embodiments.

FIG. 5A illustrates a simplified high-level block diagram of a method or system for generating recommendations for a skin condition using invariant features and deep learning techniques for image processing and computer vision, according to some embodiments.

FIG. 5B illustrates another simplified high-level block diagram of a classification model that may be utilized to implement various features and functionalities for a method or system for image processing and computer vision, using invariant features and deep learning techniques, according to some embodiments.

FIG. 5C illustrates more details about the extraction portion of the simplified high-level block diagram of a method or system for image processing and computer vision, using invariant features and deep learning techniques illustrated in FIG. 5B, according to some embodiments.

FIG. 5D illustrates more details about the neural network portion of the simplified high-level block diagram of a method or system for image processing and computer vision, using invariant features and deep learning techniques illustrated in FIG. 5B, according to some embodiments.

FIG. 5E illustrates a block diagram of an environment in which a method or system for generating recommendations for a skin condition using invariant features and deep learning techniques for image processing and computer vision may be implemented, according to some embodiments.

FIG. 5F illustrates more details about the recommender of the block diagram of a method or system for image processing and computer vision, using invariant features and deep learning techniques illustrated in FIG. 5E, according to some embodiments.

FIG. 5G illustrates more details about the relation embedding portion of the block diagram of a method or system for image processing and computer vision, using invariant features and deep learning techniques illustrated in FIG. 5F, according to some embodiments.

FIG. 5H illustrates more details about the textual embedding portion of the block diagram of a method or system for image processing and computer vision, using invariant features and deep learning techniques illustrated in FIG. 5F, according to some embodiments.

FIG. 5I illustrates more details about the visual embedding portion of the block diagram of a method or system for image processing and computer vision, using invariant features and deep learning techniques illustrated in FIG. 5F, according to some embodiments.

FIG. 5J illustrates more details about the joint learning portion of the block diagram of a method or system for image processing and computer vision, using invariant features and deep learning techniques illustrated in FIG. 5F, according to some embodiments.

FIG. 5K illustrates another simplified high-level block diagram of a method or system for generating recommendations for a skin condition using invariant features and deep learning techniques for image processing and computer vision, according to some embodiments.

FIG. 5L illustrates another simplified high-level block diagram of a method or system for generating recommendations for a skin condition using invariant features and deep learning techniques for image processing and computer vision, according to some embodiments.

FIG. 5M illustrates more details about the joint learning portion of the block diagram of a method or system for image processing and computer vision, using invariant features and deep learning techniques illustrated in FIG. 5L, according to some embodiments.

FIG. 5N illustrates another simplified high-level block diagram of a method or system for generating recommendations for a skin condition using invariant features and deep learning techniques for image processing and computer vision, according to some embodiments.

### DETAILED DESCRIPTION

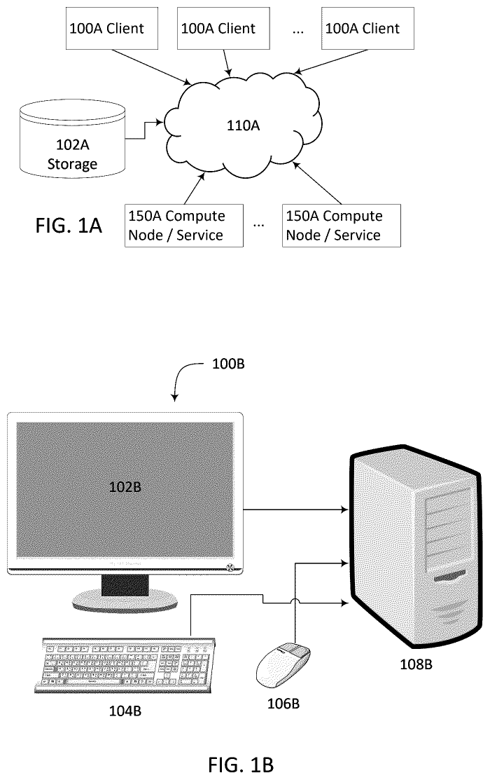

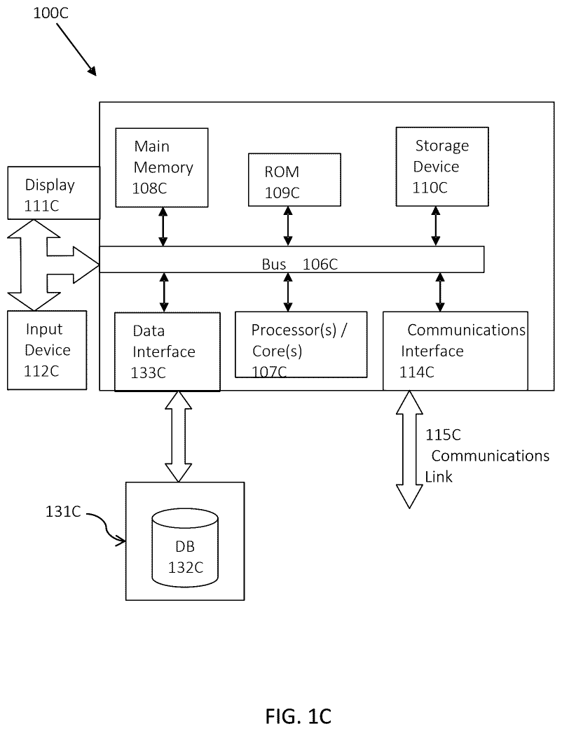

FIG. 1A illustrates a simplified, high-level block diagram of a computing environment for image processing and computer vision, using invariant features and deep learning techniques, according to some embodiments. More specifically, FIG. 1A illustrates a computing environment where a plurality of client systems 100A (e.g., one or more computing devices such as a tablet, a laptop, a desktop, a server, etc. in a medical care facility) may be connected with plurality of compute nodes and/or services for image processing and computer vision using invariant features and deep learning techniques, via a cloud computing environment or a network 110A (e.g., a private cloud, a public cloud, a hybrid cloud, the Internet, an intranet, a mesh network, etc.) to provide various features, functions, tasks, etc. In some of the embodiments and implementations described herein, the invariant features comprise one or more invariant physiological features where an invariant physiological feature is located at a fixed location with respect to a part such as a piece of bone in a human body. An invariant feature thus distinguishes from other features that may be disguised, occluded, or mutilated due to, for example, movements of soft tissues such as muscles, tendons, ligaments, etc.

The cloud computing environment or network 110A may be provisioned for by one or more compute nodes and/or compute services 150A (e.g., one or more server computers, one or more virtual machines, one or more executable containers, a set of services such as software as a service, a set of microservices, etc.) in some embodiments. Moreover, the cloud computing environment or network 110A may be coupled with a storage 102A that is configured to store various pieces of data or information described herein.

FIG. 1B illustrates a simplified computer system on which various methods for image processing and computer vision using invariant features and deep learning techniques may be implemented, according to some embodiments. For example, the example computing system 100B may be implemented in a manner to allow for provisioning various techniques, functionalities, features, etc. described herein.

The computing system 100B may include, for example, a computing device 108B including, for example, one or more central processing units (CPUs), one or more graphics processing units (GPUs), memory, storage devices, etc., a display 102B, a physical or virtual pointing device 106B (e.g., a physical or virtual touchpad, mouse, stylus, pen, etc.), a physical or virtual keyboard 104B, or any other required or desired components, etc. to facilitate provisioning various techniques, functionalities, features etc. described herein.

FIG. 1C illustrates a block diagram of an illustrative computing system suitable for implementing some embodiments for image processing and computer vision using invariant features and deep learning techniques, according to some embodiments. More specifically, FIG. 1C is a block diagram of an illustrative computing system 100C suitable for implementing at least some of the various embodiments described herein. Computer system 100C includes a bus 106C or other communication mechanism for communicating information, which interconnects subsystems and devices, such as processor 107C, system memory 108C (e.g., RAM), static storage device 109C (e.g., ROM), disk drive 110C (e.g., magnetic or optical), communication interface 114C (e.g., modem or Ethernet card), display 111C (e.g., CRT or LCD), input device 112C (e.g., keyboard), and cursor control.

The illustrative computing system 100C may include an Internet-based computing platform providing a shared pool of configurable computer processing resources (e.g., computer networks, servers, storage, applications, services, etc.) and data to other computers and devices in a ubiquitous, on-demand basis via the Internet in some embodiments. For example, the computing system 100C may include or may be a part of a cloud computing platform (e.g., a public cloud, a hybrid cloud, etc.) where computer system resources (e.g., storage resources, computing resource, etc.) are provided on an on-demand basis, without direct, active management by the users in some embodiments.

According to one embodiment of the present disclosure, computer system 100C performs specific operations by processor 107C executing one or more sequences of one or more instructions contained in system memory 108C. Such instructions may be read into system memory 108C from another computer readable/usable medium, such as static storage device 109C or disk drive 110C. In alternative embodiments, hard-wired circuitry may be used in place of or in combination with software instructions to implement the present disclosure. Thus, embodiments of the present disclosure are not limited to any specific combination of hardware circuitry and/or software. In one embodiment, the term “logic” shall mean any combination of software or hardware that is used to implement all or part of the present disclosure.

The term “computer readable medium” or “computer usable medium” as used herein refers to any medium that participates in providing instructions to processor 107C for execution. Such a medium may take many forms, including but not limited to, non-volatile media and volatile media. Non-volatile media includes, for example, optical or magnetic disks, such as disk drive 110C. Volatile media includes dynamic memory, such as system memory 108C.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the present disclosure, execution of the sequences of instructions to practice the present disclosure is performed by a single computer system 100C. According to other embodiments of the present disclosure, two or more computer systems 100C coupled by communication link 115C (e.g., LAN, PTSN, or wireless network) may perform the sequence of instructions required to practice the present disclosure in coordination with one another.

Computer system 100C may transmit and receive messages, data, and instructions, including program, e.g., application code, through communication link 115C and communication interface 114C. Received program code may be executed by processor 107C as it is received, and/or stored in disk drive 110C, or other non-volatile storage for later execution. Computer system 100C may communicate through a data interface 133C to a database 132C on an external storage device 131C.

In the foregoing specification, the present disclosure has been described with reference to specific embodiments thereof. It will, however, be evident that various modifications and changes may be made thereto without departing from the broader spirit and scope of the present disclosure. For example, the above-described process flows are described with reference to a particular ordering of process actions. However, the ordering of many of the described process actions may be changed without affecting the scope or operation of the present disclosure. The specification and drawings are, accordingly, to be regarded in an illustrative rather than restrictive sense.

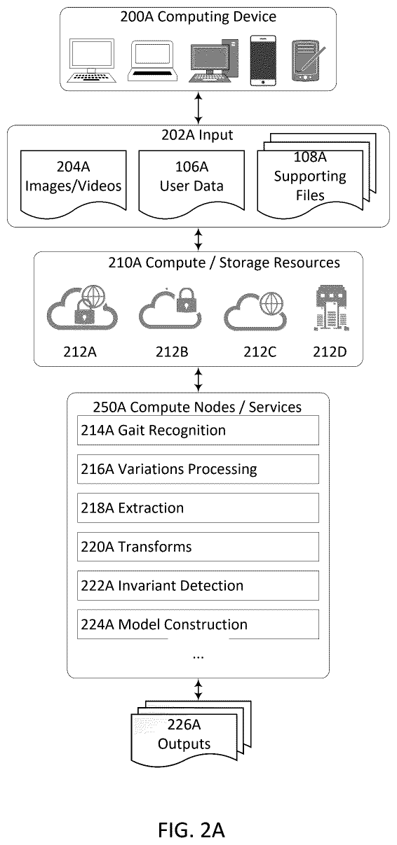

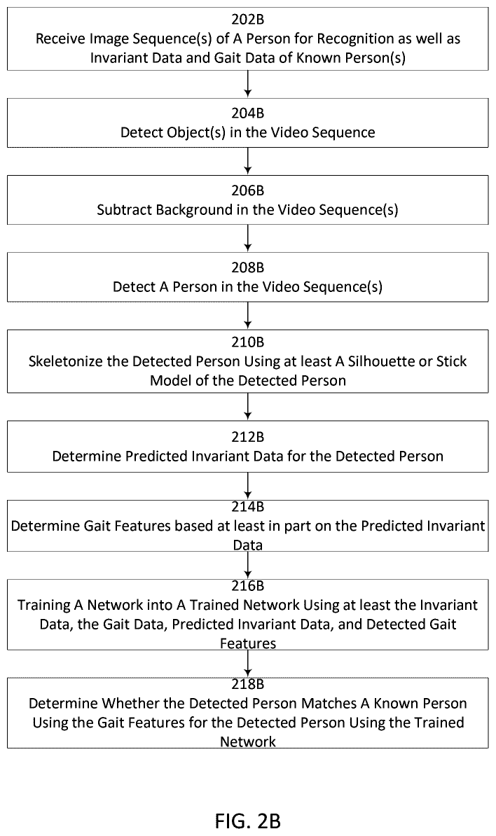

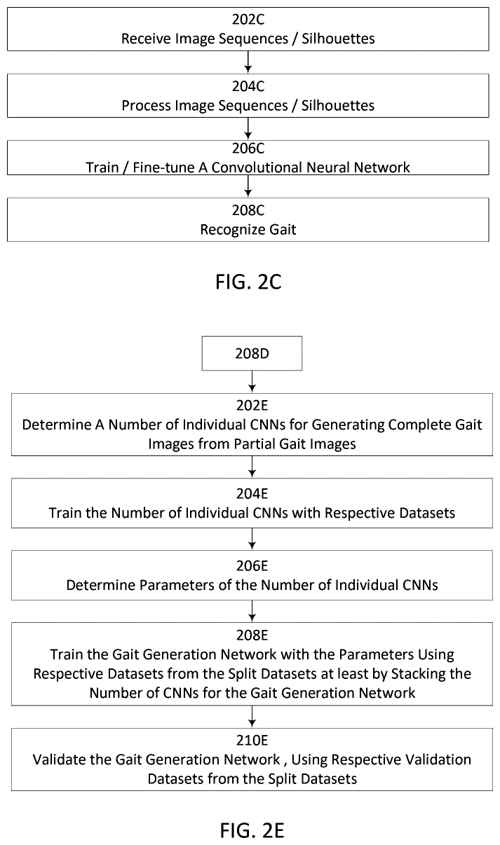

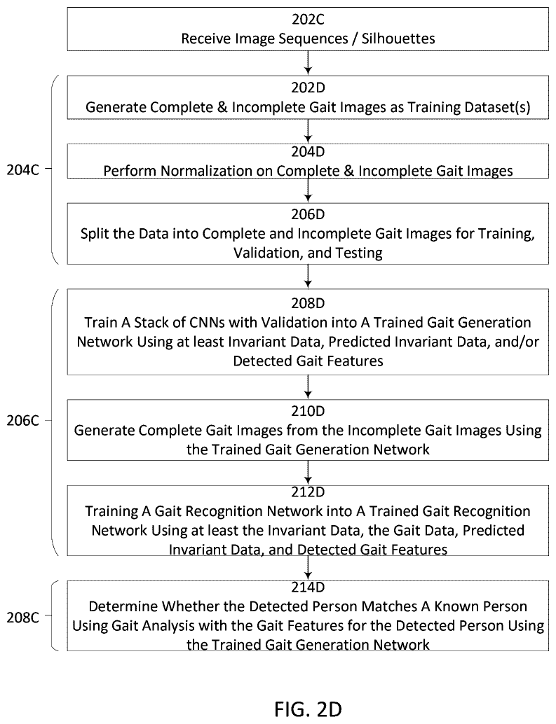

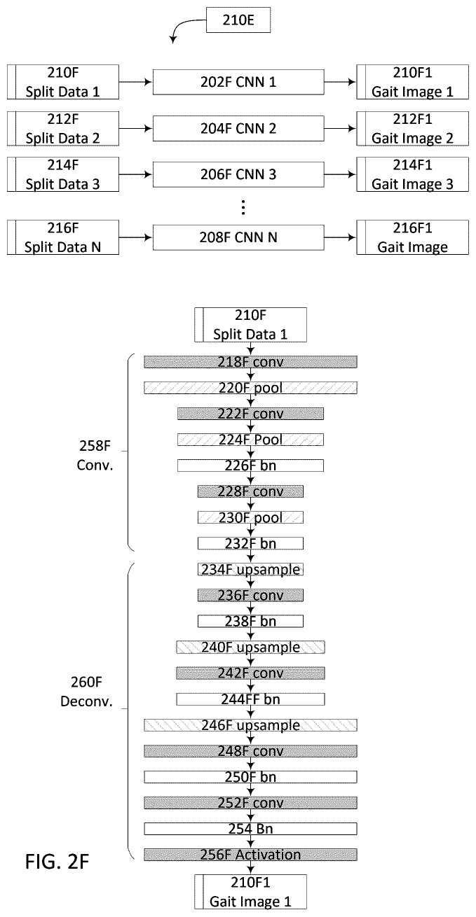

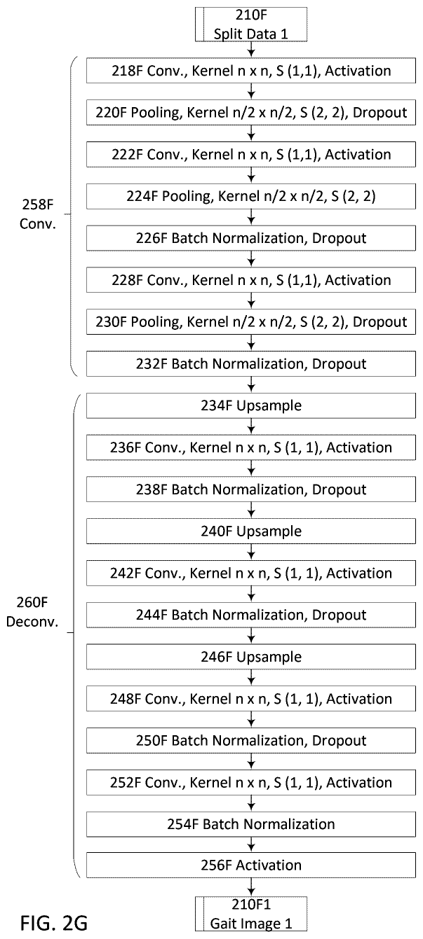

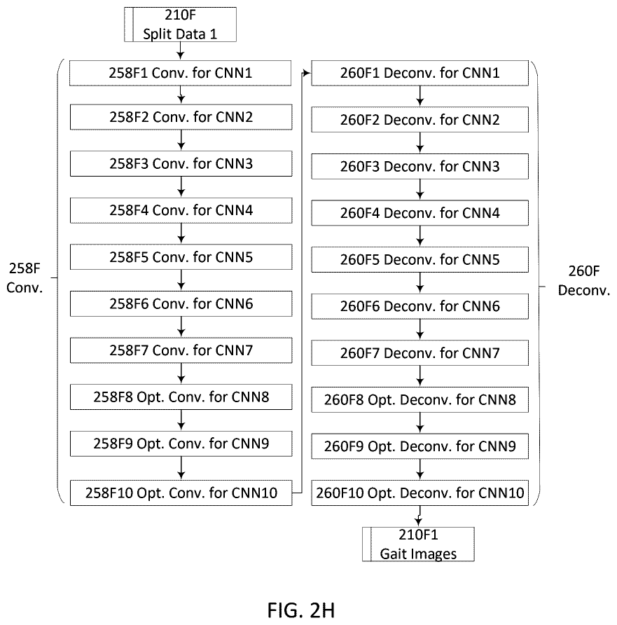

FIG. 2A illustrates a simplified high-level block diagram of method or a system for image processing and computer vision, using invariant features and deep learning techniques, according to some embodiments. In these embodiments, one or more client computing devices 200A (e.g., a desktop or laptop computer, a terminal, a smart phone, a personal digital assistant, a tablet computing device, etc.) may provide an input 202A to an one or more compute nodes and/or services 250A for image processing and computer vision, using invariant features and deep learning techniques. The input 202A may include, for example but not limited to, a plurality of images and/or a plurality of sequences of images such as one or more videos 204A and user data 206A. In some of these embodiments, the input 202A may also include one or more supporting files 208A such as, without limitation, libraries, scripts, routines, etc.

The input 202A may be stored in or provisioned by one or more compute and/or storage resources 210A such as a hybrid cloud 212A, a private cloud 212B, or a public cloud 212C in some embodiments. In some other embodiments, the input 202A may be stored in or managed by a server via a traditional network infrastructure 212D (e.g., the Internet or an intranet). In other embodiments, the input 202A may be stored in any combination of a hybrid cloud 212A, a private cloud 212B, a public cloud 212C, or a remotely accessible server via a traditional network infrastructure 212D.

The plurality of compute nodes and/or services 250A includes a plurality of different software programs. Each of the plurality of software programs may be provided to the one or more client computing devices 200A in a variety of forms such as a monolithic application program, a set of integrated application programs, one or more virtual machines and/or one or more virtualized containers, a set of services, a set of microservices, or any combinations thereof. In some of these embodiments illustrated in FIG. 2A, the plurality of compute nodes and/or services 250A may be provide as a cloud service such as a hybrid cloud 212A, a private cloud 212B, or a public cloud 212C described above.

In some embodiments, the plurality of compute nodes and/or services 250A may be hosted by one or more servers that are connected to the one or more client computing devices via a traditional network infrastructure 212D. In other embodiments, the plurality of compute nodes and/or services 250A may be provided to the one or more client computing devices 200A in any combination of a hybrid cloud 212A, a private cloud 212B, a public cloud 212C, or one or more servers connected via a traditional network infrastructure 212D. In these embodiments, the plurality of compute nodes and/or services 250A receives the input 202A and performs various operations for the input 202A to generate outputs 226A such as recommendations, classifications, predictions, etc.

In some embodiments, the plurality of compute nodes and/or services 250A may include a gait recognition software program 214A that may perform various operation to analyze, recognize, and determine whether a gait cycle or a smaller portion of a gait cycle of a person matches that of another person. The plurality of compute nodes and/or services 250A may include variations processing software program 216A that performs various operations to account for variations in analyses such as when a person being recognized is carrying a bag or case in his hand(s), on his shoulder, or on his back, whether a person being recognized is wearing clothing that occludes the his gait cycles, whether a person is wearing accessories, clothing, or fake feature (e.g., fake beard) that impedes the visibility of facial feature, or any other variations of a person that may impede capturing of features or attributes of the person or a portion thereof and hence recognition of the person.

The plurality of compute nodes and/or services 250A may include one or more extraction software programs 218A that extract features from an image or a sequence of images and one or more transforms 220A such as a perspective transform (e.g., a perspective transform from a physical world coordinate frame to a camera pose coordinate frame), a 2D or 3D coordinate transform (e.g., a translation transform, a rotation transform, a scaling transform, or any combinations thereof), a transform between a first coordinate frame and a second coordinate frame such as a camera pose coordinate frame to a pixel coordinate frame, or any combinations thereof, etc.

The plurality of compute nodes and/or services 250A may include one or more invariant detection software programs 222A. For example, the plurality of compute nodes and/or services 250A may include a facial invariant feature detection software program that detects one or more invariant features such as the locations at which a retaining ligament or a true ligament is attached to corresponding bones. A retaining ligament extends from one bone to another bone and attaches to these two bones while a true ligament extends from a bone to skin, not necessarily (and oftentimes not) from one bone to another bone. Nonetheless, some ligaments on a face of a person have been recognized as true retaining ligaments in the medical field. For example, orbital ligament, zygomatic ligament, infraorbital ligament, masseteric ligament, and mandibular ligament have been accepted and recognized as the true retaining ligaments of the face.

For gait analyses, some embodiments account for the feet, the knees, and the hips. For the feet, the ligaments that may be accounted for by some implementations described herein include, for example but not limited to, plantar fascia, deltoid ligament, and/or a lateral ligament complex. The plantar fascia is a ligament that runs from the heel to the toes to support the arch of the foot. A deltoid ligament is located on the inner side of the ankle with the attachment points of medial malleolus (e.g., inner ankle bone) to the talus, calcaneus, and navicular bones. A lateral ligament complex includes the anterior talofibular ligament, calcaneofibular ligament, and posterior talofibular ligament with the attachment points of lateral malleolus (the outer ankle bone) to the talus and calcaneus.

In some embodiments that account for knees in gait analyses, the locations at which ligaments attach to the corresponding bones may be extracted as invariant features. These ligaments may include one or more of the anterior cruciate ligament, the posterior cruciate ligament, the medial collateral ligament, and/or a lateral collateral ligament. The anterior cruciate ligament provides one or more invariant physiological locations or features that may be extracted and may include the lateral femoral condyle (inside the knee) to the anterior intercondylar area of the tibia (e.g., the front of the shin bone).

The posterior cruciate ligament provides one or more invariant physiological locations or features that may be extracted and may include medial femoral condyle (inside a knee) to the posterior intercondylar area of the tibia (e.g., back of the shin bone). The medial collateral ligament provides one or more invariant physiological locations or features that may be extracted and may include the medial epicondyle of the femur (e.g., inner thigh bone) to the medial condyle of the tibia (e.g., inner shin bone). The lateral collateral ligament provides one or more invariant physiological locations or features that may be extracted and may include the lateral epicondyle of the femur (e.g., outer thigh bone) to the head of the fibular (e.g., outer shin bone).

In some embodiments that account for knees in gait analyses, the locations at which ligaments attach to the corresponding bones may be extracted as invariant features. These ligaments may include one or more of the iliofemoral ligament, the pubofemoral ligament, and/or the ischiofemoral ligament. The iliofemoral ligament is the ligament that prevents hyperextension of the hips with the attachment points of ilium (e.g., pelvis) to the intertrochanteric line of the femur (e.g., upper thigh bone). The pubofemoral ligament provides the attachment points from the pubic bone (e.g., pelvis) to the femur (near the lesser trochanter). The ischiofemoral ligament provides the attachment points from the ischium (e.g., pelvis) to the femur (from the posterior aspect).

One or more of the aforementioned locations or attachment points on the bones to which true or retaining ligaments attach may be extracted by a deep learning model and may be deemed as invariant features of a person because unless the person's underlying bone structure is somehow altered, these locations or attachment points remain invariant, at least with respect to the corresponding bones.

The plurality of compute nodes and/or services 250A may include a model construction software program 224A that reconstructs a 2D model from a 2D image or a sequence of 2D images or constructs a 3D model from a 2D image or a sequence of 2D images. In various embodiments described herein, the plurality of compute nodes and/or services 250A receives the input 202A, invokes one or more of the aforementioned software programs (e.g., 214A, 216A, 218A, 220A, 122A, and/or 224A), and performs various operations on the input 202A to generate outputs 226A such as recommendations, classifications, predictions, etc.

In some embodiments where x-ray devices, thermal imaging devices (e.g., high-resolution infrared thermal imaging or HRIT, other infrared thermal imaging, etc.), some ultrasound imaging devices, or other radiography devices (e.g., portable radiography devices) are used, at least some of the aforementioned physiological invariant features (e.g., points at which a ligament attaches to bones) may be identified and may be further utilized in subsequent operations (e.g., constructing a 3D or 2D model representing a user or a portion thereof such as a facial model, a gait model, etc.) It shall be noted that a normal bone appears as a hyperechoic continuous line related to the interface between the outer cortex and the adjacent tissues. Ultrasound, due to different acoustic impedance between soft tissues and the bone cortex, allows the evaluation of the bone surfaces and thus fits the purpose of determining the aforementioned physiological invariant features under certain circumstances.

In some other embodiments where conventional image capturing devices (e.g., cameras, video cameras, etc.) that are capable of only capturing the reflected light off a subject, computing imaging processing and recognition techniques may be utilized to estimate the locations of the aforementioned physiological invariant features that may also be utilized in subsequent operations (e.g., constructing a 3D or 2D model representing a user or a portion thereof such as a facial model, a gait model, etc.) For example, some embodiments described herein may reference other perceivable features on a user's body (or face) to estimate the locations at which a ligament attaches to the underlying, imperceivable bones.

For example, the inner corner of an eye to the outer corner of the same eye may be determined based on the orbicularis retaining ligament or vice versa; the outer corner of an eye to the termination of the corresponding eyebrow may be determined based on the orbicularis retaining ligament, superior temporal septum, and inferior temporal septum; and the nasal ala to the tragus may be determined based on the zygomatic-cutaneous retaining ligament. Further, the corner of the mouth to the lowest point of the ear may be determined based on the mandibular ligament, platysma auricular ligament, and platysma auricular fascia; the philtrum distance may be determined based on the upper branch of the superior orbicularis or is nasalis muscle insertion site to the skin forming the ridges at the philtrum.

These locations or the line or curve segments connecting some of these locations may be determined and are approximately aligned with the fibrous band of tissues of the respective retaining ligaments or the respective true ligaments, and at least some of the new landmark points approximately correspond to the respective points at which the corresponding retaining ligaments attach to the bones or to the respective points at which the corresponding true ligaments attach to the bones or to the skin, or to a combination of respective points at which one or more retaining ligaments and one or more true ligaments attach.

It shall be noted that a ligament (e.g., retaining ligament, true ligament, or true retaining ligament) may not necessarily exhibit a single direction of the fibrous band of tissues of the ligament. Rather, some ligaments (e.g., the zygomatic ligament) may exhibit one or more “bends” and hence multiple directions for its fibrous band of tissues. Therefore, the approximate alignment of a length parameter with the fibrous band of tissues of a ligament refers to the approximate alignment of the length parameter with the general direction or orientation of the ligament (e.g., the approximate direction pointing from one end to the other end of the ligament), rather than the strict direction or orientation of the ligament's fibrous band of tissues, in some embodiments. Similar locations and line or curve segments may be determined in the hip, thigh, leg, ankle, and/or foot areas for a person.

Nonetheless, constructing a 3D or 2D model using at least these physiological invariant points and/or line or curve segments facilitate the recognition of a person, regardless of how the person to be recognized alters his or her appearances.

Some of these embodiments may further leverage the statistical average distances of the ethnic group to which the person belongs to estimate the locations at which a ligament attaches to the underlying, imperceivable bones. These embodiments may be applied to scenarios where some of even all of the aforementioned locations on a person are imperceivable by conventional cameras or video cameras, and a similar 3D or 2D model may be constructed to facilitate the recognition of the person or a portion thereof.

FIG. 2B illustrates a simplified block diagram of a method or system for image processing and computer vision, using invariant features and deep learning techniques, according to some embodiments. More specifically, FIG. 2B illustrates a simplified block diagram of a method or system for recognizing a person by performing a gait analysis.

It takes dozens of muscles working together throughout the body of a person to put one foot in front of the other. These subtle patterns of muscular flexes and strains are so distinctive that scientists believe these subtle patterns are as unique to a person as the person's fingerprint or iris. There are two phase in a stride or gait cycle—stance phase and swing phase. The stance phase is usually further categorized into five sub-phases—(1) initial contact phase, (2) loading response phase, (3) mid-stance phase, (4) terminal stance phase, and (5) pre-swing phase. The swing phase is generated categorized into three sub-phases—(1) early swing phase, (2) mid swing phase, and (3) terminal swing phase.

The initial contact phase accounts for about 0% (an instant) into a gait cycle and represents a foot touches the ground and begins the first phase of double support. The function is to establish contact with the ground surface and initiate weight acceptance and usually involves concentric to eccentric dorsiflexors of the ankle with neutral motion (e.g., zero degree) of the ankle, about five degrees of flexion motion of the corresponding knee which exhibits eccentric extensors, and about 30 degrees of flexion motion with concentric extensors and eccentric flexors.

The loading response phase accounts for about 0-10% into a gait cycle and begins with the initial contact and continues until the contralateral foot leaves the ground. The foot continues to accept weight and absorb shock by rolling into pronation. This loading response phase involves rapid plantarflexion motion of the corresponding ankle to about 10 degrees of eccentric dorsiflexors muscle action, about 10-15 degrees of flexes of motion of the corresponding knee with eccentric extensors and concentric flexors muscle actions, as well as gradual extension of the hip with concentric extensors muscle actions.

The mid-stance phase accounts for about 10-30% into a gait cycle and begins when the contralateral foot leaves the ground and continues until ipsilateral heel lifts off the ground. The body is supported by a single leg and begins to move from force absorption at impact to force propulsion forward. The mid-stance phase involves gradual dorsiflexion motion of the ankle with eccentric plantarflexors and concentric dorsiflexors muscle actions, the knee begins to extend with concentric extensors muscle actions, and the hip exhibits gradual extension also with concentric extensors muscle actions.

The terminal stance phase accounts for about 30-50%. into a gait cycle begins when the heel leaves the floor and continues until the contralateral foot contacts the ground. In addition to single limb support and stability, this event serves to propel the body forward. Bodyweight is divided over the metatarsal heads. The terminal stance phase involves gradual dorsiflexion of the ankle until a maximum of about 10 degrees before beginning to plantarflex with eccentric plantarflexors followed by concentric plantarflexors muscle actions. The knee continues extending until a maximum of about 5 degrees of flexion before beginning to flex with concentric extensors followed by eccentric extensors and concentric flexors, and the hip muscle actions. The hip extends until a maximum of about 10 degrees of extension with eccentric flexors muscle actions.

The pre-swing phase accounts for about 50-60% into a gait cycle and begins when the contralateral foot contacts the ground and continues until the ipsilateral foot leaves the ground. Provides the final burst of propulsion as the toes leave the ground. The pre-swing phase begins with the ankle beginning to plantarflex rapidly before foot leaves the ground and involves concentric plantarflexors muscle actions. The knee begins to flex rapidly with Eccentric extensors muscle actions; and the hip begins to flex before foot leaves the ground with concentric flexors muscle actions.

The early swing phase accounts for 60-75% into a gait cycle and begins when the foot leaves the ground until it is aligned with the contralateral ankle. This event functions to advance the limb and shorten the limb for foot clearance. During the early swing phase, the ankle continues to plantarflex until a maximum of about 20 degrees before moving back towards a neutral position with eccentric dorsiflexors followed by concentric dorsiflexors and eccentric plantarflexors muscle actions; the knee exhibits rapid knee flexion until a maximum of about 60 degrees with eccentric extensors and concentric flexors muscle actions; and the hip gradually flexes with concentric flexors muscle actions.

The mid swing phase accounts for 75-85% into a gait cycle and begins from the ankle and foot alignment and continues until the swing leg tibia is vertical. As in early swing, it functions to advance the limb and shorten the limb for foot clearance. During the mid swing phase, the ankle maintains a neutral position with concentric dorsiflexors muscle actions; the knee begins to extend with eccentric flexors muscle actions; and the hip continues to flex until a maximum of just over about 30 degrees with concentric flexors muscle actions.

The terminal swing phase accounts for about the last 15% of a gait cycle and begins when the swing leg tibia is vertical and ends with initial contact. Limb advancement slows in preparation. During the terminal swing phase, the ankle maintains a neutral position with concentric dorsiflexors muscle actions; the knee extends until full extension, and flexes just slightly before initial contact with eccentric flexors followed by concentric flexors muscle actions; and the hip remains flexed to around 30 degrees with concentric flexors and eccentric extensors followed by concentric extensors muscle actions.

Some embodiments partition the data of a gait cycle or a smaller portion thereof into a plurality of uniform or non-uniform subsets of data and feed each subset into a network where each subset corresponds to a period of time of the data. It is noted that analyses of a gait cycle produce arguably more accurate results when the person being recognized is captured from the side (e.g., side views), traveling in a direction orthogonal to the direction of the camera pose. These embodiments thus iteratively use a respective network to process a subset of the gait data.

In these embodiments illustrated in FIG. 2B, one or more images or one or more sequences of images (e.g., one or more video sequences) of a person to be recognized may be received at 202B. In addition, invariant data (e.g., data pertaining to physiological invariant features of a person) and gait data (e.g., data for one or more full gait cycles or a smaller portion of a full gait cycle) of one or more known persons may be received at 202B. Such data may be stored in one or more data structures such as one or more databases.

One or more objects may be detected at 204B. For example, one or more convolutional neural networks may be used to extract features from the one or more images or one or more image sequences, extract the features, and classify the extracted features for entity recognition at 204B. In some of these embodiments, the background in the image(s) or image sequence(s) may be subtracted at 206B. In these embodiments, a foreground includes the subject to be recognized, and the remainder of the image(s) or image sequence(s) is categorized as the background. For example, in an image containing a person, the detected person or a portion thereof, any accessories carried by or attached to the person (e.g., bag, backpack, purse, hat, sunglasses, etc.) are categorized as the foreground while the remaining detected objects are categorized as background and may be subtracted from the image(s) or image sequence(s).

A person may then be detected at 208B, and the detected person may be skeletonized at 210B. In some embodiments, skeletonizing a detected person may use a silhouette of the detected person or a “stick” diagram including sticks representing the torso and limbs of the detected person with joints connecting the hip portion, the thigh portions, the leg portions, the ankle portions, and the foot portions. Invariant data may be predicted or determined at 212B for the detected person.

As described above, in some embodiments where x-ray devices, thermal imaging devices (e.g., high-resolution infrared thermal imaging or HRIT, other infrared thermal imaging, etc.), some ultrasound imaging devices, or other radiography devices (e.g., portable radiography devices) are used, at least some of the aforementioned invariant data (e.g., points at which a ligament attaches to bones) may be determined or predicted at 212B using the detected, skeletonized person. In some other embodiments where conventional image capturing devices (e.g., cameras, video cameras, etc.) that are capable of only capturing the reflected light off a subject, the aforementioned invariant data may be estimated from the silhouette or the stick model.

With the invariant data, gait features may be determined at 214B using the predicted or determined invariant data. In some of these embodiments, gait features may include the motion characteristics such as the different stages or phases of motions, relative positions and/or orientations of various portions of the body of the person (e.g., toes, feet, ankles, legs, knees, thighs, and/or hips, etc.), the temporal durations of these different stages or phases or motions, etc.

A network may be optionally trained at 216B using at least the invariant data determined or predicted at 212B, the gait data received at 202B, the invariant data received at 202B, and/or the gait features determined at 214B in some embodiments. In these embodiments, the network may perform inferences while being trained or fine-tuned at 216B. A determination may be made at 218B to decide whether the detected person matches a known person using at least the gait features determined at 214B for the person to be recognized and the trained network. It shall be noted that the aforementioned processes may or may not necessarily be performed in the order illustrated in FIG. 2B or described above, and that a first process may be performed ahead of a second process despite the fact that the first process is illustrated to follow the second process in FIG. 2B or described above. For example, process 208B may be performed before process 206B although 208B is illustrated as following 206B.

FIG. 2C illustrates a simplified high-level block diagram of a method or system for image processing and computer vision, using invariant features and deep learning techniques, according to some embodiments. In these embodiments, one or more image sequences and/or silhouettes may be received at 202C. These one or more image sequences and/or silhouettes may be processed at 204C. A convolutional neural network may be trained or fine-tuned at 206C; and gait features may be recognized at 208C, using the trained convolutional neural network. In some of these embodiments, training, re-training, or fine-tuning the neural network may include adjusting the neural network for more accurate extraction or determination of features (e.g., extraction or determination of invariant physiological features) from image data.

FIG. 2D illustrates more details about a portion of the simplified high-level block diagram of a method or system for image processing and computer vision, using invariant features and deep learning techniques illustrated in FIG. 2C, according to some embodiments. More specifically, FIG. 2D illustrates more details about each of processes in FIG. 2C. In these embodiments, the process begins with receiving one or more image sequences or silhouettes at 202C as in FIG. 2C.

Processing the one or more image sequences or silhouettes at 204C may include generating complete and incomplete gait images as one or more training datasets at 202D. In some embodiments, gait images may include, for example but not limited to, (1) GEI or gait energy image; (2) gait entropy image (GEnI), (3) MIEI (Motion Information energy Image), (4) Frame Difference Energy Iage (FEDI), (5) Enhance Gait Energy Image (EGEI); (6) Chrono Gait Image (CGI), and/or (7) Gait Flow Image (GFI). In some embodiments, different incomplete gait images may be generated as training dataset(s) each having the same or different number of frames. In some of these embodiments, the starting frame of a dataset may be selected randomly. Incomplete gait images refer to gait images that do not form a complete gait cycle while complete gait images refer to gait images that form a complete gait cycle or a multiples thereof.

Processing the one or more image sequences or silhouettes at 204C may further include normalizing the complete and/or incomplete gait images at 204D for training, validation, or testing a model such as a convolutional neural network. In these embodiments, normalization helps ensure that the pixel values of images are within a consistent range, making it easier for the model to learn patterns. In some embodiments, the convolutional neural network may include a stack of neural networks (e.g., a stack of fully convolutional networks), and each network of the stack of neural networks may receive a corresponding dataset with a different starting frame.

Processing the one or more image sequences or silhouettes at 204C may further include splitting the data at 206D for the received image sequence(s) and/or silhouettes into complete and incomplete gait images for training, validation, and/or testing the convolutional neural network. In some of these embodiments, a subset of the data may include both complete gait image(s) and incomplete gait image(s) of one or more types of incomplete gait images. In some embodiments, splitting the data at 206D may also include splitting the data to form, in addition to one or more subsets each having incomplete and/or complete gait images, a reference subset that contains the same number of types of incomplete gait images. In some embodiments, splitting the data at 206D may also include splitting the data to form, in addition to one or more subsets each having incomplete and/or complete gait images, a gallery subset that contains only complete gait images.

In some embodiments, training or fine-tuning a convolutional neural network at 206C may include training a stack of convolutional neural networks (CNNs) with validation into a trained gait generation network at 208D, using at least the invariant data, the gait data, predicted invariant data, and/or the detected gait features that are described above with reference to FIG. 2B. In some of these embodiments, the stack of CNNs may include fully convolutional neural networks (FCNs). In some of these embodiments, the hidden layers of the FCNs may be stacked together to have one end-to-end network that learns or is trained as a single neural network for complex tasks using as input directly the raw input data without any manual feature extraction.

Training or fine-tuning a convolutional neural network at 206C may further include generating complete gait images at 212D from one or more incomplete gait images using the trained gait generation network determined at 210D. These embodiments address the strong assumption and hence a major shortfall of conventional approaches that assumes that a full gait cycle of individuals is available. This is a strong assumption, especially in video surveillance applications where occlusion may occur, and a person may be observed in only a few frames.

These embodiments construct a complete gait image set from an incomplete gait image using the trained stack of FCNs that gradually transforms the incomplete gait image by, for example, transforming the incomplete gait image to a first incremental stage of a gait cycle using a first FCN in the stack, transforming the first incremental stage gait image to a second incremental stage of the gait cycle using a second FCN in the stack, transforming the second incremental stage gait image to a third incremental stage of the gait cycle using a third FCN in the stack, etc. until the gait images for a complete gait cycle. For example, the stack of FCNs may include five (resulting in six intervals for a gait cycle), seven (resulting in eight intervals for a gait cycle), nine (resulting in ten intervals for a gait cycle), eleven (resulting in twelve intervals for a gait cycle), etc. fully convolutional networks each responsible for transforming an input gait image to the next stage of a gait cycle with a small increment for the transformation (e.g., one of the eight phases or smaller than one phase). More details about constructing a complete gait image set from an incomplete gait image(s) will be described below with reference to at least FIGS. 2E-2H.

Recognizing gait features at 208C in FIG. 2C may include determining whether the detected person matches a known person at 214D by using a gait analysis with the gait features of the detected person and the trained gait generation network that includes the aforementioned stack of FCNs.

FIG. 2E illustrates more details about a portion of the simplified high-level block diagram of a method or system for image processing and computer vision, using invariant features and deep learning techniques illustrated in FIG. 2D, according to some embodiments. More specifically, FIG. 2E illustrates more details about training a stack of convolutional neural networks (CNNs) with validation into a trained gait generation network at 208D of FIG. 2D. In these embodiments, a number of individual CNNs for generating complete gait images from partial gait image(s) may be determined at 202E. As described herein, incomplete gait images refer to gait images that do not form a complete gait cycle while complete gait images refer to gait images that form a complete gait cycle or a multiples thereof.

The number of individual CNNs may be trained at 204E with respective datasets. For example, a training dataset may be split into the equal number of subsets, and each individual CNN is trained with a corresponding, different subset at 204E. A plurality of parameters for an individual CNN may be determined and extracted at 206E; and the gait generation network may be trained at 208E with the extracted parameters of each individual CNN as well as the respective datasets from the split datasets. In some embodiments, the gait generation network may be formed by stacking the number of individual CNN.

In some embodiments, each CNN of the number of the individual CNNs is identical to one another. In some of these embodiments, each CNN is a fully convolutional neural network that performs only convolutions, downsampling, and/or upsampling and contains solely locally connected layers such as convolution, pooling, and upsampling while avoiding dense layers. A fully convolutional neural network is distinguishable from a fully connected neural network because a fully convolutional neural network does not include fully connected layer(s) that does not perform the convolution operation. The gait generation network may be trained end-to-end in some embodiments as a single neural network for complex tasks using as input directly the raw input data without any manual feature extraction. The gait generation network may be optionally validated at 210E, using respective validation datasets from the split datasets.

FIG. 2F illustrates more details about a portion of the simplified high-level block diagram of a method or system for image processing and computer vision, using invariant features and deep learning techniques illustrated in FIG. 2E, according to some embodiments. More specifically, FIG. 2F illustrates more details about training or validating the gait generation network at 210E of FIG. 2E. In these embodiments, a number of CNNs (e.g., 202F, 204F, 206F, . . . , 208F) may be identified. Each of the number of CNNs may receive a respective set of split data (e.g., 210F “split data 1”, 212F “split data 2”, 214F “split data 3”, . . . , 216F “split data 4”) and performs an incremental transformation to produce the respective outputs (e.g., 210F1 “gait image 1”, 212F1 “gait image 2”, 214F1 “gait image 3”, . . . , 216F1 “gait image 4”).

FIG. 2F further illustrates more details of a CNN in the number of CNNs. In some embodiments, each CNN in the number of CNNs (202F, 204F, 206F, . . . , 208F) is identical to one another. The architecture of the CNN includes a convolutional network 258F and a deconvolutional network 260F. For example, the convolutional network 258F of CNN 202F may receive the “split data 1” 210F at a first convolution layer 218F whose output is passed to a pooling layer 220F (e.g., a max pooling layer, an average pooling layer, etc.) The output of the pooling layer 220F is sent to a second convolution layer 222F whose output is sent to a second pooling layer 224F (e.g., a max pooling layer, an average pooling layer, etc.)

The output of the second pooling layer 224F is sent to a batch normalization layer 226F whose output is provided to a third convolution layer 228F. The output of the third convolutional layer 228F is sent to a third pooling layer 230F (e.g., a max pooling layer, an average pooling layer, etc.) whose output is provided to a second batch normalization layer 232F. The output of the second batch normalization layer 232F is provided to the deconvolutional network 260F. More particularly, the output of the second batch normalization layer 232F is provided to an upsampling layer 234F in the deconvolutional network 260F.

The output of the upsampling layer 234F is provided to a fourth convolutional layer 236F whose output is in turn provided to another batch normalization layer 244F. The output of the batch normalization layer 244F is further provided to an upsampling layer 246F whose output is provided to a fifth convolution layer 248F. The output of the fifth convolutional layer 248F is provided to another batch normalization layer 250F whose output is provided to a sixth convolutional layer 252F. The output of the sixth convolutional layer 252F is provided to another batch normalization layer 254F whose output is then processed by an activation layer 256F (e.g., a Rectified Linear Unit or ReLU) to generate the output “gait image 1” 210F1. After each CNN (202fF, 204F, 206F, . . . , 208F) performs its small, incremental transformation, the gait generation network including the stack of CNNs may thus generate gait images of a full gait cycle from even a single gait image that falls far short of a full gait cycle.

FIG. 2G illustrates more details about a portion of the simplified high-level block diagram of a method or system for image processing and computer vision, using invariant features and deep learning techniques illustrated in FIG. 2E, according to some embodiments. More specifically, FIG. 2G illustrates another example convolutional neural network that may be used in the stack of CNNs of a gait generation network. In these embodiments, the CNN may also include, like that in FIG. 2F, a convolutional neural network 258F and a deconvolutional neural network 260F.

The first convolutional layer 218F may include an n×n kernel with a stride of (1, 1) and an activation function (e.g., ReLU). The pooling layer 220F may include an n/2×n/2 kernel with a stride of (2, 2) and dropout that drops out one or more neurons in the pooling layer. Due the stride of (2, 2), the width and the height of the input are thus halved. The convolutional layer 222F may include an n×n kernel with a stride of (1, 1) and an activation function (e.g., ReLU). The pooling layer 224F may include an n/2×n/2 kernel with a stride of (2, 2). The batch normalization layer 226F may also include dropout that drops out one or more neurons. The convolutional layer 228F may include an n×n kernel with a stride of (1, 1) and an activation function (e.g., ReLU). The following pooling layer 230F may include an n/2×n/2 kernel with a stride of (2, 2) and dropout. The batch normalization layer 232F may include dropout. This concludes the convolutional network 258F.

The deconvolutional network 260F includes an upsampling layer 234F following by a convolutional layer 236F that may include an n×n kernel with a stride of (1, 1) and an activation function (e.g., ReLU). The batch normalization layer 238F may also include dropout. The convolutional layer 242F following the upsampling layer 240F may include an n×n kernel with a stride of (1, 1) and an activation function (e.g., ReLU) that is then followed by a batch normalization layer 244F with dropout. The next convolutional layer 248F following another upsampling layer 246F may include an n×n kernel with a stride of (1, 1) and an activation function (e.g., ReLU) that is in turn followed by a batch normalization layer 250F with dropout. The next convolutional layer 252F following the batch normalization layer 250F may include an n×n kernel with a stride of (1, 1) and an activation function (e.g., ReLU). This convolutional layer 252F precedes a batch normalization layer 254F that is in turn followed by an activation (e.g., ReLU) 256F. The gait generation network thus generates the activated output gait image 210F1.

FIG. 2H illustrates more details about a portion of the simplified high-level block diagram of a method or system for image processing and computer vision, using invariant features and deep learning techniques illustrated in FIG. 2E, according to some embodiments. More specifically, FIG. 2H illustrates another schematic diagram for a fully convolutional neural network that may be used in the stack of fully convolutional neural networks of a gait generation network that includes a convolutional network 258F and a deconvolutional network 260F. In these embodiments, the input “split data 1” 210F is provided to the hidden layers of the stack of CNNs. For example, the input 210F is provided to the convolutional layer(s) (258F1) of CNN1 which is followed by 258F2 convolutional layer(s) for CNN2, 258F3 convolutional layer(s) for CNN3, 258F4 convolutional layer(s) for CNN4, 258F5 convolutional layer(s) for CNN5, 258F6 convolutional layer(s) for CNN6, and 258F7 convolutional layer(s) for CNN7.

The convolutional network 258F may include one or more additional convolutional layers of one or more additional CNNs. For example, the output of the convolutional layer(s) of CNN7 (258F7) may be provided to the convolutional layer(s) for CNN8 (258F8), then to the convolutional layer(s) for CNN9 (258F9), and to the convolutional layer(s) for CNN10 (258F10).

The output of the convolutional network 258F is provided to the deconvolutional network 260F which includes the deconvolution layer(s) of CNN1 (260F1), the deconvolution layer(s) of CNN2 (260F2), the deconvolution layer(s) of CNN3 (260F3), the deconvolution layer(s) of CNN4 (260F4), the deconvolution layer(s) of CNN5 (260F5), the deconvolution layer(s) of CNN6 (260F6), and the deconvolution layer(s) of CNN7 (260F7). Similarly, the deconvolutional network 260F may include one or more additional deconvolutional layers of one or more additional CNNS. For example, the output of the deconvolution layer(s) of CNN7 (260F7) may be provided to the deconvolution layer(s) of CNN8 (260F8), then to the deconvolution layer(s) of CNN9 (260F9), and to the deconvolution layer(s) of CNN10 (260F10), etc. to produce the final output “gait image(s)” 210F1.

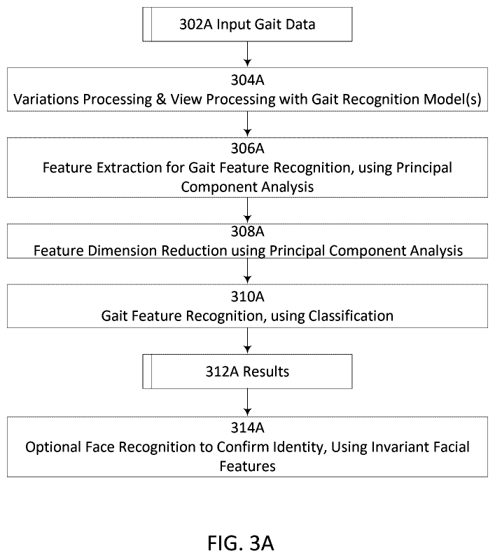

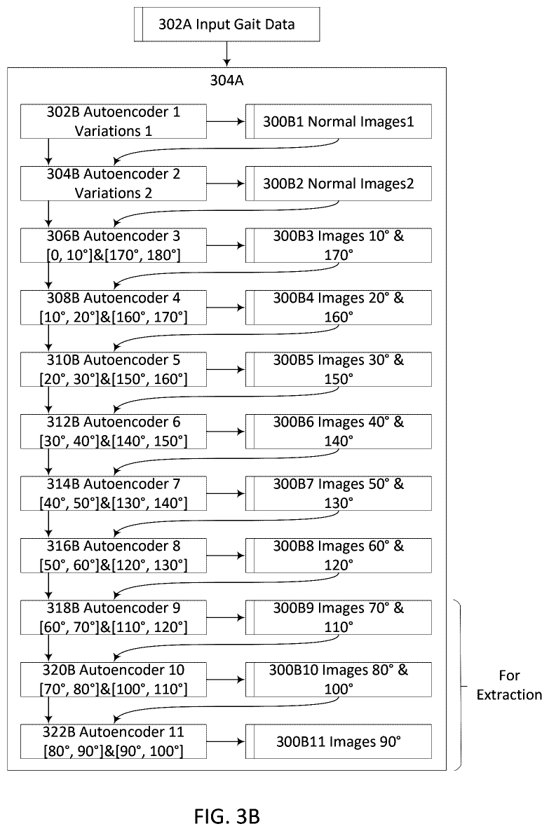

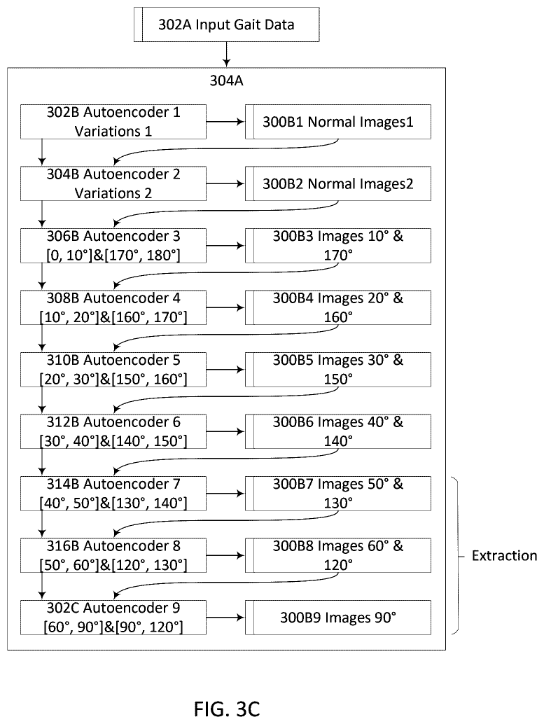

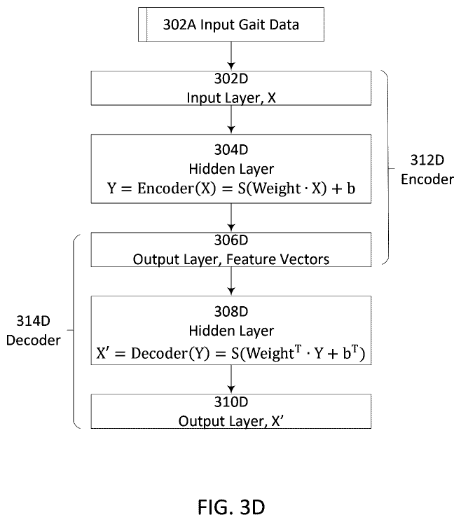

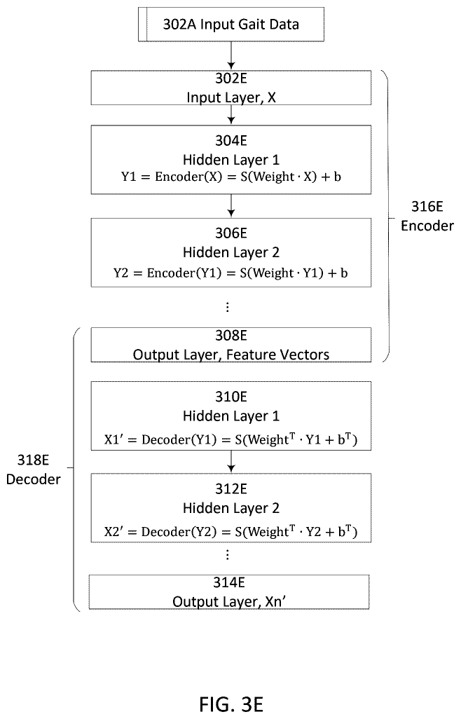

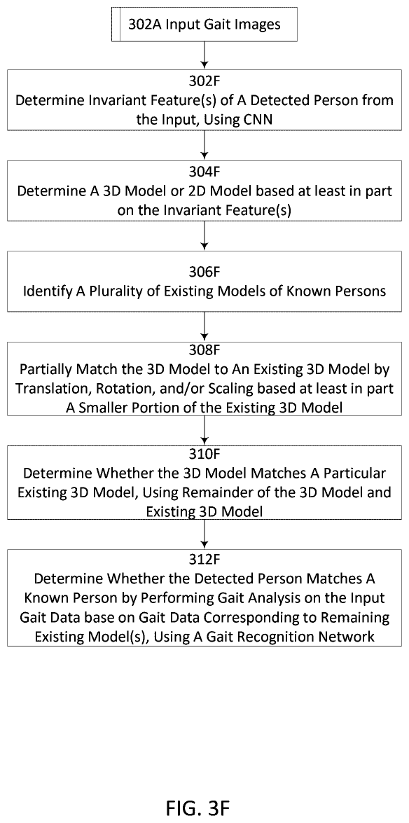

FIG. 3A illustrates a simplified high-level block diagram for image processing and computer vision, using invariant features and deep learning techniques, according to some embodiments. In these embodiments, gait data may be received at 302A. In some of these embodiments, the input gait data may be a gait dataset that may be split into a number of random datasets, eight different datasets respectively corresponding to the eight phases of a gait cycle, or a number of datasets respectively corresponding to the same number of fixed temporal intervals.

In these embodiments illustrated in FIG. 3A, the input gait data may include views from multiple different perspectives. In some of these embodiments, the input gait data may include one or more views that are influenced by variations that may further include, for example but not limited to, carrying condition variations (e.g., backpack, brief case, etc.), clothing condition variations (e.g., wearing a long coat, wearing a skirt, etc.) Various techniques described herein perform transformations to transform these different views to a normal view which represents the side view of a person's walking data.

Variations processing may be performed at 304A to process views representing various variations; and view processing may also be performed at 304A to process views captured from different perspectives at different elevation angles, different azimuth angles, different zooms, or any combinations thereof. In some embodiments, variations processing may be first performed prior to view processing. In some embodiments, variations processing and view processing may be performed by an auto-encoder that includes a first layer for performing a first variation processing (e.g., clothing condition variations) and a second layer for performing a second variation processing (e.g., carrying condition variations).

The auto-encoder may further concatenate a plurality of layers after the variations processing layers where the plurality of layers respectively, incrementally transform views captured at different perspectives by a small angle to eventually generate one or more normal views so that the discrepancies among the intermediate, transformed views become smaller and smaller as the perspective views processing progress into deeper layers of the network.

Feature extraction for gait feature recognition may be performed at 306A. In some embodiments, a principal component analysis (PCA) may be performed for feature extraction in some embodiments although some other embodiments utilize pre-training that separately trains each of the plurality of layers before finally rolling these individual, separate layers into the auto-encoder without using the principal component analysis.

Principal component analysis determines the direction(s) of the greatest variance in the input dataset and represents each data point by its coordinates along each of such direction(s). Some of these embodiments use a nonlinear generalization form of PCA that uses an adaptive, multilayer B-encoder network to transform higher-dimensional data into lower-dimensional code as well as a similar B-decoder network to recover the data from the code for the auto-encoder. This auto-encoder may be trained first with random weights in these two networks that can be trained together by minimizing the discrepancy between the original data and its reconstruction. The required gradients are determined by using, for example, the chain rule to backpropagate error derivatives first through the decoder network and then through the encoder network to fine tune the parameters in these two networks.

In some embodiments, feature dimension reduction may be performed at 308A. Some of these embodiments may utilize the principal component analysis for feature dimension reduction at 308A. Gait feature recognition may then be performed at 310A to generate the recognized gait features 312A by using a classifier. In some embodiments, the classifier recognizes gait features by using the support vector machine (SVM), the k-nearest neighbor classification algorithm, or other suitable classification algorithms.

With the gait features recognized, the detected person in the input data 302A may be matched with known persons by analyzing and comparing their gait features as gait includes subtle patterns of muscular flexes and strains that make a person's gait highly distinctive and unique to the person as the person's fingerprint and iris. Optionally, face recognition may be performed at 314A to confirm or reassure the identity of the person. In some embodiments, face recognition may also be performed using the invariant physiological points or line or curve segments.

FIG. 3B illustrates more details about a portion of the simplified high-level block diagram of a method or system for image processing and computer vision, using invariant features and deep learning techniques illustrated in FIG. 3A, according to some embodiments. More specifically, FIG. 3B illustrates more details about variations processing and perspective view processing at 304A of FIG. 3A that may be used for gait analyses and gait feature or pattern recognition.

In these embodiments, the variations processing and perspective view processing at 304A may receive input gait data 302A at Autoencoder 1 (302B) that performs variation condition processing for the first variation (e.g., clothing condition variations). Nonetheless, not all images include clothing condition variations. Therefore, if an image includes clothing condition variation, this image is processed by auto-encoder 1 (302B). Otherwise, this input image is passed to the next auto-encoder or layer until this image finds the appropriate auto-encoder of the auto-encoders or layers for processing.

The auto-encoder 1 (302B) may transform an input image into a normal image 1 (300B1) if the input image is fit for processing by auto-encoder 1 (302B), and the normal image 1 (300B1) is then passed to auto-encoder 2 (304B) which performs a different variation processing (e.g., carrying condition variations) on the input that the variation processing performed by auto-encoder 1 (302B). Otherwise, the input image passes through auto-encoder 1 (302B) and is received at auto-encoder 2 (304B).

Similarly, the auto-encoder 2 (304B) may transform an input image (normal image 1 300B1 or the input image that passes auto-encoder 1 302B) into a normal image 2 (300B2) if the input image is fit for processing by auto-encoder 2 (304B), and the normal image 2 (300B2) is then passed to auto-encoder 3 (306B). Otherwise, the input image passes through auto-encoder 2 (304B) and is received at auto-encoder 3 (306B) that performs a perspective view processing that transforms a view having a perspective (e.g., azimuth angle between zero degree and 10 degrees as well as between 170 degrees and 180 degrees) to a view at perspective view (e.g., a perspective view at 10-degree azimuth angle or at 170-degree azimuth angle).

Further, the auto-encoder 3 (306B) may transform an input image (normal image 2 300B2 or the input image that passes auto-encoder 2 304B) into a normal image 3 (300B3) if the input image is fit for processing by auto-encoder 3 (306B), and the normal image 3 (300B3) is then passed to auto-encoder 4 (308B). Otherwise, the input image passes through auto-encoder 3 (306B) and is received at auto-encoder 4 (308B). That is, auto-encoder 3 (306B) transforms views having a perspective view angle between 0-degree and 10-degree to the perspective view at 10-degree as well as views having a perspective view angle between 170-degree and 180-degree to the perspective view at 170-degree in some embodiments. It shall be noted that the architecture illustrated in FIG. 3B is devised to transform views at 10 degrees perspective angle intervals although other perspective angle intervals may also be used. It shall also be noted that various examples described here use azimuth angles purely for the ease of illustration and explanation, and that elevation angles and combinations of azimuth angles and elevation angles can be equally processed by using a deeper network architecture with respective layers transforming corresponding range of angles.

Similarly, the auto-encoder 4 (308B) may transform an input image (output image 300B3 or the image that passes through auto-encoder 3 306B) into an output image 4 (300B4) if the input image is fit for processing by auto-encoder 4 (308B), and the output image 4 (300B4) is then passed to auto-encoder 5 (310B). Otherwise, the input image to auto-encoder 4 (308B) passes through auto-encoder 4 (308B) and is received at auto-encoder 5 (310B). That is, auto-encoder 4 (308B) transforms views having a perspective view angle between 10-degree and 20-degree to the perspective view at 20-degree as well as views having a perspective view angle between 160-degree and 170-degree to the perspective view at 160-degree in some embodiments.

Further, the auto-encoder 5 (310B) may transform an input image (output images 300B4 or the image that passes through auto-encoder 4 308B) into an output image 5 (300B5) if the input image is fit for processing by auto-encoder 5 (310B), and the output image 5 (300B5) is then passed to auto-encoder 6 (312B). Otherwise, the input image passes through auto-encoder 5 (310B) and is received at auto-encoder 6 (312B). That is, auto-encoder 5 (310B) transforms views having a perspective view angle between 20-degree and 30-degree to the perspective view at 30-degree as well as views having a perspective view angle between 150-degree and 160-degree to the perspective view at 150-degree in some embodiments. As it can be seen, these auto-encoders gradually transform views within a small range of perspective variations to views at a fixed perspective which are then processed by the next auto-encoder(s) to eventually reach 90-degree views (side view).

Moreover, the auto-encoder 6 (312B) may transform an input image (output images 300B5 or the image that passes through auto-encoder 5 310B) into an output image 6 (300B6) if the input image is fit for processing by auto-encoder 6 (312B), and the output image 6 (300B6) is then passed to auto-encoder 7 (314B). Otherwise, the input image passes through auto-encoder 6 (312B) and is received at auto-encoder 7 (314B). That is, auto-encoder 6 (312B) transforms views having a perspective view angle between 30-degree and 40-degree to the perspective view at 40-degree as well as views having a perspective view angle between 140-degree and 150-degree to the perspective view at 140-degree in some embodiments.

Further, the auto-encoder 7 (314B) may transform an input image (output images 300B6 or the image that passes through auto-encoder 6 312B) into an output image 7 (300B7) if the input image is fit for processing by auto-encoder 7 (314B), and the output image 7 (300B7) is then passed to auto-encoder 8 (316B). Otherwise, the input image passes through auto-encoder 7 (314B) and is received at auto-encoder 8 (316B). That is, auto-encoder 7 (314B) transforms views having a perspective view angle between 40-degree and 50-degree to the perspective view at 50-degree as well as views having a perspective view angle between 130-degree and 140-degree to the perspective view at 130-degree in some embodiments.

In addition, the auto-encoder 8 (316B) may transform an input image (output images 300B7 or the image that passes through auto-encoder 7 314B) into an output image 8 (300B8) if the input image is fit for processing by auto-encoder 8 (316B), and the output image 8 (300B8) is then passed to auto-encoder 9 (318B). Otherwise, the input image passes through auto-encoder 8 (316B) and is received at auto-encoder 9 (318B). That is, auto-encoder 8 (316B) transforms views having a perspective view angle between 50-degree and 60-degree to the perspective view at 60-degree as well as views having a perspective view angle between 120-degree and 130-degree to the perspective view at 120-degree in some embodiments.

Moreover, the auto-encoder 9 (318B) may transform an input image (output images 300B8 or the image that passes through auto-encoder 8 316B) into an output image 9 (300B9) if the input image is fit for processing by auto-encoder 9 (318B), and the output image 9 (300B9) is then passed to auto-encoder 10 (320B). Otherwise, the input image passes through auto-encoder 9 (318B) and is received at auto-encoder 10 (320B). That is, auto-encoder 9 (318B) transforms views having a perspective view angle between 60-degree and 70-degree to the perspective view at 70-degree as well as views having a perspective view angle between 110-degree and 120-degree to the perspective view at 110-degree in some embodiments.

Further, the auto-encoder 10 (320B) may transform an input image (output images 300B9 or the image that passes through auto-encoder 9 318B) into an output image 10 (300B10) if the input image is fit for processing by auto-encoder 10 (320B), and the output image 10 (300B10) is then passed to auto-encoder 11 (322B). Otherwise, the input image passes through auto-encoder 10 (320B) and is received at auto-encoder 11 (322B). That is, auto-encoder 10 (320B) transforms views having a perspective view angle between 70-degree and 80-degree to the perspective view at 80-degree as well as views having a perspective view angle between 100-degree and 110-degree to the perspective view at 100-degree in some embodiments.

Finally, the auto-encoder 11 (322B) may transform an input image (output images 300B10 or the image that passes through auto-encoder 10 320B) into an output image 11 (300B111) if the input image is fit for processing by auto-encoder 11 (322B). That is, auto-encoder 11 (322B) transforms views having a perspective view angle between 80-degree and 90-degree to the perspective view at 90-degree (side views) as well as views having a perspective view angle between 90-degree and 100-degree to the perspective view at 90-degree (side views) in some embodiments. The outputs of the last few layers (e.g., 300B9, 300B10, and/or 300B11) may be appropriate for extraction (e.g., extraction of gait features) because these transformed images are sufficiently close to the side views for gait feature extraction and gait analyses. That is, some embodiments may or may not proceed to transform images to side views in order to conserve compute resources. Further, the example network illustrated in FIG. 3B uses ten-degree intervals for view transformation in these illustrated embodiments although other wider or narrower angle intervals may also be used in other embodiments.

FIG. 3C illustrates more details about a portion of the simplified high-level block diagram of a method or system for image processing and computer vision, using invariant features and deep learning techniques illustrated in FIG. 3A, according to some embodiments. Compared to FIG. 3B, the simplified high-level block diagram of the network architecture in FIG. 3C includes the same auth-encoders 302B, 304B, 306B, 308B, 310B, 312B, 314B, and 316B.

The only difference is that the auto-encoder following auto-encoder 9 316B is auto-encoder 9 (302C) that is responsible for transforming views having a perspective view angle between 60-degree and 90-degree to the perspective view at 90-degree (side views) as well as views having a perspective view angle between 90-degree and 120-degree to the perspective view at 90-degree (side views) in these embodiments illustrated in FIG. 3C. That is, the auto-encoders in the example network architecture 304A do not have to be responsible for the same angular interval of views. In this example, auto-encoder 9 (302C) is responsible for transforming views spanning across 30-degrees of perspective angles while the other auto-encoders are responsible for transforming views spanning across 10-degrees of perspective angles.

FIG. 3D illustrates another simplified high-level block diagram for image processing and computer vision, using invariant features and deep learning techniques, according to some embodiments. More specifically, FIG. 3D illustrates that an auto-encoder receiving and processing input 302A may include an encoder network 312D and a decoder network 314D. The encoder 312D transforms the input 302D into, for example, the output 306D of feature vectors. In this example, the encoder Y=Encoder (X)=S(Weight×X)+b may be used where X denotes the input 302D, Weight denotes the weight matrix, and b denotes the bias. In some of these embodiments, S(X)=1/(1+e\hat{ }−X) or S(X)=ln(1+e\hat{ }−X) may be used.

The encoder network 312D may include an input layer X 302D, a hidden layer 304D, and an output layer 306D that also plays the role of an input layer for the decoder network 314D. The decoder network further includes its own hidden layer 308D and its own output layer 310D. The decoder 314D transforms the input (306D) back into, for example, the output 310D having the same format as the input (e.g., images). In this example, the decoder X′=Decoder (Y)=S(Weight^{T}×Y)+b^{T} may be used where Y denotes the input 306D to the decoder 314D, Weight^{T} denotes the transpose of the weight matrix, and b^{T} denotes the transpose of the bias vector b. In some of these embodiments, S(Y)=1/(1+e\hat{ }−Y) or S(Y)=ln(1+e\hat{ }−Y) may be used.

FIG. 3E illustrates another simplified high-level block diagram for image processing and computer vision, using invariant features and deep learning techniques, according to some embodiments. In these embodiments illustrated in FIG. 3E, the gait image generation network receiving input gait data 302A may also include an encoder network 316E and a decoder network 318E. Similar to the gait image generation network illustrated in FIG. 3E, the gait image generation network illustrated in FIG. 3D also includes an encoder network 316E and a decoder network 318E; the encoder network 316E includes an input layer 302E receiving the input X and an output layer 308E which not only generates the output (e.g., feature vectors) but also serves as the input layer for the decoder network 318E; and the decoder network 318E also includes an output layer 314E.

Unlike the auto-encoder having a single hidden layer (304D for the encoder 312D and 308D for the decoder 314D) for the gait image generation network in FIG. 3D, the auto-encoder for the gait image generation network in FIG. 3E includes a plurality of hidden layers. For example, the encoder network 316E includes hidden layer 1 (304E) (Y1=Encoder(X)=S(Weight·X)+b), hidden layer 2 (306E) (Y2=Encoder(Y1)=S(Weight·Y1)+b), etc. Similarly, the decoder network 318E includes a plurality of hidden layers. For example, the decoder network 318E includes hidden layer 1 (310E) (X1′=Decoder (Y1)=S(Weight_transpose×Y1+transpose of b), hidden layer 2 (312E) (X2′=Decoder (Y2)=S(Weight_transpose×Y2+transpose of b), etc. That is, the encoder 316E transforms the input 302A into, for example, an output 308E of feature vectors; and the decoder network 318E transforms the output 308E of the encoder network 316E back into the output 314E having the same format as the input gait data 302A (e.g., an image at a different perspective).

FIG. 3F illustrates more details about a portion of the simplified high-level block diagram of a method or system for image processing and computer vision, using invariant features and deep learning techniques illustrated in FIG. 3A, according to some embodiments. In these embodiments, input gait images may be received at 302A. One or more invariant features may be determined at 302F for a person from the input gait image(s) 302A. These one or more invariant features may include an invariant physiological feature such as a location, a line segment, or a curve segment, etc. with respect to the person detected in the input gait image.

A 3D model or a 2D model may be determined at 304F based at least in part upon the one or more invariant features determined at 302F. In some embodiments, one or more additional features that are not invariant features may also be used to aid the construction of the 3D or 2D model. For example, some embodiments may use six invariant locations (e.g., two invariant locations on each earlobe, two invariant locations on the bilateral tragus, and two invariant locations on the nasal ala) and nine invariant line or curve segments (e.g., two first segments from the outer corner of an eye to the termination of the corresponding eyebrow, two second segments from the inner corner of an eye to the outer corner of the same eye, two segments for the bilateral tragus, two segments or pairs from the corner of the mouth to the lowest point of the ear, and one segment or pair for the philtrum distance) on a person's face with one or more additional features (e.g., the boundary points of eye(s), boundary points of the mouth, boundary points of the chin, etc.) to construct the 3D model although one of the advantages of using an invariant physiological feature is that the invariant physiological feature generally does not move relative to the underlying bone(s), unlike other features that may exhibit relative movement to the underlying bone(s) due to, for example, facial expressions, tension or relaxation of muscles, etc.)

A plurality of existing models of known person(s) may be identified at 306F. For example, the plurality of existing models of known person(s) may be retrieved from a database. The 3D model (or 2D model) determined at 304F may be partially matched against one or more existing 3D models (or one or more 2D models) of known person(s) at 308F. In some embodiments, the 3D model (or 2D model) may be translated, rotated, and/or scaled prior to comparison of this 3D model to or with existing 3D model(s) (or 2D model(s)). In some embodiments where a model (2D or 3D) includes a plurality of features, the matching performed at 308F may be performed incrementally. That is, a first feature (e.g., point or segment) may be first compared or aligned, then a second feature may be compared, etc., without attempting to match all features of one model against the corresponding features of the other model.

A determination may be made to decide whether the 3D model matches a particular existing model at 310F, using the remainder of the 3D model and the particular existing model. The remainder of a model at 310F is defined as the smaller portion of the model that has not been utilized in partially matching the model against the corresponding portion of another model at 308F.

One of the advantages of using an invariant feature is that once two models are properly oriented and scaled, the corresponding pair of invariant features in two models are supposed to be aligned and coincident with each other. Another advantage of using an invariant feature is that computer vision and imaging process, in the absence of an absolute length scale or a reference length, only see pixels and possess no knowledge of the correct length or size. In some embodiments, simple model matching alone may be used to filter out a large number of existing models while keeping those existing models that exhibit small discrepancies (e.g., within a threshold) with the model determined at 304F.

With one or more invariant features used in a model, computer vision and imaging process can do without the knowledge of correct length or size because, for example, the invariant locations on the body of the same person are supposed to be coincident. On the other hand, if the same invariant locations on a first image, after translation, rotation, and/or scaling, do not match the corresponding invariant locations on a second image, these two models do not match, and thus the two detected persons in these two images are different persons due to the discrepancies between the two models.

A determination may thus be made at 312F to decide whether the detected person from the input gait images 302A matches a known person at least by performing a gait analysis on the gait data from the input gait images 302A based at least in part upon gait data corresponding to the existing models, using a gait recognition network. In some embodiments where the model matching at 310F is used as a pre-filter on the plurality of existing models, the gait analysis may be performed at 312F on only the remaining existing model(s).

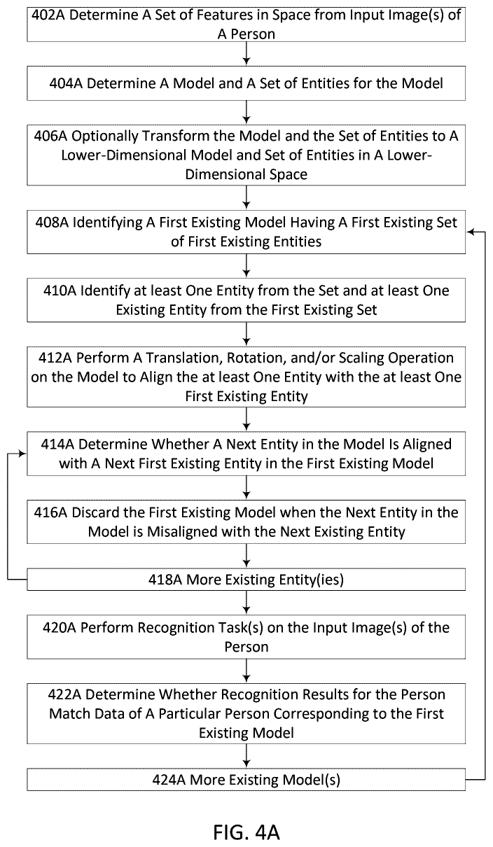

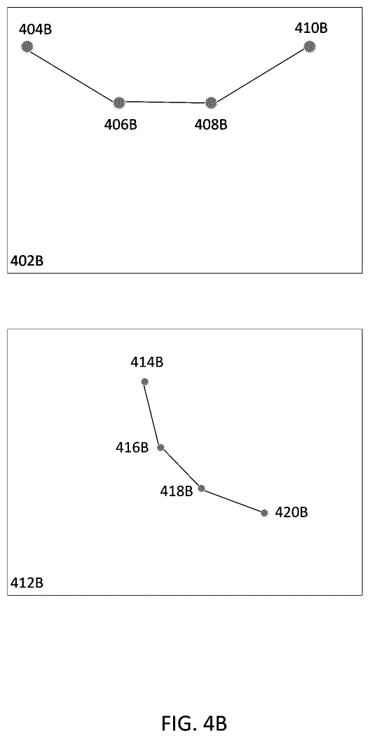

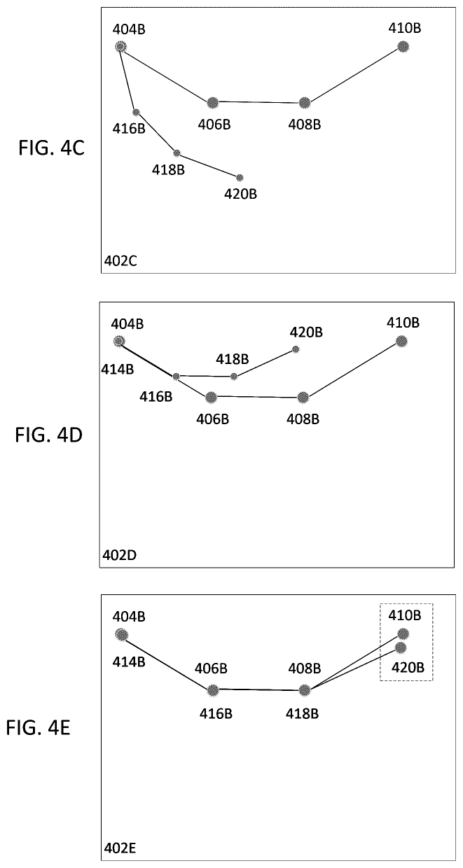

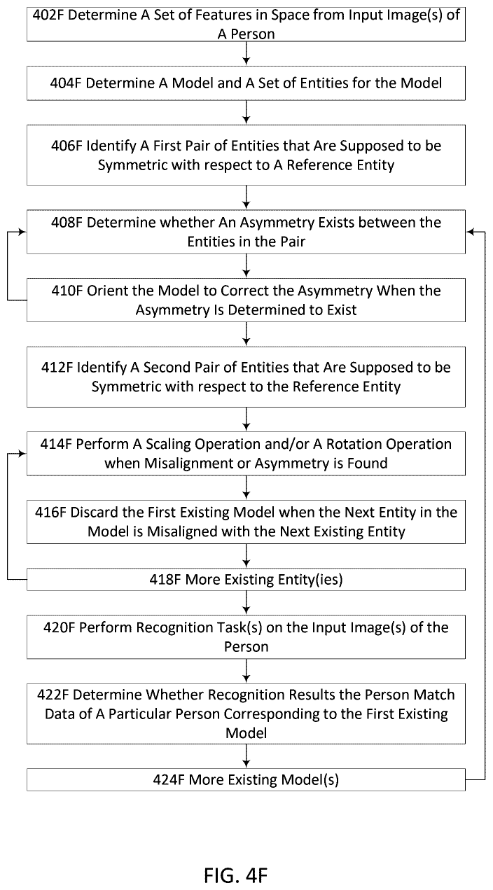

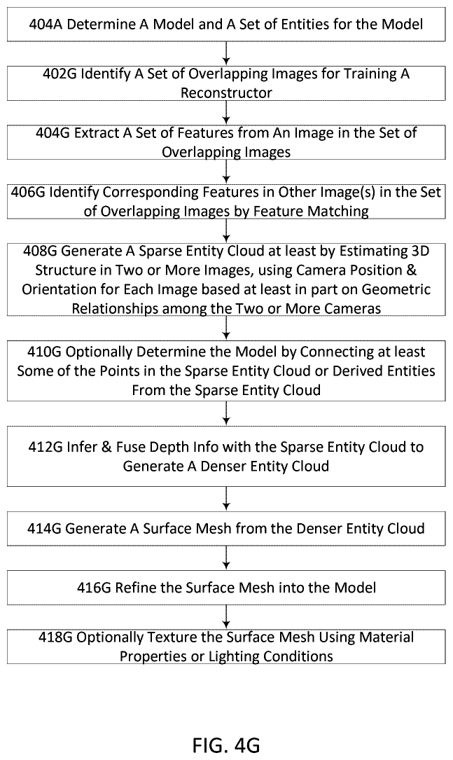

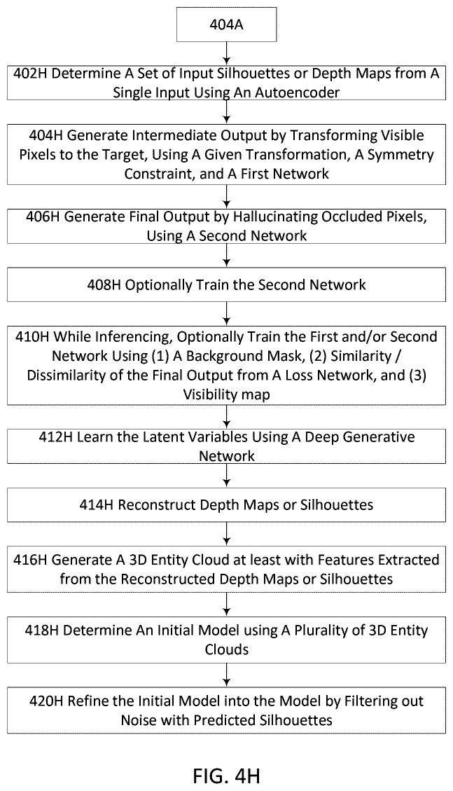

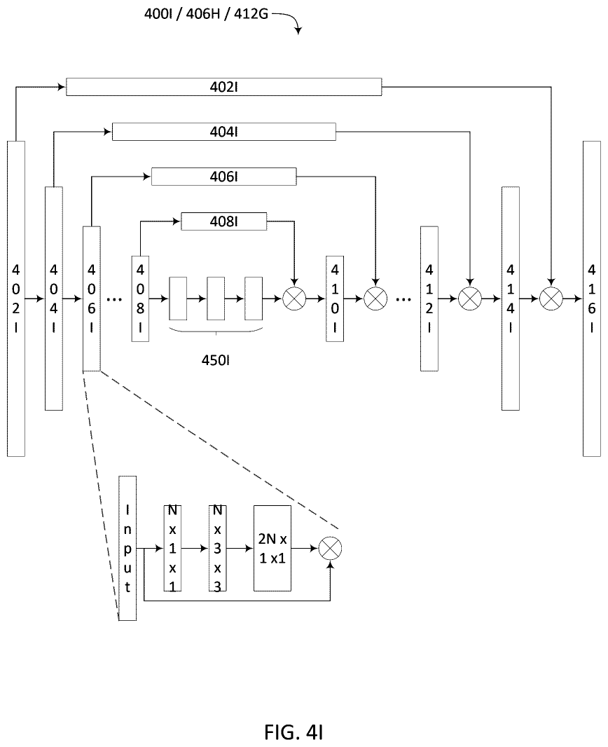

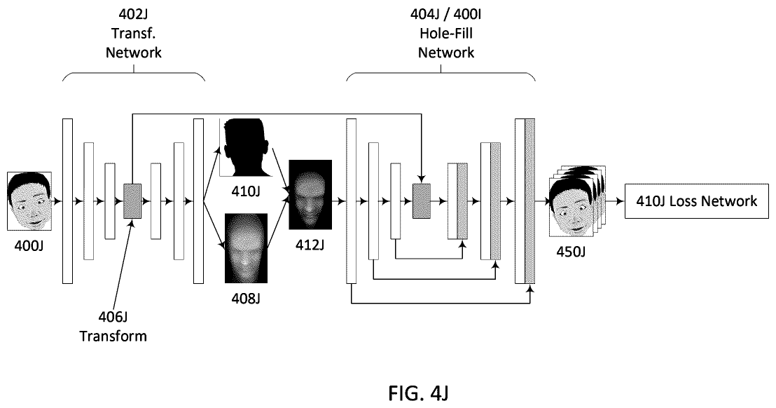

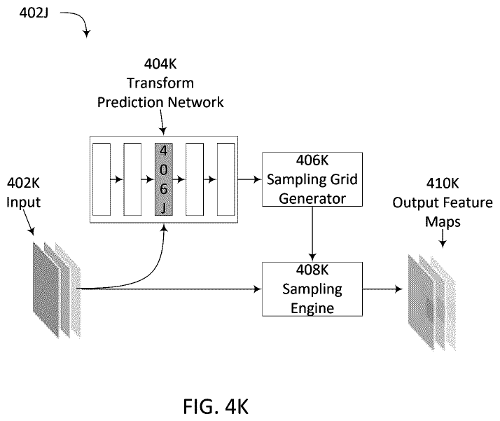

FIG. 4A illustrates a simplified block diagram of a method or system for image processing and computer vision, using invariant features and deep learning techniques, according to some embodiments. More specifically, FIG. 4A illustrates more details about rotation and scaling of a model such as the model described above with reference to FIG. 3F. In these embodiments, a set of features in space may be determined at 402A from one or more input images of a person. In some embodiments, the one or more input images may include depth data (e.g., a depth map for each input image) while in some other embodiments, the one or more input images do not include depth data.

A model and a set of entities for the model may be determined at 404A. In some embodiments, the set of entities may include one or more points, one or more line segments, or one or more curve segments, or any combinations thereof. In some embodiments, model data may also be determined at 404A where the model data may include, for example but not limited to, invariant points, invariant line segments, new line or curve segments connecting invariant points or an invariant point to an addition point on the person or to an invariant segment. In some embodiments where the one or more input images include depth data, a 3D model may be easily constructed by fixing nodes in a 3D space with their corresponding depth data.

Moreover, the model may be a 2D model or a 3D model and may be determined at 404A from the 2D input images in some embodiments whether the set of features does not include depth data. In some embodiments where a 3D model is constructed, various techniques described herein may be utilized. In addition or in the alternative, the 3D model may be constructed from 2D images by using techniques such as SIFT (Scale-Invariant Feature Transform), AKAZE (Accelerated-KAZE), or SURF (Speeded-Up Robust Features).

The model and the set of entities may be optionally transformed at 406A to a lower-dimensional model and a lower-dimensional set of entities in a lower-dimensional space. For example, a 3D model in a 3D space may be projected to a 2D model in a 2D space at 406A, or a set of 3D entities may be transformed to a set of 2D entities in a 2D space. A first existing model comprising a first existing set of first existing entities may be identified at 408A. This first existing model and/or the first existing set of first existing entities will be used in subsequent processes to respectively, incrementally compare to or with the model and/or the set of entities determined at 404A.

At least one entity may be identified at 410A from the set of entities. In addition, at least one first existing entity may be identified at 410A from the first existing set of first existing entities. At 412A, a translation, rotation, and/or scaling operation may be performed on the model (or on the first existing model) to align the at least one entity with the at least one first existing entity. In some embodiments, the at least one entity may be aligned with the at least one first existing entity prior to performing the translation, rotation, and/or scaling operation. For example, a first point in the model may be aligned with a first existing point in the first existing model, and then the model or the first existing model may be translated, rotated, and/or scaled for further alignment of the model to the first existing model (or vice versa).

A determination may be made at 414A to decide whether a next entity in the model is aligned with a next first existing entity in the first existing model. The first existing model may be discarded at 416A when the next entity of the model is misaligned with the next existing entity. For example, when a point in the model is aligned with an existing point in the first existing model, and the model is properly translated, rotated, and/or scaled, if the second point in the model is nevertheless misaligned with the corresponding existing point in the first existing model, the first existing model is deemed to be different from the model and may thus be discarded at 416A.

A determination may further be made at 418A to decide whether there are more existing entities to be compared to the model. If the determination result is affirmative at 418A, the process returns to 414A to determine whether a next entity in the model is aligned with a next, corresponding existing entity in the first existing model and repeats the processes 414A through 418A until all entities in the first existing set of existing entities have been similarly processed when the first existing model is determined to match the model or until a misaligned entity is identified when the first existing model is determined to be different from the model and is thus discarded at 416A.

When the model is determined to match an existing model, one or more recognition tasks may be performed at 420A on the input image of the person. A determination may be made to decide whether the recognition results for the person represented in the input images match data of a particular, known person that corresponds to a first existing model at 422A. A determination may be made at 424A to decide whether there are more existing model to compare to the model. If the determination result at 424A is affirmative, the process returns to 408A to identify a next existing model from the remaining existing model(s) and repeats the processes 408A through 424A until either one or more existing models that match the model are identified or no more existing models match the model. In the latter case, the person in the input images is determined not to be any of the known persons while in the former case, the person in the input images is determined to be a possible match for the one or more particular persons represented by the one or more existing models.

FIGS. 4B-4E illustrate some examples of the application of the method or system for image processing and computer vision using invariant features and deep learning techniques illustrated in FIG. 4A, according to some embodiments. More specifically, FIG. 4B illustrates a first 2D model 402B that comprises four points 404B, 406B, 408B, and 410B that are connected as shown in 402B. FIG. 4B further illustrates a second 2D model 412B that comprises four points 414B, 416B, 418B, and 420B that are connected as shown in 412B.

These examples illustrated in FIGS. 4B-4E provide a simplified example for the process illustrated in FIG. 4A and described immediately above. That is, 402B may represent an existing 2D model for a known person, and 412B may represent a 2D model for a person to be recognized. It shall be noted that FIGS. 4B-4E use 2D models for the ease of illustration and explanations, and that various techniques described herein with reference to FIGS. 4A-4E may be equally applied to 3D models.

FIG. 4C illustrates an example working space 402C where the model 402B and the model 412B are translated so that the node or point 404B of 402B coincides with the node or point 414B of 412B via a translation operation. FIG. 4D illustrates the example 402D where a rotation operation is performed on the model represented in 412B to orient and align the line segment connecting nodes 414B and 416B in 412B with the corresponding line segment connecting nodes 404B and 406B in 402B.

FIG. 4E illustrate an example 402E of performing a scaling operation to stretch the line segment connecting nodes 414B and 416B in 412B to match the length of the corresponding line segment connecting nodes 404B and 406B in 402B. It is noted that when the models 402B and 412B are constructed using invariant features described herein, these invariant features (e.g., points at which ligaments attach to bones, line segments connecting such points, etc.) remain invariant when the persons in different images are the same person, unless, of course, the underlying bone structure of the person has been altered in extremely rare circumstances. Even in these rare circumstances, some embodiments may further invoke face recognition (if the models being analyzed correspond to gait analyses and recognition) or gait analyses (if the models being analyzed correspond to face recognition) to further confirm the identity of the person being recognized.

In the example illustrated in FIG. 4E, the process performs the scaling operation and proceeds to determine whether node 406B is aligned with node 416B, and the determination result is affirmative. The process further proceeds to determine whether node 408B is aligned with node 418B, and the determination result is again affirmative. Should any of the aforementioned determination result is negative, the existing model may be discarded because different models indicate that the two persons represented by these two models are different. Nonetheless, whether the process proceeds to examine the next node, it is determined that node 410B in the model 402B is misaligned with node 420B in the model 412B. As a result, the existing model 402B is determined to be different from the model 412B and is thus discarded because the person to be recognized as represented by the model 412B is different from the known person represented by the existing model 402B.

FIG. 4F illustrates another simplified block diagram of a method or system for image processing and computer vision, using invariant features and deep learning techniques, according to some embodiments. More specifically, FIG. 4F illustrates a simplified block diagram for a method or system for model comparison for identify recognition. In these embodiments, a set of features in space may be determined at 402F from one or more images of a person. In some embodiments, the set of features determined at 402F may include depth data (e.g., a depth map for each input image) while in some other embodiments, the set of features determined at 402F does not include depth data.

A model and a set of entities may be determined at 404F. The model may be a 3D model in some embodiments or a 2D model in some other embodiments. In some embodiments, the set of features may include depth data (e.g., a depth map for each input image) while in some other embodiments, the set of features does not include depth data. In some embodiments, the set of entities may include one or more points, one or more line segments, or one or more curve segments, or any combinations thereof.

In some embodiments, model data may also be determined at 404F where the model data may include, for example but not limited to, invariant points, invariant line segments, new line or curve segments connecting invariant points or an invariant point to an addition point on the person or to an invariant segment. In some embodiments where the one or more input images include depth data, a 3D model may be easily constructed by fixing nodes in a 3D space with their corresponding depth data. In some other embodiments where depth data is unavailable, a 3D model may nevertheless be determined at 404F from 2D image(s). More details of determining a 3D model from 2D image(s) will be described below.

A first pair of entities that are supposed to be symmetric with respect to a centerline or axis may be identified at 406F. For example, some facial features may be assumed to be symmetric with respect to a reference geometric entity (e.g., an imaginary centerline for 2D symmetry or plane for 3D symmetry) across the center of a person's face. A determination may be made at 408F to decide whether asymmetry exists between the entities in the pair.

For example, a line segment connecting the first invariant feature representing the left corner of the mouth to the second invariant feature representing the lowest point of the left ear on the left side of a person's is supposed to be symmetric with respect to the centerline of the person's face to the a line segment connecting the third invariant feature representing the right corner of the mouth to the second invariant feature representing the lowest point of the right ear on the right side of a person's face. The corresponding nodes or segments may be identified from the model determined from the one or more input images of the person. A determination may then be made at 408F to decide whether asymmetry exists between these two sets of nodes or segments that are supposed to be symmetric with respect to the centerline of the person's face.

When the asymmetry is determined to exist at 408F, the model may be oriented at 410F to correct the asymmetry, and the process may return to 408F to determine whether the asymmetry still exists or is smaller than an acceptable threshold where the process may proceed to 412F to identify a second pair of entities that are again supposed to be symmetric with respect to the center line.

In some embodiments, the asymmetry determined at 408F may correspond to one or more perspective angles (e.g., only elevation so that orienting the model at 410F may address one perspective angle but may or may not address all the perspective angles at which the respective sets of images are captured for determining the corresponding models. For example, when a first 2D model is constructed from one or more first images captured at a first azimuth angle and a first elevation angle, and a second 2D model is constructed from one or more second images captured at a second azimuth angle and a second elevation angle, orienting the first 2D model may address and correct the discrepancy between the first and second azimuth angles (or elevation angles) but not the first and second elevation angles (or azimuth angles) because this process checks for symmetry or asymmetry with respect to a centerline in a 2D plane.

On the other hand, if a 3D model is constructed (either with depth data or with 2D images), orienting a 3D model to find symmetry or asymmetry with respect to a center-plane may nevertheless address and correct both the azimuth and elevation discrepancies in some embodiments. As a result, the identification of a second pair of entities that are supposed to be symmetric at 412F, yet asymmetry is actually found, this asymmetry may be a result of the discrepancy in a perspective angle that is not addressed at 410F in some embodiments. Regardless of whether misalignment and/or asymmetry is found, a scaling operation and/or a rotation operation may be performed on the model at 414F.

The first existing model may be discarded at 416F when the next entity in the model is determined to be misaligned with the next existing entity in the first existing model.

A determination may further be made at 418F to decide whether there are more existing entities to be compared to the model. If the determination result is affirmative at 418F, the process returns to 414F to determine whether a next entity in the model is aligned with a next, corresponding existing entity in the first existing model and repeats the processes 414F through 418F until all entities in the first existing set of existing entities have been similarly processed when the first existing model is determined to match the model or until a misaligned entity is identified when the first existing model is determined to be different from the model and is thus discarded at 416F.

When the model is determined to match an existing model, one or more recognition tasks may be performed at 420F on the input image of the person. A determination may be made to decide whether the recognition results for the person represented in the input images match data of a particular, known person that corresponds to a first existing model at 422F. A determination may be made at 424F to decide whether there are more existing model to compare to the model. If the determination result at 424F is affirmative, the process returns to 408F to identify a next existing model from the remaining existing model(s) and repeats the processes 408F through 424F until either one or more existing models that match the model are identified or no more existing models match the model. In the latter case, the person in the input images is determined not to be any of the known persons while in the former case, the person in the input images is determined to be a possible match for the one or more particular persons represented by the one or more existing models.

FIG. 4G illustrates more details about a portion of the simplified high-level block diagram of a method or system for image processing and computer vision, using invariant features and deep learning techniques illustrated in FIG. 4A, according to some embodiments. More specifically, FIG. 4G illustrates more details about determining a model and a set of entities at 404A in FIG. 4A. In these embodiments, a set of partially overlapping images may be identified at 402G for training a reconstructor. This set of partially overlapping 2D images is used to reconstruct a model (e.g., a 3D model). It shall be noted that the specification of partially overlapping images does not preclude the possibility of fully overlapping images. Nonetheless, two fully overlapping images are deemed identical and thus the addition of an identical image does not actually add value to recognition or analyses.

A set of features may be extracted at 404G from an image in the set of partially overlapping images. In some embodiments, the set of features may include, for example but not limited to, a set of SIFT (scale-invariant feature transform) features, a set of AKAZE/accelerated KAZE features, a set of SURF (speeded-up robust features) features, or any combination thereof. Features corresponding to the same objects of interest in one or more other images in the set of overlapping images may be identified at 406G. In some embodiments, such features may be identified using entity recognition and matching techniques. For example, a first image may include a first feature (e.g., the left eye of a person), and the overlapping second image may also include a second feature that also corresponds to the left eye of a person although may be in a different perspective. In this example, the first feature and the second feature, both corresponding to the left eye of persons, may be identified at 406G.

A sparse point cloud may be generated at 408G at least by estimating a 3D structure in two or more images using camera position and orientation for each image based at least in part upon one or more geometric relationships among the two or more cameras that are used to capture the set of partially overlapping images. In some embodiments, the geometric relationships among two or more cameras or between any two of the two or more cameras capturing the set of partially overlapping images may be encoded in a matrix. More particularly, ray vectors may be computed from each camera center through each pixel coordinates. Moreover, the intersection points of these two rays in the 3D space may be deemed as the 3D coordinates of the pixel. Further, bundle adjustment may be optionally performed to adjust the parameters of the two cameras, minimizing reprojection errors. Then, a sparse point cloud may be determined and may be used to provide a framework for more detailed reconstruction of the model.

The model may be optionally determined at 410G at least by connecting some of the entities (e.g., points) in the sparse entity cloud or derived entities that are derived from the sparse entity cloud. In some embodiments, the model made by connecting some entities (e.g., invariant features) in the sparse entity cloud may be sufficient for recognition of a person (e.g., via model matching as described above with reference to FIGS. 4A-4F) in some embodiments or may be sufficient at least for discarding mismatching existing models described above so that the more compute-intensive face recognition or gait analysis tasks may be avoided at least for the mismatching existing models.

Depth data or information may be inferred at 412G and fused with the sparse entity cloud to generate a dense entity cloud. In some embodiments, a surface mesh may be generated at 414G from the denser entity cloud. In some embodiments, the surface mesh may be generated using Delaunay triangulation techniques, Poisson surface reconstruction techniques, or other similar techniques. The surface mesh may be refined at 416G into the model. In some of these embodiments, a surface mesh refers to a set of node data structures that store a set of three or more nodes (e.g., three nodes for a triangular mesh element, four nodes for a quad mesh element, etc.) and a relationship that this set of three or more nodes form a mesh element.

In some embodiments, the node data structure may store only the nodal data but not the relationships correlating sets of nodes to corresponding mesh elements because the purpose of the surface mesh is to generate nodes for the model, not to smoothly represent the entity for which the surface mesh is generated. In some other embodiments where smooth or more accurate representation of the model is desired or required, the surface mesh may be optionally textured at 418G, using material properties and/or lighting condition(s).

FIG. 4H illustrates more details about a portion of the simplified high-level block diagram of a method or system for image processing and computer vision, using invariant features and deep learning techniques illustrated in FIG. 4A, according to some embodiments. More specifically, FIG. 4H illustrates more details about determining a model and a set of entities at 404A of FIG. 4A. In these embodiments, A set of inputs may be determined or generated at 402H by using an auto-encoder from a single input such as a single image showing a person. In some embodiments, the set of inputs may include a set of silhouettes and/or a set of depth maps that includes depth information of pixels in the set of silhouettes or images.

The auto-encoder may receive an input from the set of inputs and generates an intermediate output (e.g., an intermediate output image) at 404H for the input at least by transforming visible pixels to the intermediate output, using a predetermined transformation and a first network in the auto-encoder. In some embodiments, the intermediate output may be generated by further using a symmetry constraint. In some embodiments, the first network maps pixels that are visible in both an input to the auto-encoder and the intermediate output generated by using the predetermined transformation, and pixels that are occluded are not processed by the predetermined transformation. The reason that the output at this stage is called “intermediate” is that the predetermined transformation only transforms pixels that are visible in both the input and the target, intermediate output while the invisible pixels will be generated subsequently by using other techniques. In some of these embodiments, the first network may include an appearance flow network or a disocclusion-aware appearance flow network.

In some embodiments, the symmetry constraint includes reflectional symmetry which may also be referred to as line symmetry, mirror symmetry, or mirror-image symmetry and is symmetry with respect to a reflection with respect to a line or axis in a 2D space and a plane in a 3D space. In some embodiments, generating the intermediate output includes first obtaining the coordinates for a pixel in an input and applying the predetermined transformation to the coordinates. The reflectional symmetry constraint may be used to generate a reflectional symmetry-aware visibility indices or other data structure(s) for pixels in an image even if some pixels are invisible in the input or in the intermediate output. That is, the reflectional symmetry constraint may be used to fill “holes” or “gaps” by simply flipping, for example, a coordinate of a point and/or a surface normal vector (e.g., by flipping the a point or a surface normal with respect to the z-axis when the xy-plane is the reflectional symmetry plane) in subsequent processing that generate multiple views at different perspectives from a single input image.

In some embodiments, in addition to or in the alternative of the predetermined transformation to the coordinates, a perspective projection may also be applied. More specifically, there are multiple coordinate frames involved between a 2D planar image and a 3D real-world coordinate frame. For example, there are the pixel coordinate frame in a 2D space defined by an image, and there is a camera coordinate frame where the camera may be approximated with a pinhole viewing system. Showing a point in the 3D real-world coordinate frame in a 2D image uses a perspective transformation to map 3D point coordinates to a point on the image plane from the pose of the camera. The point on the image plane is correlated to and defined by the camera coordinate frame, and the image plane is then transformed to the pixel coordinate frame for the input image.

The final output may be generated at 406H at least by generating or hallucinating occluded pixels (e.g., pixels that are invisible in the input or in the output) using a second network. This second network is responsible for filling “holes” or “gaps” in a model. The second network may be optionally trained at 408H by using at least the input from the set of input determined at 402H, the entire set of input, the intermediate output generated at 404H, and the final output generated at 406H. For example, the second network may be optionally trained at 408H with adversarial training that uses, for example, VGG16 for calculating features and reconstruction losses or perceptual loss. In some embodiments, regularization may be utilized for training the second network by correcting muti-collinearity and overfitting of the second network.

In some embodiments, the first and/or the second network may be optionally trained at 410H while inferencing at least by using a background mask, similarity or dissimilarity of the final output from a loss network, and/or a visibility map. In some embodiments, latent variables (e.g., variables that are inferred directly through the first and/or the second network) may be learned at 412H by using a deep generative network such as a generative adversarial network that generates new synthetic data with the same statistics as the training dataset by perturbing the training dataset with imperceivable, small changes that successfully “fool” a discriminator sub-network.

A set of silhouettes or a set of depth maps may be reconstructed from the input at 414H. In some of these embodiments, reconstruction loss may also be generated as a byproduct that may be used to fine-tune or train the decoder network of the auto-encoder. A 3D entity cloud may then be generated at 416H for the input set of silhouettes or the input set of depth maps with at least the extracted features from the reconstructed set of silhouettes and/or the reconstructed set of depth maps.

In some embodiments, the set of inputs may include a plurality of silhouettes and/or a plurality of depth maps some of which may be partially overlapping while each silhouette or each depth map is processed separately to generate a 3D entity cloud from which an initial model is determined at 418H (e.g., by using some invariant features represented in the 3D entity cloud(s)), the process illustrated in FIG. 4H generates a plurality of 3D entity clouds that may be jointly use to determine the initial model due to the partial overlap among some of the set of silhouettes or the set of depth maps. The initial model may be refined at 420H into the model for 404A at least by filtering out noise with the predicted or reconstructed silhouettes and/or depth maps.

FIG. 4I illustrates more details about a portion of the simplified high-level block diagram of a method or system for image processing and computer vision, using invariant features and deep learning techniques illustrated in FIG. 4H, according to some embodiments. More specifically, FIG. 4I illustrates a simplified schematic representation of the second network that is used to generate the final output at 406H (e.g., by filling “holes” or “gaps”) in FIG. 4H or to infer depth data or information at 412G of FIG. 4G for synthesizing 3D shapes via modeling multi-view depth maps and silhouettes. In these embodiments, the network 400I may include a set of convolutional layers (e.g., 402I, 404I, 406I, 408I, etc.) that generate convolutional outputs that are in turn sent to a fully convolutional network 450I (three FCNs shown in FIG. 4I). Each of the output feature maps by a convolutional layer (e.g., 402I, 404I, 406I, 408I, etc.) is further bypassed and added to the output of either the fully convolutional network 450I or the deconvolutional layers (e.g., 410I, 412I, 415I, 416I).

For example, the output of the convolution layer 402I and the output of the deconvolution layer 414I are summed before providing the summed result to the deconvolution layer 416I as an input. The output of the convolution layer 404I and the output of the deconvolution layer 412I are summed before providing the summed result to the deconvolution layer 414I as an input. The output of the convolution layer 406I and the output of the deconvolution layer 410I are summed before providing the summed result to the deconvolution layer 412I as an input. The output of the convolution layer 402I and the output of the fully convolutional network 450I are summed before providing the summed result to the deconvolution layer 410I as an input.

Each convolutional layer may have the same architecture that includes, for example, N×1×1 convolutional layer (e.g., a 1×1 kernel with N channels) receiving the input and followed by a N×3×3 convolutional layer (e.g., a 3×3 kernel with N channels) that is in turn followed by a 2N×1×1 convolutional layer (e.g., a 1×1 kernel with 2N channels) whose output is provided to a adder that also receives the input. This network 400I may be used as the second network that generates the final output at 406H (e.g., by filling “holes” or “gaps”) in FIG. 4H or infers depth data or information at 412G of FIG. 4G for synthesizing 3D shapes via modeling multi-view depth maps and silhouettes.

FIG. 4J illustrates a simplified high-level block diagram of a method or system for generating multi-view from an input image for image processing and computer vision, using invariant features and deep learning techniques, according to some embodiments. More specifically, FIG. 4J illustrates a simplified schematic block diagram of a network or auto-encoder that may be used for determining a set of input silhouettes or depth maps at 402H illustrated in FIG. 4H. In these embodiments, the network for 402H includes a transform prediction network 402J, which predicts a predetermined transform 406J and a hole-filling network 404J which generates a plurality of views 450J at different perspectives from a single input 400J.

The transform prediction network 402J includes a predetermined transformation 406J (e.g., the predetermined transformation described above with reference to 404H) that is to be fine-tuned, a convolutional portion preceding the predetermined transformation 406J, and a deconvolutional portion following the predetermined transformation 406J.

The transform prediction network 402J generates one or more silhouettes or images 410J from the single input 400J as well as one or more depth maps 408J and fuses the one or more silhouettes or images 410J with the one or more depth maps 408J into an intermediate output 412J that is provided to the hole-filling network 404J that makes up the invisible pixels intermediate output 412J to generate the final output of multi-view images, silhouettes, and/or depth maps 450J from the single input 400J.

The transform prediction network 402J transforms pixels that are visible in both the input 400J and the intermediate output (e.g., 408J, 410J, and/or 412J) and leave invisible pixels (e.g., pixels that are occluded) to the hole-filling network 404J which hallucinates these invisible pixels. The transform prediction network 402J may be trained to calibrate and fine-tune the predetermined transform 406J by computing and backpropagating the loss in the intermediate output (408J, 410J, or 412J). The hole-filling network 404J may also be trained by computing and backpropagating the construction loss to calibrate the model or layer parameters of the convolutional and deconvolutional layers.

FIG. 4K illustrates more details about a portion of the simplified high-level block diagram of a method or system for image processing and computer vision, using invariant features and deep learning techniques illustrated in FIG. 4J, according to some embodiments. More specifically, FIG. 4K illustrates more details about the transform prediction network 402J in FIG. 4J. In some embodiments, a set of inputs 402K may be provided to the transform prediction network 404K that may include, for example, one or more convolutional layers, one or more deconvolutional layers, and a predetermined transform 406J that is to be learned. The set of inputs 402K is provided to the transform prediction network 404K that generates a set of feature maps. The set of feature maps generated by the transform prediction network 404K is provided to a sampling grid generator 406K where the sampling grid includes a set of points where the input map should be sampled to produce the transformed output.

To perform a transformation on the input (e.g., an input feature map), each output pixel may be computed by applying a sampling kernel centered at a particular location in the input feature map. It shall be noted that a pixel refers to an element of a generic feature map, not necessarily a pixel in an image. In some embodiments, the output pixels may be defined to lie on a regular grid of pixels, forming an output feature map that lies in the space defined by the height and the width of the grid as well as the number of channels, which may be held to the same number in both the input 402K and output 410K.

The sampling grid generated by the sampling grid generator 406K and the input 402K may be provided to the sampling engine 408K which applies its sampling kernel at the grid locations, defined by the sampling grid, in the input feature map to produce the transformed output by the transform 406J. The sampling engine 408K thus generates the output feature maps 410K for the input 402K by using the sampling grid generated by the sampling grid generator 406K. More precisely, the sampling engine 408K receives the sampling point locations from the sampling grid generated by the sampling grid generator 406K as well as the input 402K and produce the sampled output feature maps 410K.

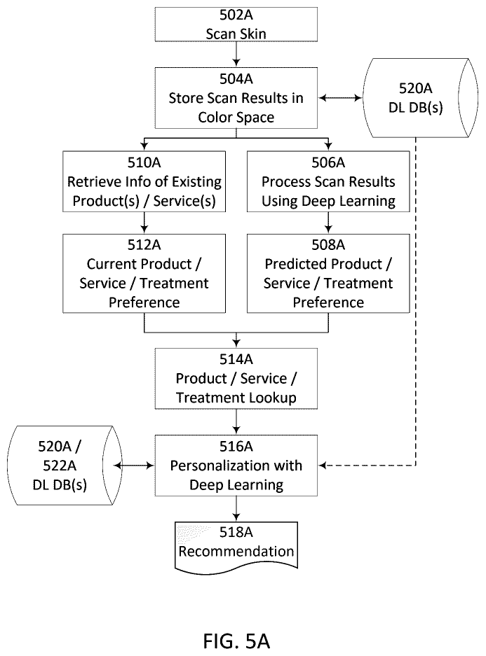

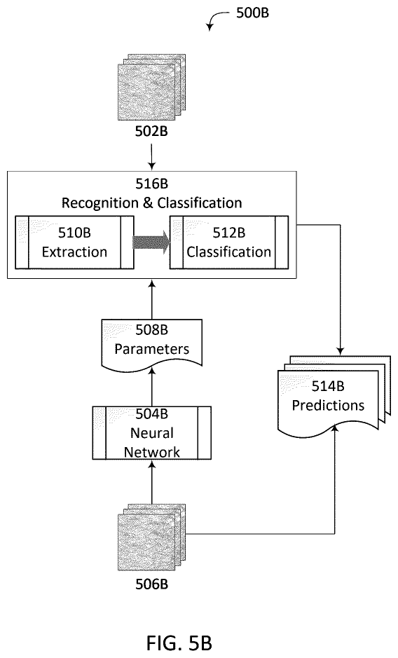

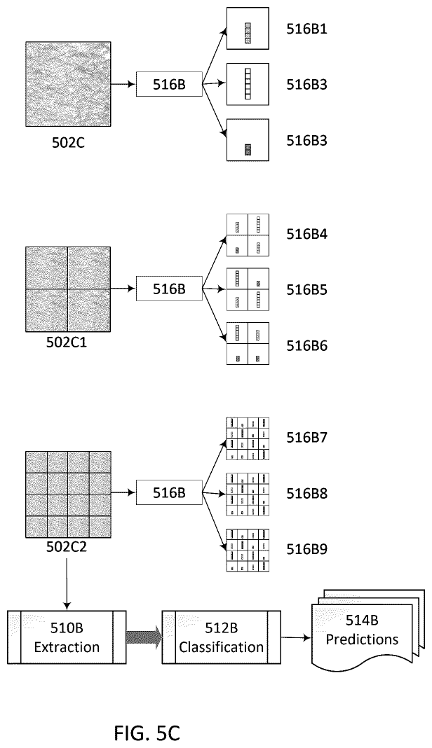

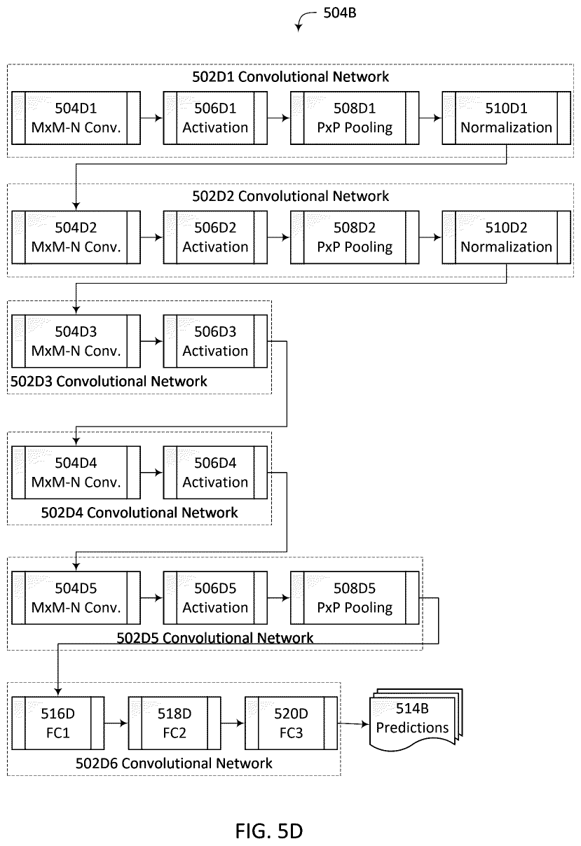

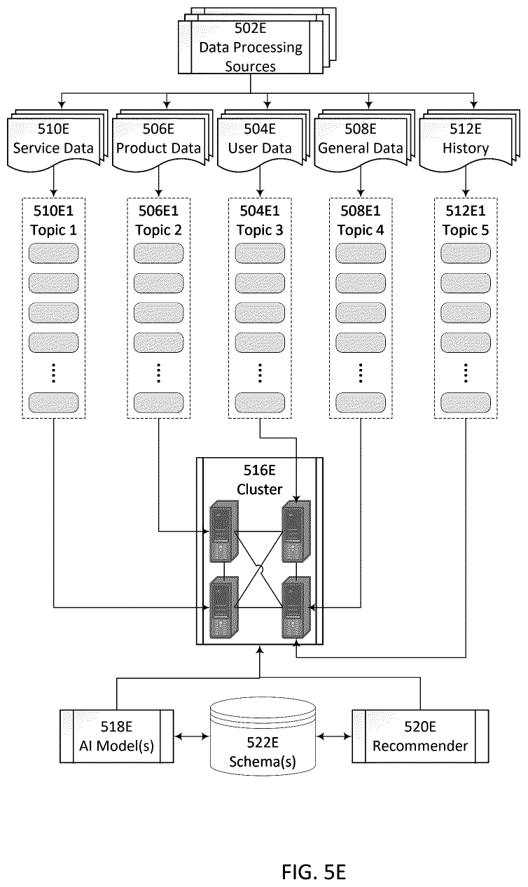

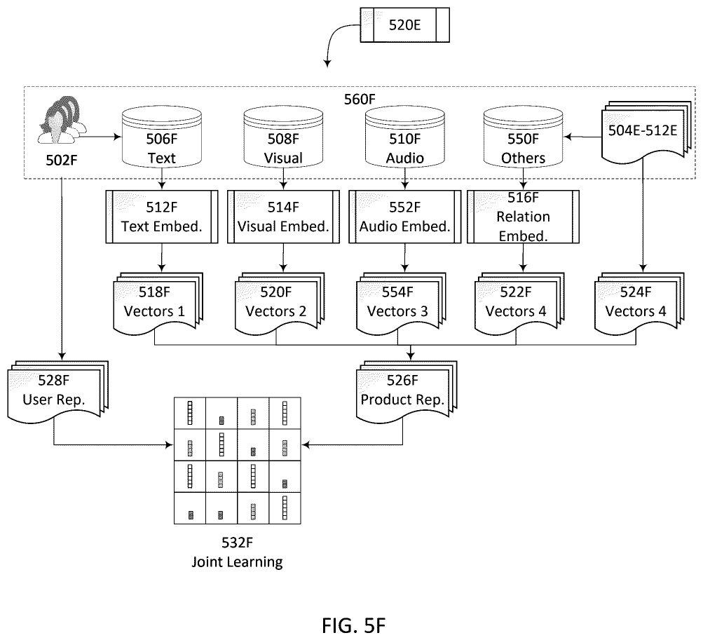

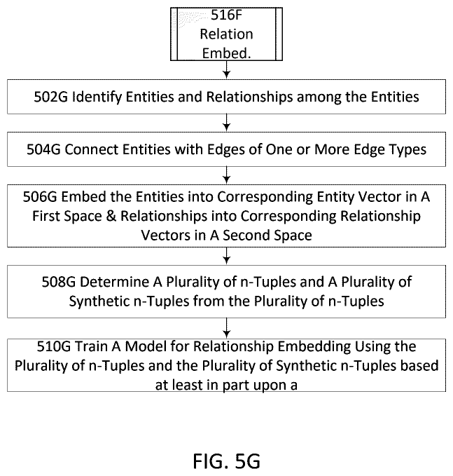

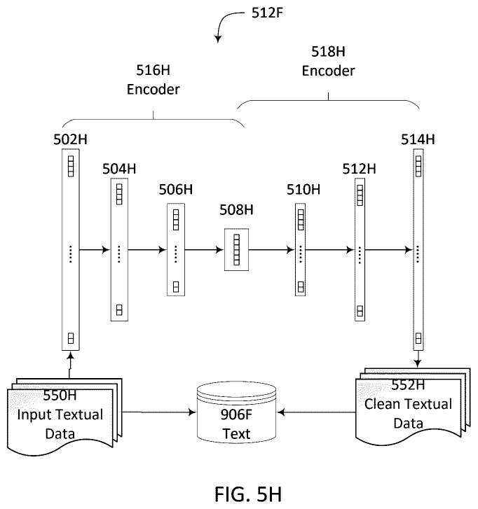

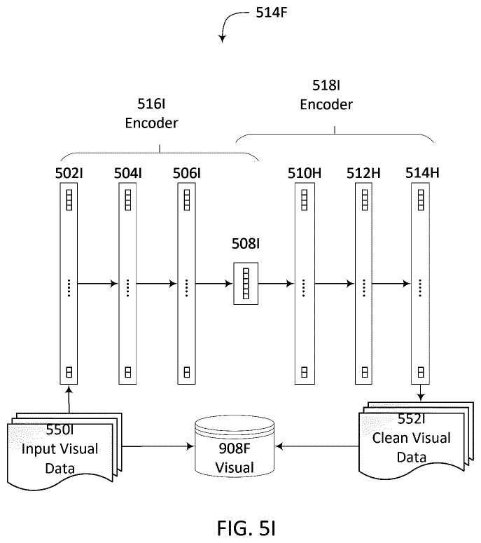

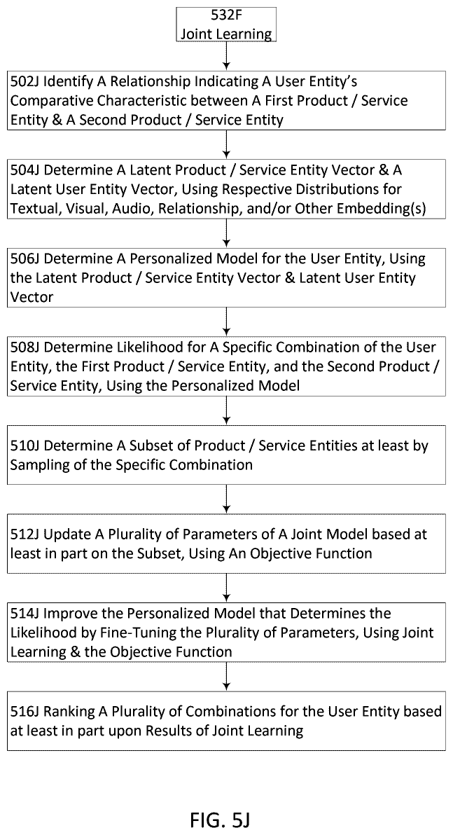

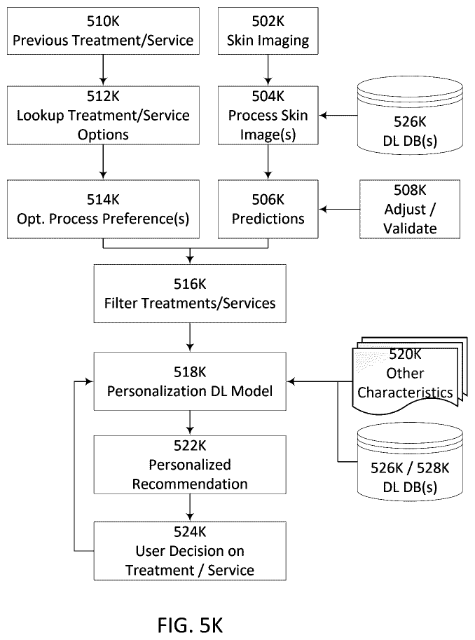

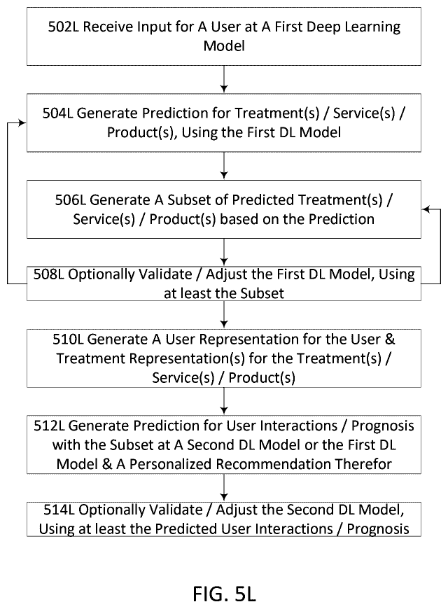

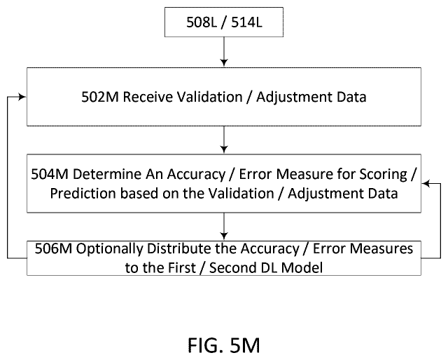

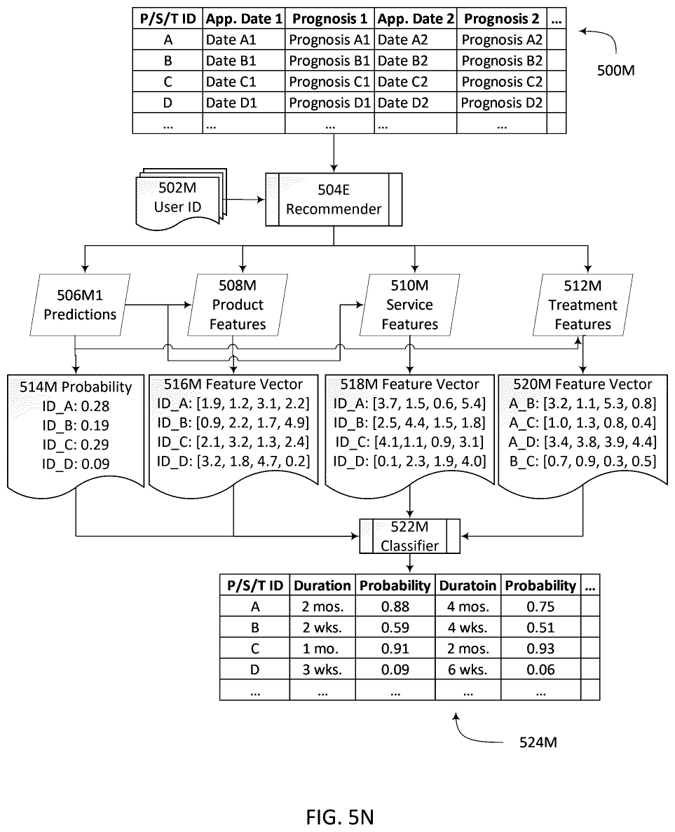

FIG. 5A illustrates a simplified high-level block diagram of a method or system for generating recommendations for a skin condition using invariant features and deep learning techniques for image processing and computer vision, according to some embodiments. More specifically, FIG. 5A illustrates a lookup service for determining and recommending one or more matching cosmetic or skincare products, cosmetic or skincare services, and/or treatment options for skin issues. These functionalities illustrated in FIG. 5A may be performed by a user or an expert using a computing device such as a smartphone, a tablet computing device, a laptop, a desktop, a scanner with compute resources and network connectivity, etc.

In some embodiments, the simplified method or system begins by scanning the skin of a person (502A) and storing the scan results in a particular color space (504A) (e.g., the LAB color space, the Pantone color space, sRGB color space, the Adobe RGB color space, CIE or the Commission internationale de l'Melairage 1931 XYZ color space (CIEXYZ color space), CIERGB color space, CIELUV color space, CIEUVW color space (CIE 1964 color space), CIE 1976 L*, A*, B* color space (or simply CIELAB or LAB color space where the lightness value (L*) ranging from 0 (black) to 100 (white), the green-red values (a*) with unbounded values where negative values toward green and positive values toward red, and blue-yellow values (b*) with unbounded values where negative values toward blue and positive values toward yellow), the RGBA color space, ICtCp color space, etc. The scan results may be stored in one or more deep learning databases 520A for training, validation, testing, or inferencing purposes.

Some embodiments described herein characterize and address the nuances of skin undertones or shades using depth, hue, and saturation not only to address the deficiencies of the current, industry-leading foundation color system but also to address olive undertones that are not addressed by most, if not all foundation and concealer brands of cosmetic products. Olive undertone represents medium tones in, for example, middle eastern and Hispanic persons and has been observed across all depths (e.g., warm, neutral, cool), not just medium tones. Further, present color system and techniques characterize saturation yet often ignore undertone in most, if not all, cosmetic product brands.

Scanning a user's skin at 502A may be performed by using a scanning device or an equivalent thereof in some embodiments or by using a mobile computing device having or coupled to an image capturing device such as a mobile phone, a tablet, a laptop, a desktop, and others, in some other embodiments. Various techniques described herein may include a plurality of image capturing device profiles so that when a particular scanning device is used for scanning a user's skin, the corresponding image capturing device may be referenced for various calibration to render the scan results to more accurately represent the color of the user's skin tone.

An image capturing device profile may include a plurality of settings for a specific image capturing device. The settings may include, for example, one or more factors of the image capturing device (e.g., vignettes including hue, saturation, tint, and others), lighting condition (e.g., bright sunlight, overcast, fluorescent, incandescent, tungsten, and others), lens optical characteristics, image sensor geometric characteristics, or any other appropriate factors that may affect the accuracy of representing the subject (e.g., a user's skin) in images (e.g., digital photographs). In some embodiments, an image capturing device may be configured to capture raw image information in a raw image format that contains minimally processed data instead of other more heavily processed image data format such as JPEG, TIFF, and others to preserve the image data.

The scan results stored at 504A may be provided together with the information of existing products, services, or treatment options (collectively products) retrieved at 510A. In addition, the preference data of a user pertaining to products, services, and/or treatment options may also be retrieved at 512A and combined with the retrieved information of existing products, services, treatment options, or any combinations thereof as well as the scan results to a lookup engine 514A that predicts one or more products, services, and/or services for the particular user whose skin was scanned at 502A.

In some embodiments, products include cosmetic products such as, without limitation, foundations, concealers, or products for lips, etc. In some of these embodiments, products may further include all skincare products such as moisturizers, products for exfoliation, products for eye puffiness, dark circles, and others, skin hydration products, and others.

The lookup engine 514A determines one or more products, services, treatment options, or any combinations thereof for a particular user (e.g., a client or a prospective client) and presents pertinent information in the form of a personalized recommendation with sufficient textual or graphical examples, or a combination, descriptions, explanations, and additional auxiliary information to convince the particular user to try or purchase at least one of the recommended products, services, treatment options, or any combinations thereof. In some embodiments, the lookup service 514A may be performed by a mobile application installed on a user's mobile computing device (e.g., a mobile phone or tablet, a wearable artificial intelligence hardware, etc.)

The scan results stored at 504A may be further processed at 506A using a deep learning network, and the processed scan results may be provided as an input to a deep learning network that predicts the affinity or preference of the particular user to products, services, and/or treatment options at 508A.

In some embodiments illustrated in FIG. 5A-5N, processing the input may include determining, extracting, or deriving one or more invariant features. These one or more invariant features (e.g., locations at which ligaments attach to corresponding bones) may be used to correctly determining the orientation of an image (e.g., a user may have tilted his or her head when the user pictures are captured, the capturing device may be posed at a perspective such as an elevation angle and/or azimuth angle different from zero-degree from the user whose pictures are being captured, etc.) The camera pose and/or the picture orientation relative to the camera may be determined and used to re-orient the picture using techniques described herein (e.g., orienting a model representing the user or a portion thereof). Thus, even in the absence of an absolute scale or length measure, at least the 2D pictures of the user may be correctly oriented, and any skin condition may thus be more accurately computed at least with respect to or relative to the user (or a portion thereof) captured in the picture.

The predicted affinity or preference generated by the deep learning network at 508A may be provided, together with the preference or affinity data of the user retrieved at 512A, to the lookup engine 514A that predicts one or more products, services, and/or services for the particular user whose skin was scanned at 502A in some embodiments.

The looked up products, services, and/or treatment options may be provided as an input to a deep learning network 516A that predicts personalized recommendations 518A for the particular user whose skin was scanned at 502A. The deep learning personalized recommendation network 516A may be also coupled with one or more deep learning databases 520A or one or more different deep learning databases 522A.

A personalized recommendation (e.g., 518A) differs from a general recommendation in that a personalized recommendation includes a form of personalization that is custom tailored to a specific user by at least accounting for one or more specific attributes, characteristics, habits, preferences, histories, and others factors that are known but are not inferred, implied, or derived to be related to the specific user. Although multiple clients may have one or more attributes or characteristics in common, a personalized recommendation differs from a general recommendation with the consideration of more personally specific attributes, characteristics, habits, preferences, and others factors.

Personalized recommendations may be implemented with artificial intelligence techniques. In some embodiments, the personalization network at 516A may be trained using one or more deep learning datasets (e.g., the datasets stored in 520A or 522A). These one or more deep learning datasets may include data such as user brand and/or product affinities or loyalty data, user's prior purchases, user's prior returns, and/or purchase trend(s) in the market, product attributes or characteristics such as prices, brands, and other attributes or characteristics, user's attributes such as age, ethnicity, preferences, and other attributes, prior product recommendation(s), any combination thereof, and/or any other suitable data.

The deep learning network providing personalized recommendations may determine a plurality of matching product and recommend a smaller subset or the entire set of the plurality of matching products, services, treatment options, or any combinations thereof for the particular user based at least in part upon the data or information specific to the particular user. A dataset may be transmitted to a model as a data stream for training the model where a data stream is the transmission of sequence of digitally encoded coherent signals to convey information.

FIG. 5B illustrates another simplified high-level block diagram 500B of a classification model that may be utilized to implement various features and functionalities for a method or system for image processing and computer vision, using invariant features and deep learning techniques, according to some embodiments. In these embodiments, scan results 502B may be provided to a recognition and classification system 516B that includes an extraction network 510B and a classification network 512B.

In addition to the scan results 502B, the recognition and classification system 516B may further receives may further receive a plurality of parameters 508B as an input. The plurality of parameters may include, for example but not limited to, hyperparameter(s), network parameter(s), or any other suitable global parameters. The plurality of parameters may be predicted by a neural network 504B which receives one or more datasets 506B and performs convolutional operations to predict a better set of parameters 508B. A network parameter denotes a parameter that is actually accounted for during the operation of the neural network 504B. In some embodiments, these one or more network parameters include, for example but not limited to, one or more weights in one or more kernels (also referred to as a weight matrix or a filter hereinafter), one or more biases in the neural network 504B, initial values of weights in one or more kernels, one or more activation functions for the neural network 504B, or any combinations thereof, and others.

Learning one or more parameters of the neural network 504B may include iteratively computing an error in the prediction 514B (e.g., recognized object(s) in an input image, predicted class such as the predicted skin tone of an input image, a matching product, and others) produced by the neural network 504B and backpropagating the computed error through each layer in the neural network 504B using, for example, a gradient descent algorithm (e.g., a stochastic gradient descent algorithm or other similar or equivalent algorithm). With the backpropagated error, parameters (e.g., hypermeters and/or network parameters) may be iteratively updated until a cost or objective function (e.g., a cross-entropy function) is satisfied.

In some embodiments, the datasets 506B may be partitioned into a first subset (e.g., about 60 percent of the plurality of datasets) for training the neural network 504B and a second subset (e.g., about 40 percent or the remainder of the plurality of datasets) for testing the neural network 504B. In some embodiments, the datasets 506B may be partitioned into a first subset (e.g., about 40 percent of the plurality of datasets) for training the neural network 504B, a second subset (e.g., about 30 percent of the plurality of datasets) for testing the neural network 504B, and a third subset (e.g., about 30 percent of the plurality of datasets) for validating the neural network 504B.

In some embodiments, the neural network 504B may include at least two hidden layers in addition to an input layer and an output layer. The neural network 504B may be trained, tested, and/or validated in a supervised, unsupervised, or hybrid mode using a plurality of datasets 506B (e.g., a plurality of scanned images of one or more users, a plurality of synthetic, artificially created images, or a combination of scanned image(s) and synthetic, artificially created image(s)) for feature learning (e.g., whether an input image 506B include hairs, freckles, wrinkles, moles, pre-malignant skin growth, malignant skin growth, known patterns corresponding to skin diseases, other colored spots, capillaries, and others).

A synthetic, artificially created image may be generated by making an imperceivably small change to an actual image (e.g., a scanned image of a user's skin) in such a way that a human without aid cannot discern the actual image from the synthetic, artificially created image. For example, a synthetic, artificially created image may be created by altering the lightness value (or other values such as chroma value or depth value) with such an imperceivably small amount that human eyes cannot distinguish between the actual image and the synthetic, artificially created image, yet the classifier will misclassify the synthetic, artificially created image (e.g., predicting a different, incorrect skin tone than the ground truth skin tone of the actual image).

In some embodiments, the deep neural network 504B may be trained with one or more such synthetic, artificially created images to improve its accuracy (e.g., better capability in discerning small changes). Such a small change may or may not necessarily apply to the entire frame of an actual image. In some embodiments, a visually imperceivably small change may be made to a small portion of an actual image (e.g., by changing the depth of a hair or a small colored spot in an actual image to make the hair or the small colored spot appear lighter) to generate a corresponding synthetic, artificially created image, and such synthetic, artificially created image may also be used to train the entity recognition and/or feature extraction capability of the deep neural network 504B.

Training the deep neural network 504B may include learning one or more parameters 508B of the neural network 504B. The one or more parameters to be learned may include, for example, one or more network parameters, one or more hyperparameters, or a combination of one or more network parameters and one or more hyperparameters of the neural network 504B.

A hypermeter is a variable that determines the structure of the underlying neural network 504B and/or how the deep neural network 504B is to be trained. In some embodiments, these one or more hyperparameters may include, for example but not limited to, the learning rate of the neural network 504B, the number of hidden layers, the number of neurons in one or more layers, whether and which specific layer(s) and/or whether and which specific neuron(s) may be dropped out or regularized (e.g., whose output is ignored by assigning the corresponding weight to zero) for improving the accuracy of the neural network 504B while conserving computation resources, or any combinations thereof, momentum of the neural network 504B, the total number of epochs for the neural network 504B, one or more batch sizes, or any combination thereof, and others.

In some embodiments, the learning rate of the neural network 504B defines how quickly the neural network 504B updates its parameters. A low learning rate may slow down the learning process but converges smoothly. A larger learning rate speeds up the learning but may not converge. In some embodiments, a decaying learning rate may be used in the neural network 504B. The number of epochs denotes the number of times the entire training data is shown to the network while training. The number of epochs may be increased until the validation accuracy starts decreasing even when training accuracy is increasing (overfitting). A batch size is the number of sub samples given to the network after which parameter update happens. In some embodiments, a batch size may be set to 32, 64, 128, and/or 256, and others.

A hidden layer denotes a layer between the input layer and the output layer of the neural network 504B. In some embodiments, training the neural network 504B may include repeatedly adding a layer to the neural network 504B until the error no longer improves or is within an acceptable or desirable threshold. A larger number of hidden units within a layer with regularization techniques may increase accuracy while a smaller number of units may cause underfitting in some embodiments. The momentum may be used to know the direction of the next step with the knowledge of the previous steps and ma assist to prevent oscillations. In some embodiments, the momentum may be set between 0.5 to 0.9.

The extraction network 510B receives the scan results 502B and performs feature extraction on the received scan results 502B to determine, for example, feature maps that are then passed along to the classification network 512B. The classification network 512B performs classification on the output of the extraction network 510B to generate the predictions 514B.

FIG. 5C illustrates more details about the extraction portion of the simplified high-level block diagram of a method or system for image processing and computer vision, using invariant features and deep learning techniques illustrated in FIG. 5B, according to some embodiments. More specifically, FIG. 5C illustrates more details about the extraction network 510B and the classification network 512B in the recognition and classification system 516B that performs prediction and recognition (e.g., predicting the skin tone, skin condition, diseases, etc. of a user's skin) using a neural network with N levels of hierarchies to represent features in each of an input image. These embodiments incorporate spatial information by successively partitioning each input image into a grid of subregions at each hierarchy of a plurality of hierarchies (e.g., a three-hierarchy, five-hierarchy, and others, partitioning), performing entity (e.g., features such as hairs, freckles, wrinkles, known patterns corresponding to skin diseases, other colored spots, and others) recognition in each subregion, and aggregating (e.g., concatenating the respective results of subregions) the result of each of a plurality of subregions to represent the input image.

The recognition and classification system 516B may include a neural network such as a version of the trained neural network 504B. In some embodiments, the output of the recognition and classification system 516B may be generated by softmax. In some other embodiments, the output of the recognition and classification system 516B may be generated by a number of fully connected layers. In some of these embodiments, only the last N layers (e.g., the last three layers) of the recognition and classification system 516B are used for recognition because outputs of earlier layers in the network have been found not to be very informative from analyses (e.g., entropy analysis). Yet in some other embodiments, the output of the recognition and classification system 516B may use a support vector machine (SVM) model, rather than the aforementioned fully connected layers or softmax in the final layer(s) of the recognition and classification system 516B to avoid overfitting because softmax may tend to overfit in some cases. Each layer (other than the input layer) in the modified version of the trained deep neural network receives outputs (e.g., feature vectors or feature maps) of the preceding layer (e.g., a convolution layer, an input layer, and others).

A support vector machine model may reshape the response maps generated by preceding convolutional layers (e.g., 510B) into feature vectors that are then forwarded to the successive classifier (e.g., 512B) for training or testing. Further, selecting support vector machine over fully connected layer(s) may be based at least in part upon one or more factors including, for example but not limited to, a support vector machine's performance is better than corresponding fully connected layer(s) because the regularization constraint may help combating overfitting that is usually a main issue with fully-connected layers; or the number of parameters of support vector machine is less than that of corresponding fully connected layers and thus makes changing configuration and subsequent tuning, learning, training easier.

The recognition and classification system 516B is aimed at extracting features from different subregions of an input image and aggregating the extracted features of all the subregions together to describe the input image. Moreover, recognition and classification system 516B computes features at a fixed resolution, varies the spatial resolution at which the computed features are aggregated, and produces results in a higher-dimensional representation that preserves more information (e.g., finer features such as thin hairs, thin freckles, and/or thin wrinkles retain two modes at every level of the hierarchy in some embodiments). In these one or more embodiments, an input image is successively subdivided into subblocks, and the artificial intelligence model computes a color attribute (e.g., a histogram or a histogram statistic, and others) for each of the subblocks. Compared with these embodiments, conventional bag of features (BoF) technique may be widely used to depict a scene of a whole picture or determine that an image contains an entity but disregard all info about the layout of the features so they are incapable of capturing shape or of segmenting an entity from its background. In contrast, these embodiments segment a hair, a freckle, or a wrinkle from the background—skin. Further, other conventional approaches attempt to build structural entity descriptors that have been proven to be challenging at least.

Some embodiments compute the feature(s) of each region in convolutional layers in the recognition and classification system 516B. The feature(s) includes a set of response maps generated by the learned filters or kernels in the convolutional layers. Unlike some conventional approach that employ pooling to combine all local features yet lose the information of some pixels that are ignored during pooling, some embodiments consider the information of each pixel in the feature(s) of an input image.

During operation, an input image 502C (or 506B during training, but a version of the trained neural network 504B may be deployed as the extraction network 510B or even the classifier 512B) may be successively partitioned into finer grids at each of a plurality of hierarchies. For the ease of illustration and explanation, FIG. 5C illustrates three hierarchies at which an input image is respectively partitioned into a 1×1 grid, 2×2 grid, and 4×4 grid. It shall be noted that although FIG. 5C illustrates the use of three hierarchies for partitioning an input image into respective square grids, other embodiments may use a different number of hierarchies and/or different grids such as rectangular grids (e.g., 4×3 grid, 16×9 grid, and others). In some of these other embodiments, the partitioning scheme may be determined based at least in part upon, for example but not limited to, the aspect ratio of the input image.

The number of feature types may be determined. For skin tone or condition recognition and prediction, the number of features may include, for example but not limited to, hairs of varying colors, freckles, wrinkles, other colored spots, known patterns corresponding to skin diseases, and others, in some embodiments. The number of features may be referenced during feature extraction (e.g., by 510B) and/or classification (e.g., by 512B) to categorize features into the corresponding bins (e.g., a first bin for hairs of varying colors, a second bin for freckles, a third bin for wrinkles, a fourth bin for other colored spots, and others) At each hierarchy, an image is partitioned into a grid. Each successive partitioning results in a lower resolution. For example, the input image 502B or 502C is partitioned into a 1×1 grid (or no partitioning) having a first resolution (e.g., a 224×224×3 input image) at the first hierarchy. At the second hierarchy, the input image is partitioned into a 2×2 grid as shown in 502C1 having four subregions, and each of the four partition represents a 112×112×3 sub-image with hence a lower resolution than that of 502C. At the third hierarchy, each of the four sub-regions in 502C1 in the input image is further partitioned into a 2×2 grid to result in a total of 4×4 grid (16 subregions) as shown in 502C2, and each of the sixteen partition represents a 56×56×3 sub-image with hence an even lower resolution than that of 502C1.

The extraction network 510B may then perform feature recognition for each of the subregion (for the entire image at the hierarchy) at each of the plurality of hierarchies and place each type of features into a corresponding bin. For an example with three feature types such as a freckle feature type, a hair feature type, and a colored spot feature type for the ease of illustration and explanation, at the first hierarchy, recognized features corresponding to different feature types will be assigned to or associated with respective bins. For example, recognized hair features are assigned to or associated with the first bin 516B1; recognized freckle features are assigned to or associated with the first bin 516B2; and recognized colored spots are assigned to or associated with the first bin 516B3.

At the second hierarchy where an input image is partitioned into a 2×2 grid (with 2×2 subregions) 502C1, for each subregion, recognized features corresponding to different feature types will be assigned to or associated with respective bins. For example, recognized hair features are assigned to or associated with the first bin 516B4; recognized freckle features are assigned to or associated with the first bin 516B5; and recognized colored spots are assigned to or associated with the first bin 516B6. Similarly, at the third hierarchy where each subregion in 502C1 is further partitioned into a 2×2 grid (with 2×2 subregions) 502C2, for each subregion in 502C2, recognized features corresponding to different feature types may be assigned to or associated with respective bins. For example, recognized hair features are assigned to or associated with the first bin 516B7; recognized freckle features are assigned to or associated with the first bin 516B8; and recognized colored spots are assigned to or associated with the first bin 516B9.

In this manner, these embodiments illustrated in FIG. 5C compute features (e.g., recognized features of each type, histogram with different types of features in different bins, and/or a histogram statistic) at a fixed resolution for each subregion, vary the spatial resolution at which the computed features are aggregated by successively partitioning an input into finer grids, and produce a higher-dimensional representation that preserves more information (e.g., fine features such as thin white and thin black lines retain two modes at every level of the spatial hierarchy in the invention but may be represented as uniform gray in all but the finest level of multiresolution histogram). This is in sharp contrast with conventional approaches using multi-resolution features or histograms that are obtained by repeatedly subsampling an input image and computing a global histogram of pixel values at each new level and thus result in loss of information due to discarding information about the layout of the features so that these conventional approaches are incapable of capturing the shape or segmenting an entity from its background.

In other words, these embodiments present a much superior approach to feature extraction and color recognition in at least that these embodiments accurately segment features (e.g., hairs, freckles, wrinkles, other colored spots, diseases, etc.) from the background (a user's skin) so that the skin tone of the skin is more accurately determined by ignoring the recognized features and focusing on the skin to determine the skin tone. For example, the presence of hairs and features having colors different from the true skin tone may obscure the computed histogram due to the presence of different color(s) in an image and thus produce less accurate skin tone prediction. Further, the segmented features may be separately processed (e.g., recognizing a colored spot having an off-white color) so that different product(s) may be recommended (e.g., concealer) for this colored spot.

FIG. 5D illustrates more details about the neural network portion of the simplified high-level block diagram of a method or system for image processing and computer vision, using invariant features and deep learning techniques illustrated in FIG. 5B, according to some embodiments. More specifically, FIG. 5D illustrates a simplified schematic diagram of the architecture of the neural network 504B in FIG. 5B. In these embodiments, the neural network 504B may include a stack of convolutional layers that are linked together to generate predictions (e.g., 514B).

The stack of convolutional layers may include a first convolutional network 502D1 followed by a second convolutional network 502D2. The output of the second convolutional network 502D2 is provided as an input to the third convolutional network 502D3 that is followed by the fourth convolutional network 502D4. The output of the fourth convolutional network 502D4 is provided as an input to the fifth convolutional network 502D5 which is in turn followed by the sixth convolutional network 502D6 that generates the predictions 514B.

More specifically, the first convolutional network 502D1 includes a first convolutional layer 504D1 having an M×M kernel with N channels. The convolutional output of 504D1 is fed to the activation layer 506D1 (e.g., Rectified Linear Unit or ReLU) whose activated output is then processed by a P×P pooling layer 508D1 (e.g., a max pooling layer, an average pooling layer, etc.) whose output is then forwarded to a normalization layer 510D1. The output of the normalization layer 510D1 is provided as an input for the second convolutional network 502D2.

In these embodiments illustrated in FIG. 5D, the second convolutional network 502D2 is identical to the first convolutional network 502D1 and includes a first convolutional layer 504D2 having an M×M kernel with N channels. The convolutional output of 504D2 is fed to the activation layer 506D2 (e.g., Rectified Linear Unit or ReLU) whose activated output is then processed by a P×P pooling layer 508D2 (e.g., a max pooling layer, an average pooling layer, etc.) whose output is then forwarded to a normalization layer 510D2. The output of the normalization layer 510D2 is provided as an input for the third convolutional network 502D3.

The third convolutional network 502D3 includes a first convolutional layer 504D3 having an M×M kernel with N channels. The convolutional output of 504D3 is fed to the activation layer 506D3 whose output is then forwarded as an input to the fourth convolutional network 502D4.

The fourth convolutional network 502D4 includes a first convolutional layer 504D4 having an M×M kernel with N channels. The convolutional output of 504D4 is fed to the activation layer 506D4 whose output is then forwarded as an input to the fourth convolutional network 502D5.

The fifth convolutional network 502D5 includes a first convolutional layer 504D5 having an M×M kernel with N channels. The convolutional output of 504D5 is fed to the activation layer 506D5 (e.g., Rectified Linear Unit or ReLU) whose activated output is then processed by a P×P pooling layer 508D5 (e.g., a max pooling layer, an average pooling layer, etc.) whose output is then forwarded as an input to the sixth, final convolutional network 502D2.

The sixth convolutional network 502D6 includes a first fully connected (FC) layer 516D having, for example, an M×M kernel with N channels. The convolutional output of 516D is fed to a second fully connected layer 518D whose output is then forwarded as an input to the third fully connected layer 520D that generate the predictions 514B as the output of 504B.

FIG. 5E illustrates a block diagram of an environment in which a method or system for generating recommendations for a skin condition using invariant features and deep learning techniques for image processing and computer vision may be implemented, according to some embodiments. More specifically, FIG. 5E illustrates a simplified schematic environment which predicts personalized matching and recommendations for products, services, treatment options, or any combinations thereof for a specific person. In these embodiments, a plurality of data processing sources 502E may provide a variety of data such as service data 510E, product data 506E, user data 504E, general data 508E, historical data 512E, etc. that pertains to various products, services, treatment options, or any combinations thereof with user interactions.

Service data 510E may include, for example, data pertaining to cosmetic and/or medical services that are available or that have been performed on one or more users. Product data 506E may include, for example, product ingredients, product color space information, brands, manufacturers, pricing, availability, reviews, sales per time period, demographic, ethnic, and/or age information of users of a particular product, product identifier, information pertaining to related and/or equivalent products, brand name of the product, generic name of the product, product images, product package images, ways of application (e.g., ingestion, external application only, frequency of application or ingestion, etc.), or any other desired or required data or information pertaining to a product such as a cosmetic product (e.g., foundation, concealer, lip products, etc.), a medical treatment product (e.g., medication), etc.

User data 504E may include information about a user's age or age range, ethnicity, demographic areas, geographic regions, profession, loyalty, preference, other products acquired, history of receiving, applying, or using product(s), service(s), and/or treatment option(s), prognosis of a skin disease or a skin condition after receiving product(s), service(s), and/or treatment option(s), prior purchase history, prior return history, prior complaint history about product(s), service(s), and/or treatment option(s), affinity and/or preference data (e.g., affinity or preference for types of products, services, and/or treatment options, types of application or usage, color, price, brands, manufacturer, etc.), transaction histories, or any other data pertaining to or specific to a user.

General data 508E may include, for example but not limited to, libraries, databases, performance monitoring data and statistics, application data, etc. Historical data 512E may include, for example but not limited to, treatment history, prior purchase, prior complaints about product(s), service(s), and/or treatment option(s), or any other temporal data pertaining to the specific combination of a user and a product, a service, a treatment option, or a combination thereof.

Each of the aforementioned types of data may be processed (e.g., via classification or clustering) into a corresponding topic that includes one or more logical groupings of events. For example, service data 510E may be processed into “topic 1” 510E1; product data 506E may be processed into “topic 2” 506E1; user data 504E may be processed into “topic 3” 504E1; general data 508E may be processed into “topic 4” 508E1; and service data 512E may be processed into “topic 5” 512E1.

A topic so generated may be sent to a cluster 516 that is further coupled with or include, for example, artificial intelligence models 518E and one or more recommender 520E that further support the cluster 516E to process various topics (e.g., performing various data analytics tasks) by using one or more schemas 522E. In some embodiments, a topic or a smaller portion thereof may be designated to a compute resource in the cluster 516E, and a compute resource in the cluster 516E may, depending upon workload balancing, process a topic, a smaller portion of a topic, or more than one full topic.

FIG. 5F illustrates more details about the recommender of the block diagram of a method or system for image processing and computer vision, using invariant features and deep learning techniques illustrated in FIG. 5E, according to some embodiments. More specifically, FIG. 5F illustrates more details about the recommender 520E in FIG. 5E. In these embodiments, the example recommender 520E illustrated in FIG. 5E generates a recommendation at least by invoking the processes or services of two major components—knowledgebase embeddings (e.g., embeddings via textual embedding 512F, visual embedding 514F, audio embedding 552F, and relation embedding 516F respectively for knowledge bases 506F, 508F, 510F, and 550E) and joint learning 532F that utilizes at least the embedding representations described below and a latent offset representation (e.g., a latent offset vector) for each of a plurality of objects (e.g., users, products, and others) Both knowledgebase embeddings via respective network embedding processes or services (e.g., deep networks).

These embodiments illustrate a multi-layer perceptron (MLP)-based hybrid deep network that predicts general as well as personalized recommendations. In some embodiments, the convolutional neural network (CNN) portion in an MLP-based hybrid deep network models the non-linear interactions between users and items and extracts local and global representations from heterogeneous data sources (e.g., textual and visual information or data sources), while the recurrent neural network (RNN) portion in the MLP-based hybrid deep network models enable the recommender system to model the temporal dynamics and sequential evolution of information such as information or data pertaining to user-product interactions, product purchases, product returns, histories thereof, and others.

In these embodiments, a recommendation model such as a recommender 520E described above may receive a plurality of datasets 560F that includes user datasets 502F pertaining to various users (e.g., clients, prospective clients, beauty advisors, cosmetics professionals, developers, and others) and product datasets 504E-512E pertaining to various attributes of products, services, or treatment options, or any combinations thereof. These user datasets 502F and product datasets 504E-512E may be stored in one or more databases or knowledge bases (e.g., 506F, 508F, 510E, 550F). In some embodiments, these user datasets 902E and product datasets 904E may include data of multiple data types such as a textual data type, a visual data type (e.g., images, videos, and others), or other data types (e.g., symbols, links, and others) In these embodiments, data having different data types in the user datasets 902E and product datasets 904E may be separately stored into separate databases or separate knowledge bases. For example, textual data may be stored in one or more textual databases or knowledge bases 506F, visual data may be stored in one or more visual databases or knowledge bases 508F, audio data may be stored in one or more audio databases or knowledge bases 510F, and other types of data such as relationships may be stored in one or more other databases or knowledge bases 550F.

In some embodiments, such other types of data may include structural data, linkage data, links, symbols, and others. of a heterogeneous collection of information with multiple types of objects (in the sense of object-oriented programming) and multiple links to express the structure of the knowledgebase for such other types of data. In these embodiments, the aforementioned links describe relationships between these objects (e.g., product types-foundation, concealer, specific type of users, rating, user behaviors, and others) and may thus be used to represent some similarity among objects.

The data stored in the one or more databases or knowledge bases (e.g., 506F, 508F, 510F, 550F) may be processed into embeddings (also referred to as embedding representation or embedding vectors). In some embodiments, an embedding is a relatively low-dimensional space into which high-dimensional vectors may be translated. In these embodiments, embeddings facilitate deep learning on large inputs like sparse vectors representing words much more easily. For example, textual data stored in a textual database or knowledgebase 506F may be processed by a textual embedding process or service 512F to for a plurality of textual vectors 518F; visual data stored in a visual database or knowledgebase 508F may be processed by a visual embedding process or service 514F to for a plurality of visual vectors 520F; audio data stored in a visual database or knowledgebase 510F may be processed by an audio embedding process or service 552F to for a plurality of audio vectors 554F; and other types of data stored in a database or knowledgebase 550F may be processed by a relationship embedding process or service 516F to for a plurality of relationship vectors 522F. In addition or in the alternative, one or more product datasets 504E-512E may also be processed (e.g., via quantization) into entity vectors 524F.

The user datasets 502F may be processed into a plurality of user latent representations 528F (e.g., latent vectors or embedding vectors in one or more latent spaces). A latent representation includes an abstract multi-dimensional representation which includes feature values that cannot be directly interpreted or measured, but which encodes a meaningful internal representation of externally observed events or data in some embodiments. User datasets 502F include, for example, users' explicit or implicit feedback captured in structured and/or unstructured, heterogeneous forms or formats of textual (e.g., textual reviews, textual comments, textual descriptions, purchase histories, return histories, loyalty and affinity data, preferences, transaction data, and others), visual (e.g., images and/or videos pertaining to users' experiences with, comments on, and/or reviews of cosmetic products), and/or other formats (e.g., symbolic ratings, emojis expressing users' take on cosmetic products, and others)

These heterogeneous forms or formats of data may nevertheless exhibit some relationships, interactions, and/or linkages among each other. In addition, user data may further exhibit relationships, interactions, and/or linkages with product data (e.g., data in the product datasets 504E-512E). Similarly, the product datasets 504E-512E may also be processed into corresponding latent representations 526F (e.g., latent vectors or embedding vectors in one or more latent spaces). With the user latent representations 528F and product latent representations 526F respectively generated for the user datasets 502F and the product datasets 504E-512E, joint learning 532F generates a final recommendation at least by utilizing at least one of these latent representations (e.g., a textual latent vector, a visual latent vector, and a relationship latent vector for an entity such as a particular user or a product) and a latent offset representation therefor (e.g., a latent offset vector).

FIG. 5G illustrates more details about the relation embedding portion of the block diagram of a method or system for image processing and computer vision, using invariant features and deep learning techniques illustrated in FIG. 5F, according to some embodiments. In these one or more embodiments, a plurality entities (e.g., one or more user entities and one or more product entities) may be identified at 502G. Each of these one or more user entities may represent a user where users may include clients of cosmetic products (or services, or treatment options) of a particular manufacturer or brand, prospective clients of the cosmetic products of the particular manufacturer or brand, beauty advisors, sales representatives of cosmetic products, cosmetics professionals, developers, etc.

One or more edges (e.g., rᵤ₋ₚ of one or more types between entity Oᵤ and entity Oₚ that represent respective relationships among the plurality of entities may also be determined at 504G. In some of these embodiments, these entities identified at 502G and edges determined at 504G may be populated into a graph. In one embodiment, relationships have multiple types (e.g., reviewed, purchased, returned, commented), and each type may have multiple sub-types (e.g., positive, neutral, negative). In another embodiments, each relationship type is codified to distinguish from other similar relationship types (e.g., negative review vs. neutral review vs. positive review).

The plurality of entities identified at 502G and the plurality of edges determined at 504G may be respectively embedded or transformed into corresponding vector representations at 506G. The plurality of entities and the edges may or may not necessarily have the same dimensionality due to the differences in their attributes. For example, user entities and products may be modeled or converted into an entity space of dimensionality M, while relationships (edges) may be modeled or converted into a relationship space of dimensionality N where M and N are not necessarily equal. Embedding or transforming entities and edges may include identifying a relationship, rᵤₚ, between a user entity Oₙ and a product entity Oₚ, where the suffices u, p, and u-p respectively denote user, product, and between user and product. All entity pairs (e.g., (Oᵤ, Oₚ)) may be represented with their vector offset (Oᵤ-Oₚ) for clustering and subsequent operations in some embodiments.

In some embodiments, one or more n-tuples (Oᵤ, Oₚ, rᵤₚ) may be generated for the plurality of entities. In some embodiments, a relationship indicates that there has been an interaction between the particular user and the particular product although the existence of a relationship/interaction does not necessarily breathe positive or negative connotations. In one embodiment, relationships have multiple types (e.g., reviewed, purchased, returned, commented), and each type may have multiple sub-types (e.g., positive, neutral, negative). In another embodiments, each relationship type is codified to distinguish from other similar relationship types (e.g., negative review vs. neutral review vs. positive review).

The plurality of entities or the one or more n-tuples may be converted or embedded into respective vectors based at least in part upon their respective dimensionalities. For example, user entities and product entities may be converted or embedded into corresponding vectors in an entity space having M dimensionality (e.g., the entity space) while relationships may be converted or embedded into corresponding vectors in a relationship space having N dimensionality (e.g., the original vector space in which the relationship is captured or modeled), where M and N may or may not necessarily be equal. With the example dimensionalities of M and N provided above, a relationship may be projected, transformed, or mapped into a relationship space having a dimensionality of M×N (e.g., a relationship space) by using a transform, a mapping, etc. (e.g., a projection transform).

An objective or score function may be determined for evaluating (e.g., ranking) the plurality of n-tuples. In some embodiments, the objective or score function may be generated by using the L2 norm pertaining to the embeddings (e.g., transformation or mapping of entities and edges (or n-tuples) to the relationship space) although it shall be noted that other objective or score functions may also be used. For example, the objective or score function may be based on ∥O_{u_r}−O_{p_r}+r_{up_r}∥₂² where O_{u_r}, O_{p_r}, and r_{u-p_r} respectively denote the user entity, the product entity, and the relationship in the relationship space. For example, a score function (fᵣ) may include f(Oᵤ, Oₜ)=∥O_{u_rc}−O_{p_r}∥+r_{u-p_r}∥₂²+6∥r_{p_r,c}−r_{up_r}∥₂² where the suffix c denotes clustering, and the suffix r denotes the relationship space, ∥r_{u-p,c}−rᵤ₋ₚᵣ∥₂² is used to control that the clustering-specific relationship (r_{u-p_r}) and the original relationship (r_{up_r}) are bound within some threshold distance (e.g., not sufficiently far from each other), and c is used to control the effect of ∥r_{u-p_r,e}−r_{up_r}∥₂² and may also be learned during training

One or more constraints may be determined on the aforementioned objective or score function. In some embodiments, the one or more constraints may include:

$${‖ {O}_{u} ‖}_{2} <= 1 ; \\ {‖ Op ‖}_{2} <= 1 ; \\ {‖ r ‖}_{2} <= 1 ; \\ {‖ {O}_{u \_ r} ‖}_{2} <= 1 ; and \\ {‖ {O}_{p \_ r} ‖}_{2} <= 1.$$

A transform, T, may be determined based at least in part upon the relationship, r_{u_p}, between a user entity Oᵤ and a product entity Oₚ. That is, O_{u_r}=T*Oᵤ O_{p_r}=T*Oₚ; and rᵤₚᵣ=T_{ru_p} where the suffix “r” denotes the relationship space. The entities (or entity vectors) Oᵤ and Oₚ may be respectively transformed or mapped, with the transform T, from the entity space into O_{u_r} and O_{p_r} in the relationship space by using: O_{u_r}=Oᵤ*T; O_{p_r}=Oₚ*T, where O_{u_r} and O_{p_r} in the relationship space. A plurality of n-tuples (e.g., (Oᵤ, Oₚ, rᵤ₋ₚ)) may be generated for the entities and the relationships.

A n-tuple may be destructed into a destructed or incorrect n-tuple at 508G. In some embodiments, a destructed or incorrect n-tuple (collectively a synthetic n-tuple) may be determined at 508G by replacing an entity (e.g., a user entity or a product entity) in an original n-tuple where a relationship does exist between the user entity and the product entity in the original n-tuple so that the aforementioned relationship in the original n-tuple no longer exists in the destructed or incorrect n-tuple. For example, a user U had one or more interactions or relationship R with a product U in the original n-tuple (U, P, R). A destructed n-tuple may be generated by replacing the user U with a different user entity U′ so that there is no interaction (or relationship) between the user entity U′ and the product entity P. The destructed n-tuple may then be generated as (U′, P, R). Similarly, another destructed n-tuple may be generated by replacing the product entity P with a different product entity P's with which the user entity U had no interactions or relationship. This destructed n-tuple may be generated as (U, P′, R).

In some sense, a destructed n-tuple represents an adversarial example that is synthetically generated by altering the corresponding original example (Oᵤ, Oₚ, rᵤₚ) into a synthetically fabricated record (Oᵤ, O′ₚ, r_{u_p}). Further, due to the fact that most, if not all, of the data is not directly measurable or detectable by humans (at least not without expending substantial amount of time and effort), this non-measurability or detectability of the aforementioned destructed or incorrect n-tuples is also similar to the non-visibility of adversarial examples. In some embodiments, a destructed example may also be synthetically generated by replacing the user entity with a different user for which no relationship exists between the different user and the product, whereas a relationship does exist in the existing n-tuple between the original user entity and the product entity. A nonlinear function (e.g., a logistic sigmoid function, 1/(1+e^{-x}), a margin-based function, etc.) may be determined and used in computing the objective or score function for determining the pairwise n-tuple ranking measure.

A pairwise n-tuple ranking measure (e.g., a probability of a user entity Oᵤ and a product entity Oₚ having a relationship r_{u_p} or p(Oᵤ, Oₚ I r_{u_p})) may then be determined based at least in part upon the aforementioned destructed n-tuple and the objective or score function. More particularly, determining a pairwise n-tuple ranking measure for a n-tuple may include destructing the n-tuple (Oᵤ, Oₚ, rᵤₚ) to generate a destructed or incorrect n-tuple (Oᵤ, O′ₚ, r_{u_p}) where the relationship rᵤ₋ₚ does not exist between the user entity Oᵤ and the product entity O′ₚ (and hence “destructed” or “incorrect” n-tuple). In some embodiments, a pairwise n-tuple ranking probability or measure may be computed based at least in part upon the aforementioned objective or score function.

In some embodiments, a Bayesian form for a correct n-tuple and an incorrect n-tuple may be determined by using a nonlinear function. Such nonlinear functions that may be used to determine the Bayesian form may include, for example but not limited to, a logistic sigmoid function, 1/(1+e^{-x}), a margin-based function, or any other suitable or appropriate functions, etc. In some embodiments, the embedding module described herein may be trained at 510G by iteratively using a plurality of correct n-tuples and the corresponding plurality of destructed, incorrect n-tuples with an objective or cost function and a gradient descent (e.g., a stochastic descent algorithm, the Newton-Raphson method, the steepest descent method, or other appropriate algorithms or methods) by populating errors backward through the network for the embedding module to distribute the errors according to a gradient of the errors and by updating the network accordingly. In some embodiments, the objective or cost function may include: Σ_{(Ou,Op,ru-p)}{Σ_{O′u,O′p,r′u-p}{Max(0,fᵣ(Oᵤ,Oₚ))+γ−fᵣ(O′ᵤ,O′ₚ)}}, where γ denotes the margin, (Oᵤ, Oₚ, rᵤ₋ₚ) denote the correct n-tuples, and (Oᵤ, P′ₚ, r_{u-p_r}) and (O′ᵤ, Pₚ, r_{u-p_r}) denote the incorrect n-tuples.

In these embodiments, representing entities as vectors (e.g., by quantization or other appropriate techniques), various parameters (e.g., weights, the objective or cost function described immediately above, the score function fᵣ( ), the one or more constraints, the coefficient λ described above with reference to the objective or cost function, etc. may be learned during training. Training the embedding module or model may involve an iterative process where one or more parameters or entities are updated in an iteration, and the training returns to, for example, update the module or model with the one or more modified parameters or entities in the previous iteration and repeats the steps until a convergence criterion is met (e.g., the reduction in errors between two successive iterations is smaller than a convergence threshold, a limit of the number of iterations to be performed or time for iteration has been reached, or any other suitable or appropriate criterion).

FIG. 5H illustrates more details about the textual embedding portion of the block diagram of a method or system for image processing and computer vision, using invariant features and deep learning techniques illustrated in FIG. 5F, according to some embodiments. More specifically, FIG. 5H illustrates more details about textual embedding illustrated as 512F in FIG. 5F. These one or more embodiments utilize a neural network for learning the representation of the input data, which is often, if not always, contaminated with noise, non-informative information, etc., by learning to predict a clean (e.g., denoised) version or content.

The example neural network 512F illustrated in FIG. 5H may include a total of L layers (seven layers are shown in FIG. 5H for the ease of illustration and explanation although a more or fewer number of layers may also be utilized in other embodiments). These L layers may be approximately divided into two portions where the first ˜½ L layers 516H (including layers 502H, 504H, 506H, 508H) represent an encoding part that maps the input data 550H received at the input layer 502H from, for example, the textual knowledgebase 906F into a textual vector (e.g., 518F in FIG. 5F) and then to a latent representation (e.g., 926F in FIG. 5F). The input data received at the input layer 502H may include contaminated data with noise, non-informative information, etc. as described above. Such noise, non-informative information, etc. may cloud the accuracy of the vector representation and hence the latent vector to correctly represent the informative information in the original input data.

The encoding portion 516H may include a plurality of hidden layers (e.g., 504H, 506H) that successively process their respective input to eventually generate a textual embedding vector 508H. For example, hidden layer 504H may receive the output of the input layer 502H to generate a first output by performing an inner product between the input and a kernel (also referred to as a kernel or a weight matrix); and hidden layer 506H may receive the first output of the hidden layer 504H as its own input and generate the textual embedding vector 9081 by performing a separate inner product between the input (the output of hidden layer 504H) and the corresponding kernel. For a hidden layer (e.g., a convolution layer), the out [Yⱼ] generated by the hidden layer for the input [X,] may be expressed as Yⱼ=σ(Wᵢⱼ*Xᵢ+bⱼ). where Yⱼ, Wᵢⱼ, Xᵢ, bⱼ, and σ respectively denote the output, the kernel, the input, the bias, and learning rate. The kernel and the bias may also be learned during training.

The remaining ˜½L layers 518H (e.g., including 508H, 510H, 512H, and 514H) represent the decoding portion of the neural network 512F. More specifically, the hidden layers 510H and 512H respectively receive their inputs from the immediately preceding layers to generate respective outputs. For example, hidden layer 510H receives the textual embedding vector 508H to generate a first output that is received by hidden layer 512H as an input. Hidden layer 512H generates a second output that is then received by the last layer 514H that in turn generates a clean, more compact output embedding (e.g., clean textual data 552H) for the original input textual data 550H that may be further stored in a textual knowledgebase or database 906F.

In some embodiments, the weight parameters for the kernel (also referred to as a weight matrix or filter) may be drawn from the Gaussian distribution

$$N ( 0 , {λ}_{W}^{- 1} I ) ,$$

where I denotes an identity matrix, and λ_{W} denotes a model-specific regularization parameter that may be learned during training. In some of these embodiments, the weight parameter may be expressed as a more generalized normal distribution with zero mean and variance-covariance matrix. The use of

$$N ( 0 , {λ}_{W}^{- 1} I )$$

may reduce the total number of unknown hyperparameters in some embodiments. The other entities such as the objects (O), relationships (r), bias parameter (b), etc. may also be determined similarly. For example, the bias parameter, b, may be drawn from the Gaussian distribution

$$N ( 0 , {λ}_{b}^{- 1} I ) ,$$

where I denotes an identity matrix, and λ_{ab} denotes a parameter that may be learned during training; a relationship, r, may be drawn from the Gaussian distribution

$$N ( 0 , {λ}_{r}^{- 1} I ) ,$$

where I denotes an identity matrix, and λᵣ denotes the aforementioned model-specific regularization parameters that may be learned during training; and an object, O, may be drawn from the Gaussian distribution

$$N ( 0 , {λ}_{O}^{- 1} I ) ,$$

where I denotes an identity matrix, and λₒ denotes a parameter that may be learned during training. In some embodiments, the aforementioned parameters (e.g., λ_{W}, λ_{b}, λᵣ, and λₒ may be learned during training based at least in part on the datasets used in training (e.g., different datasets may provide different, optimized parameter values). In some of these embodiments, these parameters may be learned from a range between 0 and 0.5 (e.g., λ_{W}=0.01, λ_{b}=0.01, λᵣ=0.001, and λₒ=0.005), and the learning rate, σ, may be set to 2 or 3.

For the output Y of an L-th layer, Y may be drawn from a Gaussian distribution,

$$N , as {Y}_{L} ∼ N ( σ ( {W}_{L} * {Y}_{L - 1} + {b}_{L} ) , {λ}_{Y}^{- 1} I ) ,$$

where I denotes an identity matrix, λ_{Y} denotes a parameter, σ denotes the learning rate hyperparameter, WL denotes the L-th layer kernel, Y_{L-1} denotes the output of the (L-1)-th layer, all of which may be learned during training. These techniques may thus determine a user latent vector or representation and the product latent vector or representation accordingly. For a triple, (Oᵤ, Oₚ, rᵤ₋ₚ) showing i-th user O_{u,i} prefers j-th product O_{p,j} over the j′-th product, O_{p,j}, its probability, p(j>j′) may be determined by

$$σ ( {O}_{u , i}^{T} {Z}_{j} - {O}_{u , i}^{T} {Z}_{j}^{′} ) , where σ , {O}_{u , i}^{T} , {Z}_{j} and {Z}_{j}^{′}$$

respectively denote the learning rate hyperparameter, the i-th user object's vector representation, the latent representation capturing the j-th product's latent and the i-th user object, and the latent representation capturing the j′-th product's latent and the i-th user object.

FIG. 5I illustrates more details about the visual embedding portion of the block diagram of a method or system for image processing and computer vision, using invariant features and deep learning techniques illustrated in FIG. 5F, according to some embodiments. More specifically, FIG. 5I illustrates more details about visual embedding illustrated as 514F in FIG. 5F. These one or more embodiments utilize a neural network for learning the representation of the input data, which is again often contaminated with noise, non-informative information, etc., by learning to predict a clean (e.g., denoised) version or content.

The example neural network 514F illustrated in FIG. 5I may include a total of L layers (seven layers are shown in FIG. 5I for the ease of illustration and explanation although a more or fewer number of layers may also be utilized in other embodiments). These L layers may be approximately divided into two portions where the first ˜½ L layers 516I (including layers 502I, 504I, 506I, and 508I) represent an encoding part that maps the input data 550I received at the input layer 502I from, for example, the visual knowledgebase 508F into a visual vector (e.g., 520F in FIG. 5F) and then to a latent representation (e.g., 526F in FIG. 5F). In some embodiments, layers 502I and 504I may be convolution layers, and layer 506I may be a fully connected layer receiving the output (e.g., feature vectors or feature maps) from layer 504I. The outputs of layers 504I and 506I include feature vectors or feature maps based on the respective input to these two layers from their immediately preceding layers. The visual embedding vector 908F represents a collection of all objects' visual embedding vectors in some embodiments. The input data received at the input layer 502I may include contaminated images with noise, non-informative information, etc. as described above. Such noise, non-informative information, etc. may cloud the accuracy of the vector representation and hence the latent vector to correctly represent the informative information in the original input data.

The encoding portion 516I may include a plurality of hidden layers (e.g., convolution layers 504I, 506I) that successively process their respective input to eventually generate a textual embedding vector 508I. For example, hidden layer 504I may receive the output of the input layer 502I to generate a first output by performing an inner product between the input and a kernel (also referred to as a kernel or a weight matrix); and hidden layer 506I may receive the first output of the hidden layer 504I as its own input and generate the visual embedding vector 508I by performing a separate inner product between the input (the output of hidden convolution layer 504I) and the corresponding kernel. In some embodiments, hidden layer 510I may be a fully connected layer generating a feature vector or feature map as output. Hidden layers 512I and 514I may be convolution layers each receiving respective input from the immediately preceding layer to generate a feature vector or feature map as output. For a hidden layer (e.g., a convolution layer), the out [Yⱼ] generated by the hidden layer for the input [Xᵢ] may be expressed as Yⱼ=σ(W_{Ij}*X_{I}+bⱼ). where Yⱼ, Wᵢⱼ, Xᵢ, bⱼ, and σ respectively denote the output, the kernel, the input, the bias, and learning rate. The kernel and the bias may also be learned during training.

The remaining ˜½ L layers 518I (e.g., including 508I, 510I, 512I, and 514I) represent the decoding portion of the neural network 514I. More specifically, the hidden layers 510I and 512I respectively receive their inputs from the immediately preceding layers to generate respective outputs. For example, hidden layer 510I receives the textual embedding vector 508I to generate a first output that is received by hidden layer 512I as an input. Hidden layer 512I generates a second output that is then received by the last layer 514I that in turn generates a clean, more compact output embedding (e.g., clean textual data 552I) for the original input textual data 550I that may be further stored in a visual knowledgebase or database 508F.

In some embodiments, the weight parameters for the kernel (also referred to as a weight matrix or filter) may be drawn from the Gaussian distribution

$$N ( 0 , {λ}_{W}^{- 1} I ) ,$$

where I denotes an identity matrix, and λ_{W} denotes a model-specific regularization parameter that may be learned during training. In some of these embodiments, the weight parameter may be expressed as a more generalized normal distribution with zero mean and variance-covariance matrix. The use of

$$N ( 0 , {λ}_{W}^{- 1} I )$$

may reduce the total number of unknown hyperparameters in some embodiments. The other entities such as the objects (O), relationships (r), bias parameter (b), etc. may also be determined similarly.

For example, the bias parameter, b, may be drawn from the Gaussian distribution

$$N ( 0 , {λ}_{b}^{- 1} I ) ,$$

where I denotes an identity matrix, and λ_{b} denotes a parameter that may be learned during training; a relationship, r, may be drawn from the Gaussian distribution

$$N ( 0 , {λ}_{r}^{- 1} I ) ,$$

where I denotes an identity matrix, and λᵣ denotes the aforementioned model-specific regularization parameters that may be learned during training; and an object, O, may be drawn from the Gaussian distribution

$$N ( 0 , {λ}_{O}^{1} I ) ,$$

where I denotes an identity matrix, and λₒ denotes a parameter that may be learned during training. In some embodiments, the aforementioned parameters (e.g., λ_{W}, λ_{b}, λᵣ, and λₒ may be learned during training based at least in part on the datasets used in training (e.g., different datasets may provide different, optimized parameter values). In some of these embodiments, these parameters may be learned from a range between 0 and 0.5 (e.g., λ_{W}=0.01, λ_{b}=0.01, λᵣ=0.001, and λₒ=0.005), and the learning rate, a, may be set to 2 or 3.

For the output Y of an L-th layer, Y may be drawn from a Gaussian distribution,

$$N , as {Y}_{L} ∼ N ( σ ( {W}_{L} * {Y}_{L - 1} + {b}_{L} ) , {λ}_{Y}^{- 1} I ) ,$$

where I denotes an identity matrix, λ_{Y} denotes a parameter (e.g., a model-specific parameter), σ denotes the learning rate hyperparameter, W_{L} denotes the L-th layer kernel, Y_{L-1} denotes the output of the (L-1)-th layer, all of which may be learned during training. These techniques may thus determine a user latent vector or representation and the product latent vector or representation accordingly. For a triple, (Oᵤ, Oₚ, rᵤ₋ₚ) showing i-th user O_{p,u} prefers j-th product O_{p,j} over the j′-th product, O_{p,j}, its probability, p(j>j′) may be determined by

$$σ ( {O}_{u , i}^{T} {Z}_{j} - {O}_{u , i}^{T} {Z}_{j}^{′} ) , where σ , {O}_{u , i}^{T} , {Z}_{j} , and {Z}_{j}^{′}$$

respectively denote the learning rate hyperparameter, the i-th user object's vector representation, the latent representation capturing the j-th product's latent and the i-th user object, and the latent representation capturing the j′-th product's latent and the i-th user object.

FIG. 5J illustrates more details about the joint learning portion of the block diagram of a method or system for image processing and computer vision, using invariant features and deep learning techniques illustrated in FIG. 5F, according to some embodiments. In these embodiments, a relationship may be identified at 502J where the relationship indicates that a user entity prefers a first product entity over a second product entity based at least in part upon one or more interactions between the user entity and the first and second product entities. For example, an i-th user entity of a total of M user entities may have one or more interactions with the j-th product entity but not with the j′-th product entity of the total of N product entities. In some embodiments, an array having M×N dimensionality may be used to store such interactions. For example, the field corresponding to the i-th user entity and the j-th product entity may be assigned a value of 1 to indicate the existence of the one or more interactions between the i-th user and the j-th product, and the field corresponding to the i-th user entity and the j′-th product entity may be assigned a value of o to indicate the absence of any interactions between the i-th user and the j′-th product.

A latent product entity vector or representation for a product object, a latent user entity vector or representation for the user object, and a relationship latent vector or representation may be respectively determined at 504J at least by using respective normal distributions for textual, visual, and relationship data embeddings. In the examples described above for FIG. 5I, the latent representation, Zⱼ, capturing the j-th product's latent and the i-th user entity may be determined as: Zⱼ=O_{u,j}+O_{p,j}+Ψ_{i,j}+Ω_{i,j}, where O_{u,j}, O_{p,f}, Ψ_{l,f} and Ω_{l,f} respectively denote the i-th user's latent representation with respect to the j-th product object, the j-th product object's latent representation, the output of the textual knowledge embedding by the layer L, and the output of the visual knowledge embedding by the layer L.

As described in the embodiments illustrated in FIG. 5I, O_{u,f} may be determined by drawing from the Gaussian distribution (normal distribution with zero mean) using the expression:

$$N ( 0 , {λ}_{u}^{- 1} I ) ,$$

where I denotes an identity matrix, and λᵤ denotes a model-specific parameter (e.g., a user entity embedding model) that may be learned during training. In some of these embodiments, the weight parameter may be expressed as a more generalized normal distribution with zero mean and variance-covariance matrix. The use of

$$N ( 0 , {λ}_{u}^{- 1} I )$$

may reduce the total number of unknown hyperparameters in some embodiments.

Further, O_{p,j} may be determined by drawing from the Gaussian distribution using the expression:

$$N ( 0 , {λ}_{p}^{- 1} I ) ,$$

where I denotes an identity matrix, and λₚ denotes a model-specific parameter (e.g., a product entity embedding model) that may be learned during training. In some of these embodiments, the weight parameter may be expressed as a more generalized normal distribution with zero mean and variance-covariance matrix. The use of

$$N ( 0 , {λ}_{p}^{- 1} I )$$

may reduce the total number of unknown hyperparameters in some embodiments.

Moreover, Ψ_{L,j} represents the textual embedding of textual input and may be determined by drawing from the Gaussian distribution (normal distribution with zero mean) using the expression:

$${Ψ}_{L} ∼ N ( σ ( {W}_{L} * {Ψ}_{L - 1} + {b}_{L} ) , {λ}_{Ψ}^{- 1} I ) ,$$

where I denotes an identity matrix, λ_{Y} denotes a parameter (e.g., a model-specific parameter), σ denotes the learning rate hyperparameter, W_{L} denotes the L-th layer kernel, Ψ_{L-1} denotes the output of the (L-1)-th layer, all of which may be learned during training.

In addition, Ω_{i,j} represents the visual embedding of textual input and may be determined by drawing from the Gaussian distribution (normal distribution with zero mean) using the expression:

$${Ω}_{L} ∼ N ( σ ( {W}_{L} * {Ω}_{L - 1} + {b}_{L} ) , {λ}_{Ω}^{- 1} I ) ,$$

where I denotes an identity matrix, λ_{Y} denotes a parameter (e.g., a model-specific parameter), a denotes the learning rate hyperparameter, W_{L} denotes the L-th layer kernel, Ω_{L-1} denotes the output of the (L-1)-th layer, all of which may be learned during training. It shall be noted that the learning rate parameters for textual, visual, and relationship embeddings may or may not necessarily be the same and may thus be learned separately in some embodiments or jointly in some other embodiments.

A pairwise preference probability model may be determined at 506J at least by using the latent user entity vectors and latent product entity vectors. In some embodiments, a triple (O_{u,i}, O_{p,j}, O_{p,j′}) may be constructed for the i-th user entity latent vector, the j-th product entity latent vector, and the j′-th product entity latent vector. The pairwise preference probability, p(j>j′), may be determined using

$$σ ( {O}_{u , i}^{T} {Z}_{j} - {O}_{u , i}^{T} {Z}_{j}^{′} ) , where T , σ , {O}_{u , i}^{T} , {Z}_{j} , and {Z}_{j}^{′}$$

respectively denote the transpose operator, the learning rate hyperparameter, the i-th user object's latent vector, the latent vector capturing the j-th product's latent and the i-th user object, and the latent vector capturing the j′-th product's latent and the i-th user object.

The probability of a triple corresponding to the user object, the first product object, and the second product entity may be determined at 508J at least by using the above pairwise preference probability model. For example, the aforementioned probability may be determined for the triple (O_{u,i}, O_{p,j}, O_{p,j′}) by drawing from the above probability

$$σ ( {O}_{u , i}^{T} {Z}_{j} - {O}_{u , i}^{T} {Z}_{j}^{′} )$$

at 508J where the triple satisfies that there exists one or more interactions between the user entity (e.g., O_{u,i}) and the first product entity (e.g., O_{p,j}), but there exists no interactions between the user entity (e.g., O_{u,i}) and the second product entity (e.g., O_{p,j′}).

An objective function may be determined for joint learning of multiple parameters such as the aforementioned hyperparameters, the user and product entity embeddings, the relationship entity embedding, the kernel, the bias, the learning rate, etc. The process may be iteratively performed between, for example, 516J until a convergence criterion is satisfied. At 510J, a subset of product entities may be iteratively determined by using, for example, random sampling of a plurality of triples (e.g., (O_{u,i}, O_{p,j}, O_{p,j′}) described above for one or more user entities and a plurality of product entities). These techniques described herein are aimed to determine a subset of product entities where for a randomly sampled triple (Q_{u,i}, O_{p,j}, O_{p,j′}), the subset that satisfies the constraint that the subset includes product entity j or product entity j′. At least one of the aforementioned multiple parameters may be iteratively updated in each iteration at 512J by computing an error in the output and propagating the computed error backward through the network structure of the pertinent model(s) or network(s) based at least in part upon a gradient pertaining to the error. For example, a stochastic gradient descent algorithm may be utilized. At this step, the error may be computed using a supervised training mode or an unsupervised training mode.

The posterior probability pertaining to the multiple parameters may be iteratively improved or optimized at 514J at least by using joint learning techniques based at least in part upon an entity function (e.g., a cross-entropy cost function). For example, joint learning may be performed for the user latent vector, the product latent vector, the relationship latent vector, the mapping from the user/product entities and the relationship entities to the relationship space, various model parameters described herein, various hyperparameters described herein, various embedding related variables, or any combinations thereof. With the posterior probability improved at 514J, a pairwise ranking statistic may be determined at 516J for the triple (e.g., (O_{u,i}, O_{p,j}, O_{p,j′}) described above) based on the results of joint learning.

FIG. 5K illustrates another simplified high-level block diagram of a method or system for generating recommendations for a skin condition using invariant features and deep learning techniques for image processing and computer vision, according to some embodiments. More specifically, FIG. 5K encompasses two major approaches for cosmetic product matching and recommendation using artificial intelligence techniques. The first approach applies to cosmetic product matching and recommendation with scanning a user's or prospective user's skin while the second approach applies to cosmetic product matching and recommendation with reverse look up using certain information pertaining to a user or prospective user (collectively a user or users) or to a product.

In some of these embodiments, a user may use a mobile computing device having a mobile app (e.g., a mobile color IQ app) installed thereon and an image capturing device including a camera lens and an image sensor or visit a cosmetic product retail location having a system with at least a store digital app and a scanning device to scan the user's skin at 502K. In some embodiments, the lens used in scanning the user's skin includes a telephoto lens having a magnification power (e.g., optical magnification power, digital magnification power, or optical and digital magnification power, etc.) greater than one to capture finer details of a user's skin. In these embodiments, the distance between a user's skin and the telephoto lens is more likely within the focal length of the telephoto lens to result in blurry images from a scan session. Such blurry images may be corrected into sharp images (e.g., scan image of an area of a user's skin using a scanning device having a telephoto lens in FIG. 14M) by using a SDK (software development kit) that corresponds to a specific imaging capturing device and/or its telephoto lens and is embedded in the scanning software (e.g., the store digital app or the mobile color iQ app described herein).

In some embodiments, the image capturing device of a modern user mobile computing device (e.g., a smart phone such as iPhone 6S® or later models) and/or the scanning device in the system deployed at a cosmetic product retail site may be configured to capture raw data for images (e.g., DNG files or digital negative files) to preserve the completeness of data in the captured images, and the aforementioned SDK may be embedded within the mobile color iQ app and the store digital app or may be a separate piece of software that functions in conjunction with the mobile color iQ app and the store digital app.

In some other embodiments, the lens used in scanning the user's skin may include a macro lens for creating close-up, macro images, a wide-angle lens, a standard lens (e.g., lens having focal length(s) falling between 35 mm and 85 mm), or a specialty lens such a fisheye lens, a tilt shift lens, an infrared lens, etc. A lens may be a fixed-focal length lens having a single focal length value in some embodiments or a variable focal length having a range of focal length values in some other embodiments. Different lenses may have different fields of view. For lenses having larger fields of view, the user's skin may be scanned only once per target area (e.g., forehead area, cheek area, neck area, jawline, outer eye area(s), etc.) For lenses having smaller fields of view, the user's skin may be scanned more than once per target area to obtain a better representation of a reasonably large skin area for subsequent processing.

In some embodiments, the user may use a lens on the image capturing device or the scanning device to scan one or more areas (e.g., forehead area, check area, neck area, etc.) In some embodiments where multiple areas of a user's skin are scanned, the result of each area of the multiple areas may be averaged or weight averaged (e.g., heavier weights for the forehead scan and/or the check area scan and lighter weight in the neck area scan; heavier weight in the cheek area scan, medium weight in the forehead scan, and lighter weight in the neck area scan; etc.) The scan results (e.g., images) may be provided to an artificial intelligence model 504K that performs various processes (e.g., simple linear regression, multivariate linear regression, other linear approach for modeling the input and the output, neural network, deep learning, etc.) to recognize features in the scan results (e.g., hairs, freckles, moles, pre-malignant (e.g., pre-cancerous) skin growth, malignant skin growth, other colored spots, fine lines and/or wrinkles, characteristics of fine lines and/or wrinkles such as depth(s), characteristics of pores such as pore size(s) and/or appearance(s), skin health properties or conditions such as dryness, moisture levels (e.g., with a moisture sensor described below with reference to FIGS. 17A-B), follicle(s), bacteria infection (e.g., using a ultra-violet (UV) light source such as one or more UV-A and/or UV-B light sources in 1716 of FIG. 17B to illuminate a skin area of interest to produce, for example, corneform and proprioni bacteria florescence), dead skin buildup, pores, swelling, cracking, scaliness, etc.) and to predict one or more characteristics (e.g., skin tone, undertone, etc.) pertaining to the skin scan results.

In some embodiments, various techniques described herein are not limited only to scanning a user's skin for skin care product matching and recommendation. Rather, some embodiments apply various techniques to scan a user's skin and use various artificial intelligence techniques to recognize various types of objects on the user's skin to produce dermatological grade scan results and recommendations. For example, some embodiments may utilize the object and/or feature recognition and classification techniques described herein to recognize pre-malignant skin growth, the size and/or shape of a mole, malignant skin growth, bacteria fluorescence (e.g., corneform and proprioni bacteria florescence), or any other type of skin concerns to predict whether a skin concern may correspond to a specific type of disease and make corresponding recommendation (e.g., a visit to a medical specialist's office) accordingly. In some embodiments, the term “body scan” may be used to encompass using various methods and/or systems to scan a part of a user's body, and “body care” may be used to encompass various care instructions, information, products, services, etc., unless otherwise specifically recited in the claims to refer to which specific part (e.g., skin, hair, nails, etc.) of a user.

Some embodiments may further apply various techniques (e.g., scanning, object and/or feature recognition, prediction, classification, and recommendation, etc.) to areas or features other than a user's skin. For example, these areas may include eyes, hairs, nails tongue, or any other suitable parts of a user for which images may be captured and analyzed using various techniques described herein), and various techniques descried herein provide prediction(s) and/or recommendation(s) of pertinent information and/or product(s) or even personalized prediction(s) and/or recommendation(s) for a specific user based at least in part upon one or more attributes of the specific user. For example, various object and/or feature recognition, classification, prediction, and/or recommendation techniques may be applied to hairs to predict, for instance but not limited to, hair color, hair condition, hair health, scalp health and/or condition, or any other attributes and/or conditions to hairs and/or scalp, etc. Similarly, such techniques may be applied to analyze images of nails of a user to predict concern(s), condition(s), etc. of the user (e.g., predicted color of a nail, recognized object(s) or feature(s) that suggests possible issues with, for instance, trauma, anemia, dietary deficiencies, heart or kidney diseases, poisoning, liver hepatitis, thyroid disease, lung disease, diabetes or psoriasis, lung problem, such as emphysema, some heart problems associated with bluish nails, inflammatory arthritis, fungal infection, skin cancer, infection, injury, etc., or any combinations thereof). Such techniques may also predict and provide recommendations the user (e.g., seek medical help) with information to explain the recommendations.

In some embodiments, the artificial intelligence model predicts the skin tone, undertone value or index, skin condition, and/or skin pattern (e.g., a shade value or index having L* value, a* value, and b* value in the CIELAB or CIELch color space) of the user based at least in part upon the scan results at 506K. The predicted skin tone and/or undertone value or index by the artificial intelligence model may be adjusted by a beauty advisor or a sales representative operating the system for cosmetic product matching and recommendation. For example, a beauty advisor may review the scan result and the predicted skin tone and/or undertone value or index (e.g., a color index representing the user's skin tone or shade value or index) and adjust the predicted skin tone and/or undertone value or index (e.g., by altering the L* value, a* value, and/or b* value of the predicted skin tone and/or undertone value or index) at 508K to modify the predicted skin tone and/or undertone value or index into a modified, predicted skin tone and/or undertone value or index. In some embodiments, the predicted skin tone and/or undertone value or index or the modified, predicted skin tone and/or undertone value or index may be validated by, for example, a more sophisticated AI model running on the system for cosmetic products matching and recommendation or in a backend system (e.g., a store digital (SD) backend) remotely connected to the system for cosmetic products.

In some embodiments, the artificial intelligence model may be trained using one or more training datasets 526K. The training may be done before deploying the system for cosmetic product matching and recommendation to the field in some embodiments. In some of these embodiments, the training may continue after deploying the system for cosmetic product matching and recommendation to the field by periodically, repeatedly, or continuously receive data (e.g., user's predicted skin tone and/or undertone value or index, or modified, predicted skin tone and/or undertone value or index, etc.) The artificial intelligence model may also be trained repeatedly, periodically, or continuously by using, for example, users' purchase data, users' return data, sales records, professionals' and/or users' reviews, comments, or other responses pertaining to cosmetic products of interest, new or updated information pertaining to cosmetic products (e.g., color characteristics, information about ingredients, key feature(s), etc.), or any other suitable or appropriate information or data to further enhance the accuracy and/or performance of the artificial intelligence model.

With the predicted shade value or index (also referred to as skin tone and/or undertone value or index) or the modified, predicted shade value or index, if available, the system for cosmetic product matching and recommendation may generate a list of matching cosmetic products (e.g., foundations, concealers, products for lips, moisturizers, products for exfoliation, products for eye puffiness, dark circles, etc., skin hydration products, etc.) at least by filtering various products stored in a data structure (e.g., a database or knowledgebase) into a filtered list at 516K based at least in part upon the predicted shade value or index or the modified, predicted shade value or index, if available.

For example, the system may compare the predicted shade value or index or the modified, predicted shade value or index to the corresponding shade values or indices of various cosmetic products and identify the shade values or indices that exactly match or approximately match (e.g., with a range of shade values or indices) to generate the aforementioned filtered list of cosmetic products at 516K. In some these embodiments, the system adopts a hierarchical filtering or nested scheme where the filtering performed at 516K represents the first level filtering. In some embodiments, the first level filtering ranks the products based at least in part upon, for example, scan results, shade index or value, skin type, skin concern(s), scan location and/or time, without considering other user-specific data such as history. In contrast, the second level filtering described below predicts interaction probability for each (user, product) pair and rank each pair accordingly by accounting for more user-specific data or information.

In some embodiments, the filtered list of products may be provided to a separate artificial intelligence (AI) model at 518K that invokes various artificial intelligence techniques that shuffle and re-rank and/or further filter the filtered list of cosmetic products to generate a personalized recommendation having at least a personalized list of cosmetic products at 518K. In some embodiments where the system adopts the aforementioned hierarchical filtering or nested scheme, this personalization performed at 518K represents the second level filtering. In some embodiments, the separate AI model receives additional information 520K such as other characteristics pertaining to the particular user whose skin has been scanned at 502K.

Such information or data may include, for example, user's skin concern(s), user's skin condition (e.g., discoloration, acne, etc.), user's personal preference (e.g., user's preferring cosmetic products providing a warmer appearance, etc.), user's affinity or loyalty to certain brand(s) or specific cosmetic product(s), user's purchase history and/or trend (e.g., seasonal trend, changes in product(s) and/or brand(s) over time, etc.), user's product return history and/or trend, user's prior scan result(s), user's prior inquiries, user's prior product recommendation(s), prior scan conditions (e.g., time, location, lighting conditions such as halogen, incandescent, natural light, direct sun light, etc.), user's skin type (e.g., dry, oily, neutral, etc.), or any other suitable data or information pertaining to the particular user, or any combinations thereof. Some of such data or information pertaining to the particular user may be stored in one or more databases, one or more knowledgebases, or a combination of one or more databases and one or more knowledgebases.

The separate AI model may then generate a personalized product recommendation at 522K that may facilitate the selection and/or purchases of particular cosmetic products by the particular user at 524K. The particular user's selection and/or purchase information or data (data may refer to processed information in some embodiments) of one or more particular cosmetic products and optionally some additional information (e.g., the particular user's comments on the personalized product recommendation or a portion there of) may be sent back to the separate model executed at 518K or to the deep learning database or knowledgebase 528K storing datasets for training the separate AI model in some embodiments for further training, tuning, or validating the separate AI model and/or for storing such information or data for future reference or processing.

In the second approach that applies to cosmetic product matching and recommendation with reverse look up using certain information pertaining to a user or prospective user, information or data pertaining to a product (or service(s) or treatment option(s)) or the user may be received at 510K. Such information or data pertaining to a product may include, for example, the shade value or index for the product, price, SKU code, type (e.g., foundation, concealer, etc.), inventory status (out of stock, in stock at certain store(s), etc.), similar product(s) of the same manufacturer or brand or different manufacturer(s) or brand(s), any other product specific information or data, any combinations thereof, etc. Such information or data pertain to a user may include, for example but not limited to, user's previous shade index or value (e.g., previous mobile color IQ index or value), user identifier, user brand and/or product affinities or loyalty data, user's prior purchases and/or purchase trend(s), user's prior returns, user's profile attributes such as age, ethnicity, preferences, etc., prior product recommendation(s), any combination thereof, and/or any other suitable data.

A reverse look service may be invoked at 512K based at least in part on the information or data pertaining to the product or the user, and the process proceeds through 516K. 518K, 520K, 522K, 524K, 526K, and 528K based at least in part upon the information or data received at 512K in a similar manner as described above. In some embodiments, if the user's preference (e.g., preference for color(s), product(s), service(s), treatment option(s), etc.) is known such preference may also be provided for the reverse lookup portion of processing at 514K. In some embodiments, any specific data pertaining to the particular user such as those described above may also be utilized in the reverse lookup portion of processing. Such specific data may be provided by the user (e.g., during a current or prior consultation with a beauty advisor or through an online interview process integrated into the mobile app) or induced from other data pertaining to the particular user (e.g., prior interactions, prior purchases, prior returns, prior consultation, prior scan(s), etc.)

In some other embodiments where there is no or insufficient specific data or information about the particular user, the system or method may identify the data to correspond to one or more similar users. For example, the method or system may identify other users of similar age, in the same or similar profession(s), of the same or similar ethnicity, in the same or similar geographical area(s), or any other suitable similarities, or any combinations thereof, etc. The method or system may then use identify corresponding information or data pertaining to these similar users and use such information or data for the particular user in the reverse lookup portion of processing. In some of these embodiments, the method or system may identify such other similar users based at least in part upon their respective similarity scores (e.g., via cosine similarity) above a certain threshold score.

FIG. 5L illustrates another simplified high-level block diagram of a method or system for generating recommendations for a skin condition using invariant features and deep learning techniques for image processing and computer vision, according to some embodiments. In these one or more embodiments, input data may be received at a first deep learning model at 502L. The input data may pertain to a client and one or more products, services, treatment options, or any combinations thereof. For example, the input data may include client identifier, identifiers (e.g., SKU codes) for products, services, or treatment options, store identifier(s), store location, client's scan data, lighting conditions for client's scan data, client's current and/or prior scan results, user's brand, product, service, and/or treatment option affinities or loyalty data, client's prior purchases and/or purchase trend(s), client's prior returns, client's profile attributes such as age, ethnicity, preferences, etc., prior recommendation(s) for products, services, or treatment options, client's skin type, concern(s), and/or condition, any combination thereof, and/or any other suitable data.

A number of ranked products, services, or treatment options may be predicted at 504L based at least on the input data. In some embodiments, the deep learning model utilizes various deep learning techniques (e.g., machine learning, deep learning, convolutional and/or recurrent neural networks, support vector machines, various prediction models using techniques such as alternating least squares, or any other suitable techniques or models, or any combinations thereof) to predict a number of ranked products, services, or treatment options. A list of ranked products, services, and/or treatment options, a user feature representation (e.g., a user vector), a product (or service or treatment option) feature representation may be determined at 506L based at least in part upon the number of ranked products, services, or treatment options. For example, the deep learning model may generate 100 ranked products, services, or treatment options at 504L and selects the top N (e.g., five or ten or all 100) ranked products, services, or treatment options from the 100 ranked products, services, or treatment options for a particular client.

Optionally, the first deep learning model may be validated, adjusted, or calibrated at 508L. In some embodiments, the first deep learning model may be validated, adjusted, or calibrated by executing the first deep learning model over a validation dataset that is distinguishable from one or more training datasets used in training the first deep learning model or the one or more testing datasets used in testing the first deep learning model. In some embodiments where validation, adjustment, or calibration is performed, the validation, adjustment, or calibration may include receiving labeled data (e.g., ground truths) and/or adjustment data for the skin scan result and/or the ranked list of products, services, or treatment options. An accuracy or error measure of one or more rankings of the plurality of products, services, or treatment options may be determined based at least in part upon the adjustment data and/or labeled data. The accuracy or error measure may be propagated backward through the first deep learning model to distribute the accuracy or error measure to various levels or portions of the first deep learning model based on, for example, the gradient pertaining to the accuracy or error measure (e.g., by using a gradient descent algorithm such as the momentum or heavy ball algorithm, the stochastic gradient descent algorithm, fast gradient algorithms such as the optimized gradient method (OGM), the fast proximal gradient method (FPGM), etc., the forward-backward algorithms, or any other suitable algorithms that may be used in or as an extension of training deep learning networks.

A second deep learning model may receive the list of ranked products, services, or treatment options, the client feature representation, the product representations (or representations of service(s) and/or treatment option(s)) at 510L and predicts a respective interaction for each product, service, or treatment option in the list of ranked products, services, or treatment options for the particular client at 512L. In some embodiments, the second deep learning model may generate such predictions by using, for example but not limited to, matrix factorization techniques with feedback. The prediction at 512L represents the second level prediction that operates on the output of the first level prediction at 504L or 506L in these embodiments illustrated in FIG. 5L.

In some embodiments, a personalized recommendation that is specifically tailored to the person may be generated to include at least one of the predicted product(s), service(s), and/or treatment option(s) as well as the predicted interaction(s) and/or the predicted prognosis in response to the corresponding product(s), service(s), and/or treatment option(s).

In some of these embodiments, the second deep learning model may utilize deep learning techniques such as alternating least square (ALS) with implicit feedback (e.g., relationship data described above) with a learning library (e.g., a Spark Machine Learning Library) or some filtering techniques (e.g., collaborative filtering, joint learning, etc.) to find client-specific (e.g., personalized) patterns or matches for the particular client. Alternating least squares (ALS) factorizes a given matrix R into two factors U (e.g., a row vector) and V (e.g., a column vector) such that R≈UTV. The unknown row dimension may be provided as a parameter to the ALS algorithm and may be called latent factors.

One of the advantages of ALS is that real-world data may be often bimodal (e.g., created by a joint interaction between two types of entities). For example, a client rating a product, service, or treatment option may be affected by both the client characteristics (e.g., affinity to some characteristics or attributes) and the product, service, or treatment option characteristics (e.g., its connections to one or more of those characteristics/attributes). This type of data may be represented as a matrix, of which each dimension represents one of the entity types. Co-clustering (or bi-clustering) is a data mining technique that relates to a simultaneous clustering of the rows and columns of a matrix. Some embodiments use Matrix Factorization (MF) to solve co-clustering problems (e.g., for collaborative recommender systems). For example, matrix factorization assumes a matrix of ratings given by m clients to n products, services, or treatment options. Applying the matrix factorization on the aforementioned matrix R may end up factorizing the matrix R into two matrices such that their multiplication approximates R. The new quantity, k, introduced by the operation of matrix factorization serves as both U's and P's dimensions. This new quantity denotes the rank of the factorization.

The second deep learning model may generate its predictions by using a cost function. In some embodiments where matrix factorization or collaborative filtering is used to factorize a matrix R into U and P as described above, the cost function may be defined as: cost function=∥R-U×P^{T}∥₂+λ(∥U∥₂+∥P∥₂). The first term in the above cost function, ∥R-U×P^{T}∥₂ denotes the Mean Square Error (MSE) distance measure between the original rating matrix R and its approximation, while the second term is a regularization term that is added to govern a generalized solution (e.g., to prevent overfitting to some local noisy effects on ratings).

The above may be achieved by using alternating least squares that involve a two-step iterative optimization process. In each iteration, ALS fixes P and solves for U, and following that ALS fixes U and solves for P. Because the solution may be unique and may guarantee a minimal MSE, the cost function may, in each step, either decrease or stay unchanged, but never increase. Alternating between the two steps guarantees reduction of the cost function, until convergence. Some other embodiments may use singular value decomposition (SVD) which may provider stronger guarantees than matrix factorization in some embodiments.

At 514L, the second deep learning model may be optionally calibrated. In some embodiments, the second deep learning model may be calibrated by executing the second deep learning model over a validation dataset that is distinguishable from one or more training datasets used in training the second deep learning model or the one or more testing datasets used in testing the second deep learning model. In some embodiments where calibration is performed, the calibration may include receiving labeled data (e.g., ground truths) and/or adjustment data for the skin scan result and/or the ranked list of products, services, or treatment options. In some embodiments, client's selection data (or non-selection data indicating client's selecting none from the list), purchase data (or non-purchase indicating no purchases were made), and/or client's subsequent interaction data (e.g., interactions in future time) may also be received and utilized in calibrating the second deep learning model.

An accuracy or error measure of one or more rankings of the plurality of products, services, or treatment options may be determined based at least in part upon the adjustment data, labeled data, client's selection data (or non-selection data indicating client's selecting none from the list), purchase data (or non-purchase indicating no purchases were made), and/or client's subsequent interaction data. The accuracy or error measure may be propagated backward through the second deep learning model to distribute the accuracy or error measure to various levels or portions of the second deep learning model based at least in part on, for example, the gradient pertaining to the accuracy or error measure (e.g., by using a gradient descent algorithm such as the momentum or heavy ball algorithm, the stochastic gradient descent algorithm, fast gradient algorithms such as the optimized gradient method (OGM), the fast proximal gradient method (FPGM), etc., the forward-backward algorithms, or any other suitable algorithms that may be used in or as an extension of training deep learning networks.

FIG. 5M illustrates more details about the joint learning portion of the block diagram of a method or system for image processing and computer vision, using invariant features and deep learning techniques illustrated in FIG. 5L, according to some embodiments. More specifically, FIG. 5M illustrates more details about validating or adjusting the first deep learning model at 508L of FIG. 5L. In these embodiments, validation and/or adjustment data may be received at 502M.

A number of ranked products may be predicted at based at least on the input validation or adjustment data. In some embodiments, the deep learning model utilizes various deep learning techniques (e.g., machine learning, deep learning, convolutional and/or recurrent neural networks, support vector machines, various prediction models using techniques such as alternating least squares, or any other suitable techniques or models, or any combinations thereof) to predict a number of ranked products, services, treatment options, and/or any combinations thereof.

An accuracy or error measure may be determined at 504M for scoring or prediction, based at least in part upon the validation or adjustment data received at 502M. In some embodiments where the deep learning model may need to be fine-tuned, calibrated, or adjusted in view of the accuracy or error measure determined at 504M, the accuracy or error measure may be optionally distributed to the first and/or the second deep learning model at 506M.

FIG. 5N illustrates another simplified high-level block diagram of a method or system for generating recommendations for a skin condition using invariant features and deep learning techniques for image processing and computer vision, according to some embodiments. More specifically, a list of ranked product(s), service(s), and/or treatment option(s) 500M is provided to a recommender deep learning network 504E which also receives user data 502M of one or more users. The recommender deep learning network 504E generates a predictions 506M1.

The extractor or encoder portion of the recommender deep learning network 504E may process respective types of input data into representations. For example, the product feature encoder 508M may encode product feature data in the input 500M into product feature vectors 516M; the service feature encoder 510M may encode the service feature data in the input 500M into service feature vectors 518M; and the treatment option encoder 512M may encode treatment option data in the input 500M into the treatment option feature vectors 520M.

The recommender deep learning network 504E may also process (e.g., performing convolutional and/or deconvolutional operations with one or more encoders and/or one or more decoders in the recommender deep learning network 504E) the respective feature vectors to generate corresponding predictions therefor.

In some embodiments, the feature vectors (516M, 518M, and/or 520M) may be provided to the decoder or classifier network 522M to generate personalized output 524M that custom tailors the recommendations of ranked products, services, and/or treatment options with corresponding probabilities and timeline information.

In the present application, many of the methods described herein can be performed with variations. For example, many of the methods may include additional acts, omit some acts, and/or perform acts in a different order than as illustrated or described. Unless otherwise explicitly stated, the various embodiments described above can be readily combined to provide further embodiments, to the fullest extent that various embodiments described herein are not inconsistent with the specific teachings and definitions herein. Further, aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

We claim:

1. A computer implemented method for image processing and computer vision using invariant features and deep learning techniques, comprising:
receiving one or more images or a sequence of images pertaining to a gait cycle of a person;
processing the one or more images or the sequence of images;
training or re-training a convolutional neural network using at least the one or more images or the sequence of images that has been processed, based at least in part upon one or more invariant features from the one or more images or the sequence of images; and
recognizing a gait feature of the person to determine an identity of the person using at least the convolutional neural network that has been trained.

2. The computer implemented method of claim 1, processing the one or more images or the sequence of images comprising:
generating one or more complete gait images and one or more incomplete gait images, wherein
the one or more complete gait images correspond to at least one complete gait cycle, and
the one or more incomplete gait images corresponds to a smaller subset of a complete gait cycle.

3. The computer implemented method of claim 2, processing the one or more images or the sequence of images comprising:
performing a normalization operation on the one or more complete gait images and one or more incomplete gait images to transform pixel values of the one or more complete gait images and one or more incomplete gait images are within a range.

4. The computer implemented method of claim 3, processing the one or more images or the sequence of images comprising:
splitting the one or more complete gait images and one or more incomplete gait images, which have been normalized, into one or more first datasets and one or more second datasets, wherein
the one or more first datasets include first data corresponding to the at least one complete gait cycle, and
the one or more second datasets include second data corresponding to one or more smaller subsets of the complete gait cycle.

5. The computer implemented method of claim 1, wherein training or re-training the convolutional neural network comprises:
training a stack of a plurality of convolutional networks into a trained gait generation network using at least one of the one or more invariant features, one or more predicted invariant features, or one or more gait features detected from the one or more images or the sequence of images.

6. The computer implemented method of claim 5, wherein training or re-training the convolutional neural network comprises:
training a gait recognition network into a trained gait recognition network using at least one of the one or more invariant features or the one or more predicted invariant features.

7. The computer implemented method of claim 5, training the stack of the plurality of convolutional networks comprising:
determining a number of individual convolutional neural networks for generating complete gait images from incomplete gait images;
training each individual convolutional neural network of the number of individual convolutional neural networks with a respective dataset; and
determining one or more parameters of the each individual convolutional neural network.

8. The computer implemented method of claim 7, training the stack of the plurality of convolutional networks comprising:
training the gait generation network with the one or more parameters of the each individual convolutional neural network at least by stacking the number of convolutional neural networks to form the gait generation network.

9. The computer implemented method of claim 8, training the stack of the plurality of convolutional networks comprising:
validating the gait generation network using at least one dataset of the one or more first datasets or the one or more second datasets that are determined by splitting the one or more the one or more complete gait images and one or more incomplete gait images.

10. The computer implemented method of claim 1, wherein the one or more invariant features comprise an invariant physiological feature that is located at a fixed location with respect to a body part of a human body of the person and is free from disguise, occlusion, and mutilation due to movements of soft tissues of the person.

11. A computer program product embodied on a non-transitory computer readable medium having stored thereon a sequence of instructions which, when executed by a processor, causes the processor to execute a set of acts, the set of acts comprising:
receiving one or more images or a sequence of images pertaining to a gait cycle of a person;
processing the one or more images or the sequence of images;
training or re-training a convolutional neural network using at least the one or more images or the sequence of images that has been processed, based at least in part upon one or more invariant features from the one or more images or the sequence of images; and
recognizing a gait feature of the person to determine an identity of the person using at least the convolutional neural network that has been trained.

12. The computer program product of claim 11, wherein the non-transitory computer readable medium having stored thereon the sequence of instructions which, when executed by the processor, causes the processor to execute the set of acts, the set of acts further comprising:
generating one or more complete gait images and one or more incomplete gait images, wherein
the one or more complete gait images correspond to at least one complete gait cycle, and
the one or more incomplete gait images corresponds to a smaller subset of a complete gait cycle.

13. The computer program product of claim 12, wherein the non-transitory computer readable medium having stored thereon the sequence of instructions which, when executed by the processor, causes the processor to execute the set of acts, the set of acts further comprising:
performing a normalization operation on the one or more complete gait images and one or more incomplete gait images to transform pixel values of the one or more complete gait images and one or more incomplete gait images are within a range; and
splitting the one or more complete gait images and one or more incomplete gait images, which have been normalized, into one or more first datasets and one or more second datasets, wherein
the one or more first datasets include first data corresponding to the at least one complete gait cycle, and
the one or more second datasets include second data corresponding to one or more smaller subsets of the complete gait cycle.

14. The computer program product of claim 11, wherein the non-transitory computer readable medium having stored thereon the sequence of instructions which, when executed by the processor, causes the processor to execute the set of acts, the set of acts further comprising:
training a stack of a plurality of convolutional networks into a trained gait generation network using at least one of the one or more invariant features, one or more predicted invariant features, or one or more gait features detected from the one or more images or the sequence of images; and
training a gait recognition network into a trained gait recognition network using at least one of the one or more invariant features or the one or more predicted invariant features.

15. The computer program product of claim 11, wherein the non-transitory computer readable medium having stored thereon the sequence of instructions which, when executed by the processor, causes the processor to execute the set of acts, the set of acts further comprising:
determining a number of individual convolutional neural networks for generating complete gait images from incomplete gait images;
training each individual convolutional neural network of the number of individual convolutional neural networks with a respective dataset;
determining one or more parameters of the each individual convolutional neural network;
training the gait generation network with the one or more parameters of the each individual convolutional neural network at least by stacking the number of convolutional neural networks to form the gait generation network; and
validating the gait generation network using at least one dataset of the one or more first datasets or the one or more second datasets that are determined by splitting the one or more the one or more complete gait images and one or more incomplete gait images.

16. A system, comprising:
at least one processor;
memory that stores therein a sequence of instructions which, when executed by the at least one processor, causes the at least one processor to execute a set of acts, the set of acts comprising:
receiving one or more images or a sequence of images pertaining to a gait cycle of a person;
processing the one or more images or the sequence of images;
training or re-training a convolutional neural network using at least the one or more images or the sequence of images that has been processed, based at least in part upon one or more invariant features from the one or more images or the sequence of images; and
recognizing a gait feature of the person to determine an identity of the person using at least the convolutional neural network that has been trained.

17. The system of claim 16, wherein the memory having stored thereon the sequence of instructions which, when executed by the at least one processor, causes the at least one processor to execute the set of acts, the set of acts further comprising:
generating one or more complete gait images and one or more incomplete gait images, wherein
the one or more complete gait images correspond to at least one complete gait cycle, and
the one or more incomplete gait images corresponds to a smaller subset of a complete gait cycle;
performing a normalization operation on the one or more complete gait images and one or more incomplete gait images to transform pixel values of the one or more complete gait images and one or more incomplete gait images are within a range; and
splitting the one or more complete gait images and one or more incomplete gait images, which have been normalized, into one or more first datasets and one or more second datasets, wherein
the one or more first datasets include first data corresponding to the at least one complete gait cycle, and
the one or more second datasets include second data corresponding to one or more smaller subsets of the complete gait cycle.

18. The system of claim 16, wherein the memory having stored thereon the sequence of instructions which, when executed by the at least one processor, causes the at least one processor to execute the set of acts, the set of acts further comprising:
training a stack of a plurality of convolutional networks into a trained gait generation network using at least one of the one or more invariant features, one or more predicted invariant features, or one or more gait features detected from the one or more images or the sequence of images; and
training a gait recognition network into a trained gait recognition network using at least one of the one or more invariant features or the one or more predicted invariant features.

19. The system of claim 18, wherein the memory having stored thereon the sequence of instructions which, when executed by the at least one processor, causes the at least one processor to execute the set of acts, the set of acts further comprising:
determining a number of individual convolutional neural networks for generating complete gait images from incomplete gait images;
training each individual convolutional neural network of the number of individual convolutional neural networks with a respective dataset; and
determining one or more parameters of the each individual convolutional neural network.

20. The system of claim 19, wherein the memory having stored thereon the sequence of instructions which, when executed by the at least one processor, causes the at least one processor to execute the set of acts, the set of acts further comprising:
training the gait generation network with the one or more parameters of the each individual convolutional neural network at least by stacking the number of convolutional neural networks to form the gait generation network; and
validating the gait generation network using at least one dataset of the one or more first datasets or the one or more second datasets that are determined by splitting the one or more the one or more complete gait images and one or more incomplete gait images, wherein
the one or more invariant features comprise an invariant physiological feature that is located at a fixed location with respect to a body part of a human body of the person and is free from disguise, occlusion, and mutilation due to movements of soft tissues of the person.
